(19) United States
(12) Patent Application Publication
(10) Pub. No.: US 2025/0130544 A1
(43) Pub. Date: Apr. 24, 2025

(54) ARBITRARILY CONFIGURABLE SENSORS AND ELECTRICAL DEVICES

(71) Applicant: SWIDGET CORP., Kingston (CA)

(72) Inventors: Lowell Donald MISENER, Kingston (CA); Christopher E. ADAMSON, Kingston (CA); Cameron WILSON, Inverary (CA)

(21) Appl. No.: 18/693,344

(22) PCT Filed: Sep. 27, 2022
(86) PCT No.: PCT/CA2022/051427

§ 371 Date: Mar. 19, 2024

Related U.S. Application Data
(60) Provisional application No. 63/249,272, filed on Sep. 28, 2021.

(51) Int. Cl. G05B 19/042; H04L 12/28; H04L 41/00

(52) U.S. Cl. CPC G05B 19/0423; G05B 19/0421; H04L 41/24; G05B 2219/2642; H04L 12/2829

(57) ABSTRACT

A control module for residential environments, commercial environments, manufacturing environments, public buildings, and retail environments. Currently, configuring or reconfiguring systems for these environments is time consuming. It would be beneficial to provide arbitrarily configurable sensor and control modules and more particularly to intelligent arbitrarily configurable sensor and control modules and arrays of sensor and control modules allowing increased functionality, connectivity, intelligence, decision making, and communications within these systems. Provided is a module including a casing; one or more interfaces, each interface disposed at a predetermined position within a surface of the casing and supporting at least one of data communications and power; and one or more circuits coupled to the one or more interfaces.

### CROSS-REFERENCE TO RELATED INVENTIONS

This patent application claims the benefit of priority from U.S. Provisional Patent Application 63/249,272 filed Sep. 28, 2021.

### FIELD OF THE INVENTION

This patent application relates to arbitrarily configurable sensor and control modules and more particularly to intelligent arbitrarily configurable sensor and control modules and arrays of sensor and control modules allowing increased functionality, connectivity, intelligence, decision making, and communications within distributed applications such as industrial automation, home automation, and business automation.

### BACKGROUND OF THE INVENTION

Home automation or smart homes (also known as domotics) refers to building automation for the home. It involves the control and automation of lighting, heating (such as smart thermostats), ventilation, air conditioning (HVAC), and security, as well as home appliances such as washer/dryers, ovens or refrigerators/freezers. Wi-Fi is often used for remote monitoring and control. Home devices, when remotely monitored and controlled via the Internet, are an important constituent of the Internet of Things. Modern systems generally consist of switches and sensors connected to a central hub sometimes called a “gateway” from which the system is controlled with a user interface that is interacted either with a wall-mounted terminal, mobile phone software, tablet computer or a web interface, often but not always via Internet cloud services.

Home automation represents part of the building automation environment as in addition to residential deployments there are markets for commercial environments, manufacturing environments, public buildings, and retail environments.

Accordingly, it would be beneficial to provide arbitrarily configurable sensor and control modules and more particularly to intelligent arbitrarily configurable sensor and control modules and arrays of sensor and control modules allowing increased functionality, connectivity, intelligence, decision making, and communications within distributed applications such as industrial automation, home automation, and business automation.

Further, it would be beneficial for such arbitrarily configurable sensor and control modules to support reconfiguration of both an array of arbitrarily configurable sensor and control modules they form part of as well as reconfiguration of themselves via replaceable inserts. Such arbitrarily configurable sensor and control modules supporting applications such as artificial intelligence based assisted living functionality through monitoring user activities etc. as well as artificial intelligence based control and/or mitigation of risks, systems etc. where the artificial intelligence is centralized or distributed locally or remotely accessed.

Other aspects and features of the present invention will become apparent to those ordinarily skilled in the art upon review of the following description of specific embodiments of the invention in conjunction with the accompanying figures.

### SUMMARY OF THE INVENTION

It is an object of the present invention to mitigate limitations within the prior art relating to arbitrarily configurable sensor and control modules and more particularly to intelligent arbitrarily configurable sensor and control modules and arrays of sensor and control modules allowing increased functionality, connectivity, intelligence, decision making, and communications within distributed applications such as industrial automation, home automation, and business automation.

In accordance with an embodiment of the invention there is provided a module comprising:
a casing;
one or more interfaces, each interface disposed at a predetermined position within a surface of the casing and supporting at least one of data communications and power; and
one or more circuits coupled to the one or more interfaces

In accordance with an embodiment of the invention there is provided a system comprising:
a stack of modules each module of the stack of modules interconnected to at least one adjacent module of the stack of modules; wherein
the stack of modules dynamically configure at least one of data communications and power between the stack of modules independent of the order of the modules within the stack of modules.

In accordance with an embodiment of the invention there is provided a module comprising:
one or more interfaces supporting at least one of data communications and power; and at least one of a control signal generator and a sensor; wherein
the module can be added to a stack of modules to form a new stack of modules where each module of the new stack of modules interconnected to at least one adjacent module of the stack of modules; and
the module dynamically configures at least one of data communications and power according to its adjacent module or modules within the new stack of modules independent of the order of the modules within the new stack of modules or the functionality of the other modules within the new stack of modules.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 depicts a network environment within which Arbitrarily Configurable Sensor and Control (ACSC) modules and inserts according to and supporting embodiments of the invention may be deployed and operate; and

FIG. 2 depicts an ACSC module configuration supporting communications to a network such as depicted in FIG. 1 and other ACSCs according to and supporting embodiments of the invention;

FIG. 3A depicts an ACSC module and insert according to an embodiment of the invention;

FIG. 3B shows the insert of FIG. 3A removed from the interface cavity of the ACSC according to an embodiment of the invention;

FIG. 4 depicts an ACSC according to an embodiment of the invention with the insert removed;

FIG. 5 depicts representations of an insert for an ACSC according to an embodiment of the invention with a cable interface to an external portion of the insert;

FIGS. 6 and 7 depict configurable ACSCs according to embodiments of the invention;

FIG. 8 depicts restriction of inserts to different classes of ACSC according to an embodiment of the invention;

FIG. 9A depicts a configuration of insert and ACSC circuit board supporting restriction of insert/ACSC combinations such as depicted in FIG. 3 according to an embodiment of the invention;

FIG. 9B depicts a pin-hole configuration for achieving the insert restrictions according to FIG. 3 according to an embodiment of the invention;

FIG. 10 depicts an edge connection between the insert and ACSC circuit board according to an embodiment of the invention;

FIG. 11 depicts an internal ground bar configuration according to an embodiment of the invention providing grounding of the insert prior to electrical connectivity with the ACSC circuit board;

FIG. 12A depicts a configurable ACSC according to an embodiment of the invention wherein the installed functionality can be set at installation leaving the post-installation ACSC configuration;

FIG. 12B depicts a configurable ACSC according to an embodiment of the invention wherein the installed functionality can be set at installation leaving the post-installation ACSC configuration;

FIG. 13 depicts the configurable ACSC and cover of the embodiment of the invention depicted in FIG. 12A;

FIG. 14 depicts a configurable ACSC according to an embodiment of the invention wherein the installed functionality can be set at installation leaving the post-installation ACSC configuration;

FIG. 15 depicts a configurable ACSC and cover according to an embodiment of the invention;

FIGS. 16, 17A and 17B depict configurable ACSCs according to embodiments of the invention;

FIG. 18 depicts a configurable ACSC according to an embodiment of the invention;

FIGS. 19 and 20 depict schematics of ACSCs incorporating Nano-Hubs supporting artificial intelligence based decision making according to an embodiment of the invention;

FIGS. 21 and 22 depict schematics of ACSCs incorporating Nano-Hubs supporting artificial intelligence based decision making according to an embodiment of the invention;

FIG. 23 depicts a schematic of an ACSC according to an embodiment of the invention wherein communications to/from functions within the ACSC are established and communicated to an insert installed within the ACSC;

FIG. 24 depicts a configurable ACSC according to an embodiment of the invention wherein the installed functionality can be set at installation leaving the post-installation ACSC configuration;

FIG. 25 depicts a configurable ACSC according to an embodiment of the invention wherein the installed sensor functionality can be either set at installation or post-installation;

FIGS. 26 and 27 depict ACSC Array configurations with a Base ACSC Module according to embodiments of the invention;

FIGS. 28 and 29 depict ACSC Array configurations with a Base ACSC Module and interface elements disposed between adjacent ACSC Modules according to embodiments of the invention;

FIGS. 30 and 31 depict interconnection interfaces for ACSC Modules according to embodiments of the invention;

FIG. 32 depicts fixed and dynamic interface configurations for ACSC Modules according to embodiments of the invention;

FIGS. 33 to 35 depict ACSC Array configurations exploiting ACSC Modules and Vase ACSC Modules according to embodiments of the invention

FIGS. 36 and 37 depict an ACSC module according to an embodiment of the invention supporting inserts to configure and reconfigure additional functionality to the ACSC module;

FIGS. 38 and 39 depict an ACSC module according to an embodiment of the invention supporting inserts to configure and reconfigure additional functionality to the ACSC module;

FIG. 40 depicts bus interconnection elements to connect ACSC modules according to embodiments of the invention and interfacing of the bus interconnection element to circuits within ACSC modules according to embodiments of the invention;

FIG. 41 depicts bus interconnection elements to connect ACSC modules according to embodiments of the invention disposed within a top and side of an ACSC module according to an embodiment of the invention;

FIG. 42 depicts a power distribution module according to an embodiment of the invention supporting inserts to configure and reconfigure additional functionality to the power distribution module;

FIG. 43 depicts a base distribution module together with an ACSC module for extending the base power distribution module and configurations for these elements; and

FIG. 44 depicts an interface element as depicted in FIGS. 28 and 29 to provide an interconnection element to connect ACSC modules according to embodiments of the invention.

### DETAILED DESCRIPTION

The present invention is directed to arbitrarily configurable sensor and control modules and more particularly to intelligent arbitrarily configurable sensor and control modules and arrays of sensor and control modules allowing increased functionality, connectivity, intelligence, decision making, and communications within distributed applications such as industrial automation, home automation, and business automation.

The ensuing description provides representative embodiment(s) only, and is not intended to limit the scope, applicability or configuration of the disclosure. Rather, the ensuing description of the embodiment(s) will provide those skilled in the art with an enabling description for implementing an embodiment or embodiments of the invention. It being understood that various changes can be made in the function and arrangement of elements without departing from the spirit and scope as set forth in the appended claims. Accordingly, an embodiment is an example or implementation of the inventions and not the sole implementation. Various appearances of “one embodiment.” “an embodiment” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention can also be implemented in a single embodiment or any combination of embodiments.

Reference in the specification to “one embodiment”, “an embodiment”, “some embodiments” or “other embodiments” means that a particular feature, structure, or characteristic described in connection with the embodiments is included in at least one embodiment, but not necessarily all embodiments, of the inventions. The phraseology and terminology employed herein is not to be construed as limiting but is for descriptive purpose only. It is to be understood that where the claims or specification refer to “a” or “an” element, such reference is not to be construed as there being only one of that element. It is to be understood that where the specification states that a component feature, structure, or characteristic “may”, “might”, “can” or “could” be included, that particular component, feature, structure, or characteristic is not required to be included.

Reference to terms such as “left”, “right”, “top”, “bottom”, “front” and “back” are intended for use in respect to the orientation of the particular feature, structure, or element within the figures depicting embodiments of the invention. It would be evident that such directional terminology with respect to the actual use of a device has no specific meaning as the device can be employed in a multiplicity of orientations by the user or users.

Reference to terms “including”, “comprising”, “consisting” and grammatical variants thereof do not preclude the addition of one or more components, features, steps, integers or groups thereof and that the terms are not to be construed as specifying components, features, steps or integers. Likewise, the phrase “consisting essentially of”, and grammatical variants thereof, when used herein is not to be construed as excluding additional components, steps, features integers or groups thereof but rather that the additional features, integers, steps, components or groups thereof do not materially alter the basic and novel characteristics of the claimed composition, device or method. If the specification or claims refer to “an additional” element, that does not preclude there being more than one of the additional element.

An “electrical outlet” as used herein and throughout this disclosure, refer to, but is not limited to, an electrical socket or plug that is configured for providing electrical power, typically at so-called “mains” voltage being that supplied to the environment the outlet is deployed within by the electrical distribution network. As such the “mains” voltage is defined by region/country globally. Electrical sockets and plugs may be 110V/120V, 220V/230V/240V, 50 Hz, 60 Hz, 5A, 6A, 10A, 13A, 15A, 20A, polarized, unpolarised, earthed, fused, employ insulated pins, have an even number of pins, and have an odd or even number of pins etc. and employ ground fault and/or arc fault interrupter circuits that trigger under predetermined conditions to disable the outlet until the fault is corrected and the circuit reset. However, electrical outlets may provide DC power or AC power at a different current and/or voltage than that to which they are connected depending upon their configuration.

A “plug” as used herein and throughout this disclosure, refer to, but is not limited to, one half of an electrical connector with the other half being the socket. The plug is usually considered the male portion of an electrical connector and comprises one or more pins or jacks that are designed to mate with their corresponding socket.

A “socket” as used herein and throughout this disclosure, refer to, but is not limited to, one half of an electrical connector with the other half being the plug. The socket is usually considered the female portion of an electrical connector and comprises one or more openings that are designed to mate with their corresponding plug pins or jack.

An “electrical connector” is an electro-mechanical device used to join electrical terminations and create an electrical circuit. Electrical connectors typically consist of plugs (male-ended) and jacks (female-ended). The connection may be made/unmade manually or may require a tool for assembly and removal.

An “electrical contact” as used herein and throughout this disclosure, refer to, but is not limited to, an electrical connection between a first element (e.g., a pin of a plug) with a second element (e.g., a receptacle within a socket). Such electrical contacts may be around the periphery of the pin, on a particular surface of the pin, or particular surface of the pin. Some electrical contacts may be sprung to maintain connection over a range of relative positions of the two elements.

A “demountable insert” or “insert” as used herein and throughout this disclosure, refer to, but is not limited to, an assembly designed to be inserted within an opening/recess within an ACSC Module. Accordingly, a demountable insert may be inserted/removed without requiring the removal of a faceplate or cover of the ACSC Module.

A “retention means” as used herein and throughout this disclosure, refer to, but is not limited to, a means of attaching one element to another element. As such a retention means may include, but not be limited, a screw, a bolt, a nut and bolt, a latch, and a clip.

An “electrical supply” as used herein and throughout this disclosure, refer to, but is not limited to, an electrical power supply to which an ACSC is connected in order to provide electrical power for the ACSC, its user accessible features such as a socket, switch, etc. and provides power to the demountable insert(s) supported by the ACSC. In most instances the electrical supply is the general-purpose alternating-current (AC) electric power supply received at the residence, retail building, office, commercial building etc. However, in other instances it may be a different AC electrical power supply derived from the general-purpose AC or another power supply such as a generator. In other instances, the electrical supply may be a direct-current (DC) electrical supply. General-purpose AC is typically 110V/120V or 220V/230V/240V at either 50 Hz or 60 Hz. However, in other instances it may be at other frequencies such as 400 Hz for example in avionics applications.

A “wireless standard” as used herein and throughout this disclosure, refer to, but is not limited to, a standard for transmitting signals and/or data through electromagnetic radiation which may be optical, radio frequency (RF) or microwave although typically RF wireless systems and techniques dominate. A wireless standard may be defined globally, nationally, or specific to an equipment manufacturer or set of equipment manufacturers. Dominant wireless standards at present include, but are not limited to IEEE 802.11, IEEE 802.15, IEEE 802.16, IEEE 802.20, UMTS, GSM 850, GSM 900, GSM 1800, GSM 1900, GPRS, ITU-R 5.138, ITU-R 5.150, ITU-R 5.280, IMT-1000, Bluetooth, Wi-Fi, Ultra-Wideband and WiMAX. Some standards may be a conglomeration of sub-standards such as IEEE 802.11 which may refer to, but is not limited to, IEEE 802.1a, IEEE 802.11b, IEEE 802.11g, or IEEE 802.11n as well as others under the IEEE 802.11 umbrella.

A “wired standard” as used herein and throughout this disclosure, generally refer to, but is not limited to, a standard for transmitting signals and/or data through an electrical cable discretely or in combination with another signal. Such wired standards may include, but are not limited to, digital subscriber loop (DSL), Dial-Up (exploiting the public switched telephone network (PSTN) to establish a connection to an Internet service provider (ISP)), Data Over Cable Service Interface Specification (DOCSIS), Ethernet, Gigabit home networking (G.hn), Integrated Services Digital Network (ISDN), Multimedia over Coax Alliance (MoCA), and Power Line Communication (PLC, wherein data is overlaid to AC/DC power supply). In some embodiments a “wired standard” may refer to, but is not limited to, exploiting an optical cable and optical interfaces such as within Passive Optical Networks (PONs) for example.

A “user” as used herein may refer to, but is not limited to, an individual or group of individuals. This includes, private individuals, employees of organizations and/or enterprises, members of community organizations, members of charity organizations, men, women and children. In its broadest sense the user may further include, but not be limited to, mechanical systems, robotic systems, android systems, etc. that may be characterised by an ability to exploit one or more embodiments of the invention.

A “sensor” as used herein may refer to, but is not limited to, a transducer providing an electrical output generated in dependence upon a magnitude of a measure and selected from the group comprising, but is not limited to, environmental sensors, medical sensors, biological sensors, chemical sensors, ambient environment sensors, position sensors, motion sensors, thermal sensors, infrared sensors, visible sensors, RFID sensors, and medical testing and diagnosis devices. A sensor may include, but not be limited to, a radon sensor, an ionizing radiation sensor, a microwave radiation sensor, an optical sensor, a motion detector, a smoke detector, an air particulate detector, a water detector, a humidity detector, a liquid level sensor, a gas sensor for one or more gases including but not limited to ammonia, carbon dioxide, carbon monoxide, chlorine, chlorine dioxide, ethylene oxide, flammable gases, hydrogen, hydrogen chloride, hydrogen cyanide, hydrogen sulphide, methane, nitrogen dioxide, nitric oxide, oxygen, phosphine, propane, sulphur dioxide, one or more volatile organic compounds. A sensor may include, but not be limited to, radar, LIDAR, thermal imaging, infrared imaging, a two-dimensional (2D) optical scanner, a three-dimensional (3D) optical scanner, a microphone, an ultrasonic detector, an ultralow frequency detector, a pressure sensor, and a vibration sensor.

A “portable electronic device” or “portable electrical device” (PED) as used herein and throughout this disclosure, refers to a wireless device used for communications and other applications that requires a battery or other independent form of energy for power. This includes devices, but is not limited to, such as a cellular telephone, smartphone, personal digital assistant (PDA), portable computer, pager, portable multimedia player, portable gaming console, laptop computer, tablet computer, a wearable device, an electronic reader, a lamp, a heater, and a portable beverage machine.

A “fixed electronic device” or “fixed electrical device” (FED) as used herein and throughout this disclosure, refers to a wireless and/or wired device used for communications and other applications that requires connection to a fixed interface to obtain power. This includes, but is not limited to, a laptop computer, a personal computer, a computer server, a kiosk, a gaming console, a digital set-top box, an analog set-top box, an Internet enabled appliance, an Internet enabled television, a multimedia player, a television, a heater, a light, a beverage machine, a food dispenser, a microwave, an oven, and a refrigerator.

A “server” as used herein, and throughout this disclosure, refers to one or more physical computers co-located and/or geographically distributed running one or more services as a host to users of other computers, PEDs, FEDs, etc. to serve the client needs of these other users. This includes, but is not limited to, a database server, file server, mail server, print server, web server, gaming server, or virtual environment server.

An “application” (commonly referred to as an “app”) as used herein may refer to, but is not limited to, a “software application”, an element of a “software suite”, a computer program designed to allow an individual to perform an activity, a computer program designed to allow an electronic device to perform an activity, and a computer program designed to communicate with local and/or remote electronic devices. An application thus differs from an operating system (which runs a computer), a utility (which performs maintenance or general-purpose chores), and a programming tools (with which computer programs are created). Generally, within the following description with respect to embodiments of the invention an application is generally presented in respect of software permanently and/or temporarily installed upon a PED and/or FED.

An “enterprise” as used herein may refer to, but is not limited to, a provider of a service and/or a product to a user, customer, or consumer. This includes, but is not limited to, a retail outlet, a store, a market, an online marketplace, a manufacturer, an online retailer, a charity, a utility, and a service provider. Such enterprises may be directly owned and controlled by a company or may be owned and operated by a franchisee under the direction and management of a franchiser.

A “service provider” as used herein may refer to, but is not limited to, a third party provider of a service and/or a product to an enterprise and/or individual and/or group of individuals and/or a device comprising a microprocessor. This includes, but is not limited to, a retail outlet, a store, a market, an online marketplace, a manufacturer, an online retailer, a utility, an own brand provider, and a service provider wherein the service and/or product is at least one of marketed, sold, offered, and distributed by the enterprise solely or in addition to the service provider.

A “third party” or “third party provider” as used herein may refer to, but is not limited to, a so-called “arm's length” provider of a service and/or a product to an enterprise and/or individual and/or group of individuals and/or a device comprising a microprocessor wherein the consumer and/or customer engages the third party but the actual service and/or product that they are interested in and/or purchase and/or receive is provided through an enterprise and/or service provider.

A “user” as used herein may refer to, but is not limited to, an individual or group of individuals. This includes, but is not limited to, private individuals, employees of organizations and/or enterprises, members of community organizations, members of charity organizations, men and women. In its broadest sense the user may further include, but not be limited to, software systems, mechanical systems, robotic systems, android systems, etc. that may be characterised by an ability to exploit one or more embodiments of the invention. A user may also be associated through one or more accounts and/or profiles with one or more of a service provider, third party provider, enterprise, social network, social media etc. via a dashboard, web service, website, software plug-in, software application, and graphical user interface.

“Biometric” information as used herein may refer to, but is not limited to, data relating to a user characterised by data relating to a subset of conditions including, but not limited to, their environment, medical condition, biological condition, physiological condition, chemical condition, ambient environment condition, position condition, neurological condition, drug condition, and one or more specific aspects of one or more of these said conditions. Accordingly, such biometric information may include, but not be limited, blood oxygenation, blood pressure, blood flow rate, heart rate, temperate, fluidic pH, viscosity, particulate content, solids content, altitude, vibration, motion, perspiration, EEG, ECG, energy level, etc. In addition, biometric information may include data relating to physiological characteristics related to the shape and/or condition of the body wherein examples may include, but are not limited to, fingerprint, facial geometry, baldness, DNA, hand geometry, odour, and scent. Biometric information may also include data relating to behavioral characteristics, including but not limited to, typing rhythm, gait, and voice.

“User information” as used herein may refer to, but is not limited to, user behavior information and/or user profile information. It may also include a user's biometric information, an estimation of the user's biometric information, or a projection/prediction of a user's biometric information derived from current and/or historical biometric information.

A “wearable device” or “wearable sensor” relates to miniature electronic devices that are worn by the user including those under, within, with or on top of clothing and are part of a broader general class of wearable technology which includes “wearable computers” which in contrast are directed to general or special purpose information technologies and media development. Such wearable devices and/or wearable sensors may include, but not be limited to, smartphones, smart watches, e-textiles, smart shirts, activity trackers, smart glasses, environmental sensors, medical sensors, biological sensors, physiological sensors, chemical sensors, ambient environment sensors, position sensors, neurological sensors, drug delivery systems, medical testing and diagnosis devices, and motion sensors.

“Electronic content” (also referred to as “content” or “digital content”) as used herein may refer to, but is not limited to, any type of content that exists in the form of digital data as stored, transmitted, received and/or converted wherein one or more of these steps may be analog although generally these steps will be digital. Forms of digital content include, but are not limited to, information that is digitally broadcast, streamed or contained in discrete files. Viewed narrowly, types of digital content include popular media types such as MP3, JPG, AVI, TIFF, AAC, TXT, RTF, HTML, XHTML, PDF, XLS, SVG, WMA, MP4, FLV, and PPT, for example, as well as others, see for example http://en.wikipedia.org/wiki/List_of_file_formats. Within a broader approach digital content mat include any type of digital information, e.g., digitally updated weather forecast, a GPS map, an eBook, a photograph, a video, a Vine™, a blog posting, a Facebook™ posting, a Twitter™ tweet, online TV, etc. The digital content may be any digital data that is at least one of generated, selected, created, modified, and transmitted in response to a user request, said request may be a query, a search, a trigger, an alarm, and a message for example.

A “profile” as used herein, and throughout this disclosure, refers to a computer and/or microprocessor readable data file comprising data relating to settings and/or limits of an adult device. Such profiles may be established by a manufacturer/supplier/provider of a device, service, etc. or they may be established by a user through a user interface for a device, a service or a PED/FED in communication with a device, another device, a server or a service provider etc.

“Metadata” as used herein, and throughout this disclosure, refers to information stored as data that provides information about other data. Many distinct types of metadata exist, including but not limited to, descriptive metadata, structural metadata, administrative metadata, reference metadata and statistical metadata. Descriptive metadata may describe a resource for purposes such as discovery and identification and may include, but not be limited to, elements such as title, abstract, author, and keywords. Structural metadata relates to containers of data and indicates how compound objects are assembled and may include, but not be limited to, how pages are ordered to form chapters, and typically describes the types, versions, relationships and other characteristics of digital materials. Administrative metadata may provide information employed in managing a resource and may include, but not be limited to, when and how it was created, file type, technical information, and who can access it. Reference metadata may describe the contents and quality of statistical data whereas statistical metadata may also describe processes that collect, process, or produce statistical data. Statistical metadata may also be referred to as process data.

An “artificial intelligence system” (referred to hereafter as artificial intelligence, AI) as used herein, and throughout disclosure, refers to machine intelligence or machine learning in contrast to natural intelligence. An AI may refer to analytical, human inspired, or humanized artificial intelligence. An AI may refer to the use of one or more machine learning algorithms and/or processes. An AI may employ one or more of an artificial network, decision trees, support vector machines, Bayesian networks, and genetic algorithms. An AI may employ a training model or federated learning.

“Machine Learning” (ML) or more specifically machine learning processes as used herein refers to, but is not limited, to programs, algorithms or software tools, which allow a given device or program to learn to adapt its functionality based on information processed by it or by other independent processes. These learning processes are in practice, gathered from the result of said process which produce data and or algorithms that lend themselves to prediction. This prediction process allows ML-capable devices to behave according to guidelines initially established within its own programming but evolved as a result of the ML. A machine learning algorithm or machining learning process as employed by an AI may include, but not be limited to, supervised learning, unsupervised learning, cluster analysis, reinforcement learning, feature learning, sparse dictionary learning, anomaly detection, association rule learning, inductive logic programming.

Within the following specification reference is made to an Arbitrarily Configurable Sensor and Control (ACSC) and an ACSC Module. An ACSC may be an ACSC Module and vice-versa. An ACSC and/or ACSC Module may be employed discretely or as part of an assembly of ACSCs and/or ACSC Modules, referred to an ACSC Array within the specification.

### 1: Network Environment and Device Associations

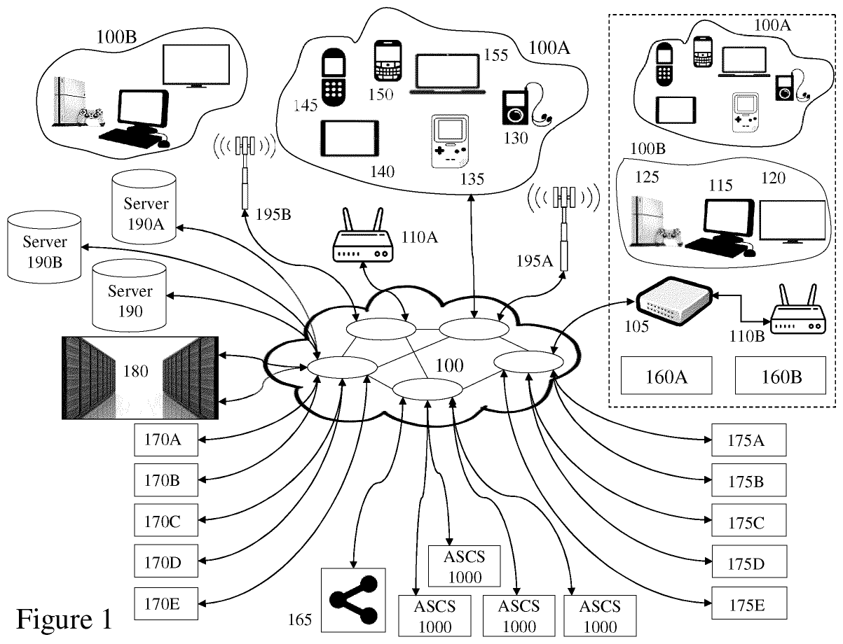

Referring to FIG. 1 there is depicted a Network 100 within which embodiments of the invention may be employed supporting Arbitrarily Configurable Sensor and Control (ACSCACSC) Systems, Applications and Platforms (ACSC-SAPs) according to embodiments of the invention. Such ACSC-SAPs, for example, supporting multiple communication channels, dynamic filtering, etc. As shown first and second user groups 100A and 100B respectively interface to a telecommunications Network 100. Within the representative telecommunication architecture, a remote central exchange 180 communicates with the remainder of a telecommunication service providers network via the Network 100 which may include for example long-haul OC-48/OC-192 backbone elements, an OC-48 wide area network (WAN), a Passive Optical Network, and a Wireless Link. The central exchange 180 is connected via the Network 100 to local, regional, and international exchanges (not shown for clarity) and therein through Network 100 to first and second cellular APs 195A and 195B respectively which provide Wi-Fi cells for first and second user groups 100A and 100B, respectively. Also connected to the Network 100 are first and second Wi-Fi nodes 110A and 110B, the latter of which being coupled to Network 100 via router 105. Second Wi-Fi node 110B is associated with commercial service provider 160, e.g., Gillette Stadium™, comprising other first and second user groups 100A and 100B. Second user group 100B may also be connected to the Network 100 via wired interfaces including, but not limited to, DSL, Dial-Up, DOCSIS, Ethernet, G.hn, ISDN, MoCA, PON, and Power line communication (PLC) which may or may not be routed through a router such as router 105.

Within the cell associated with first AP 110A the first group of users 100A may employ a variety of PEDs including for example, laptop computer 155, portable gaming console 135, tablet computer 140, smartphone 150, cellular telephone 145 as well as portable multimedia player 130. Within the cell associated with second AP 110B are the second group of users 100B which may employ a variety of FEDs including for example gaming console 125, personal computer 115 and wireless/Internet enabled television 120 as well as cable modem 105. First and second cellular APs 195A and 195B respectively provide, for example, cellular GSM (Global System for Mobile Communications) telephony services as well as 3G and 4G evolved services with enhanced data transport support. Second cellular AP 195B provides coverage in the embodiment to first and second user groups 100A and 100B. Alternatively the first and second user groups 100A and 100B may be geographically disparate and access the Network 100 through multiple APs, not shown for clarity, distributed geographically by the network operator or operators. First cellular AP 195A as show provides coverage to first user group 100A and environment 170, which comprises second user group 100B as well as first user group 100A. Accordingly, the first and second user groups 100A and 100B may according to their particular communications interfaces communicate to the Network 100 through one or more wireless communications standards such as, for example, IEEE 802.11, IEEE 802.15, IEEE 802.16, IEEE 802.20, UMTS, GSM 850, GSM 900, GSM 1800, GSM 1900, GPRS, ITU-R 5.138, ITU-R 5.150, ITU-R 5.280, and IMT-1000. It would be evident to one skilled in the art that many portable and fixed electronic devices may support multiple wireless protocols simultaneously, such that for example a user may employ GSM services such as telephony and SMS and Wi-Fi/WiMAX data transmission, VOIP and Internet access. Accordingly, portable electronic devices within first user group 100A may form associations either through standards such as IEEE 802.15 or Bluetooth as well in an ad-hoc manner.

Also connected to the Network 100 are Social Networks (SOCNETS) 165, first and second service providers 170A and 170B respectively, first and second third party service providers 170C and 170D respectively, and a user 170E. Also connected to the Network 100 are first and second enterprises 175A and 175B respectively, first and second organizations 175C and 175D respectively, and a government entity 175E. Also depicted are first and second servers 190A and 190B may host according to embodiments of the inventions multiple services associated with a provider of Arbitrarily Configurable Sensor and Control applications/platforms (ACSC-SAPs); a provider of a SOCNET or Social Media (SOME) exploiting ACSC-SAP features; a provider of a SOCNET and/or SOME not exploiting ACSC-SAP features; a provider of services to PEDS and/or FEDS; a provider of one or more aspects of wired and/or wireless communications; an Enterprise 160 such as Multiple Listing Service (MLS) exploiting ACSC-SAP features; license databases; content databases; image databases; content libraries; customer databases; websites; and software applications for download to or access by FEDs and/or PEDs exploiting and/or hosting ACSC-SAP features. First and second primary content servers 190A and 190B may also host for example other Internet services such as a search engine, financial services, third party applications and other Internet based services.

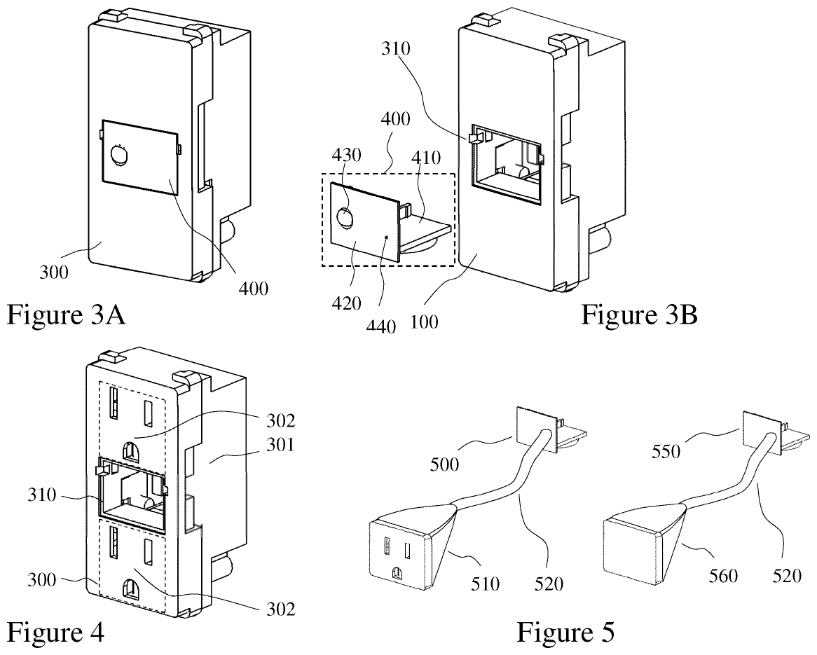

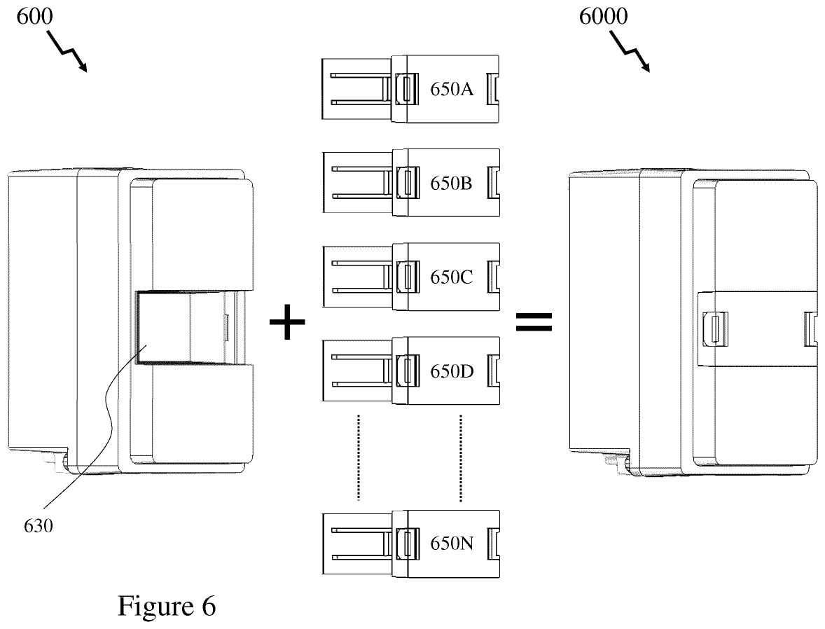

Also depicted in FIG. 1 are Arbitrarily Configurable Sensor and Control devices (ACSCs) 1000 according to embodiments of the invention such as described and depicted below in respect of FIGS. 3A to 44. As depicted in FIG. 1 the ACSCs 1000 communicate directly to the Network 100. The ACSCs 1000 may communicate to the Network 100 through one or more wireless or wired interfaces included those, for example, selected from the group comprising IEEE 802.11, IEEE 802.15, IEEE 802.16, IEEE 802.20, UMTS, GSM 850, GSM 900, GSM 1800, GSM 1900, GPRS, ITU-R 5.138, ITU-R 5.150, ITU-R 5.280, IMT-1000, DSL, Dial-Up, DOCSIS, Ethernet, G.hn, ISDN, MoCA, PON, and Power line communication (PLC).

Accordingly, an Arbitrarily Configurable Sensor and Control (ACSC) device may exploit a PED and/or FED within an Enterprise 160, for example, and access one of the first or second primary content servers 190A and 190B respectively to perform an operation such as accessing/downloading an application which provides ACSC-SAP features according to embodiments of the invention; execute an application already installed providing ACSC-SAP features; execute a web based application providing ACSC-SAP features; or access content. Similarly, a CONCUS may undertake such actions or others exploiting embodiments of the invention exploiting a PED or FED within first and second user groups 100A and 100B respectively via one of first and second cellular APs 195A and 195B respectively and first Wi-Fi nodes 110A. It would also be evident that a ACSC device may, via exploiting Network 100 communicate via telephone, fax, email, SMS, social media, etc.

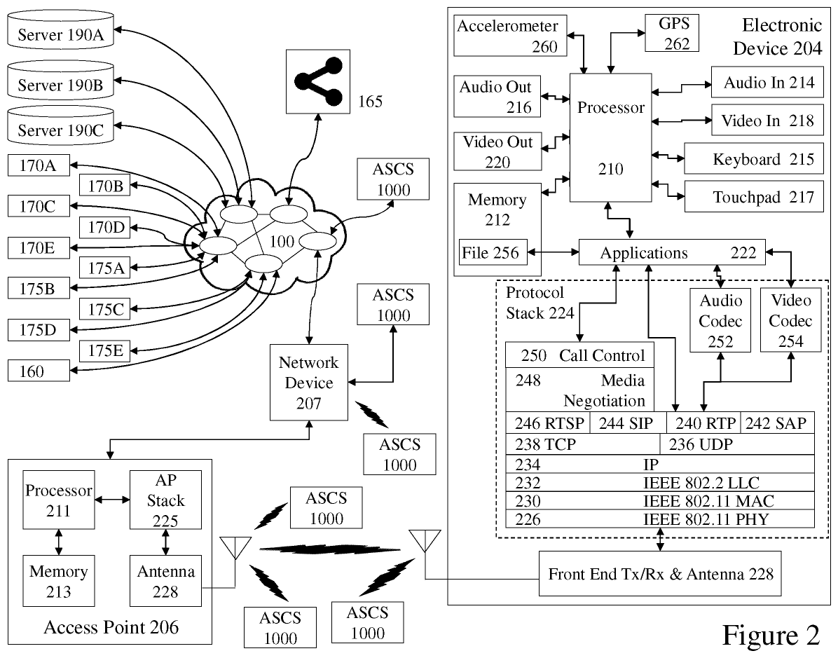

Now referring to FIG. 2 there is depicted an Electronic Device 204 and network access point 207 supporting ACSC-SAP features according to embodiments of the invention. Electronic Device 204 may, for example, be a PED and/or FED and may include additional elements above and beyond those described and depicted allowing it to communicate with one or more Arbitrarily Configurable Sensor and Control (ACSC) device 1000. Alternatively, Electronic Device 204 may represent an embodiment of an ACSC 1000 according to embodiments of the invention. Also depicted within the Electronic Device 204 is the protocol architecture as part of a simplified functional diagram of a system that includes an Electronic Device 204, such as a smartphone 155, an access point (AP) 206, such as first AP 110, and one or more network devices 207, such as communication servers, streaming media servers, and routers for example such as first and second servers 190A and 190B respectively. Network devices 207 may be coupled to AP 206 via any combination of networks, wired, wireless and/or optical communication links such as discussed above in respect of FIG. 1 as well as directly as indicated. Network devices 207 are coupled to Network 100 and therein Social Networks (SOCNETS) 165, first and second service providers 170A and 170B respectively, first and second third party service providers 170C and 170D respectively, a user 170E, first and second enterprises 175A and 175B respectively, first and second organizations 175C and 175D respectively, and a government entity 175E.

The Electronic Device 204 includes one or more processors 210 and a memory 212 coupled to processor(s) 210. AP 206 also includes one or more processors 211 and a memory 213 coupled to processor(s) 210. A non-exhaustive list of examples for any of processors 210 and 211 includes a central processing unit (CPU), a digital signal processor (DSP), a reduced instruction set computer (RISC), a complex instruction set computer (CISC) and the like. Furthermore, any of processors 210 and 211 may be part of application specific integrated circuits (ASICs) or may be a part of application specific standard products (ASSPs). A non-exhaustive list of examples for memories 212 and 213 includes any combination of the following semiconductor devices such as registers, latches, ROM, EEPROM, flash memory devices, non-volatile random access memory devices (NVRAM), SDRAM, DRAM, double data rate (DDR) memory devices, SRAM, universal serial bus (USB) removable memory, and the like.

Electronic Device 204 may include an audio input element 214, for example a microphone, and an audio output element 216, for example, a speaker, coupled to any of processors 210. Electronic Device 204 may include a video input element 218, for example, a video camera or camera, and a video output element 220, for example an LCD display, coupled to any of processors 210. Electronic Device 204 also includes a keyboard 215 and touchpad 217 which may for example be a physical keyboard and touchpad allowing the user to enter content or select functions within one of more applications 222. Alternatively, the keyboard 215 and touchpad 217 may be predetermined regions of a touch sensitive element forming part of the display within the Electronic Device 204. The one or more applications 222 that are typically stored in memory 212 and are executable by any combination of processors 210. Electronic Device 204 also includes accelerometer 260 providing three-dimensional motion input to the process 210 and GPS 262 which provides geographical location information to processor 210.

Electronic Device 204 includes a protocol stack 224 and AP 206 includes a communication stack 225. Within system 200 protocol stack 224 is shown as IEEE 802.11 protocol stack but alternatively may exploit other protocol stacks such as an Internet Engineering Task Force (IETF) multimedia protocol stack for example. Likewise, AP stack 225 exploits a protocol stack but is not expanded for clarity. Elements of protocol stack 224 and AP stack 225 may be implemented in any combination of software, firmware and/or hardware. Protocol stack 224 includes an IEEE 802.11-compatible PHY module 226 that is coupled to one or more Front-End Tx/Rx & Antenna 228, an IEEE 802.11-compatible MAC module 230 coupled to an IEEE 802.2-compatible LLC module 232. Protocol stack 224 includes a network layer IP module 234, a transport layer User Datagram Protocol (UDP) module 236 and a transport layer Transmission Control Protocol (TCP) module 238.

Protocol stack 224 also includes a session layer Real Time Transport Protocol (RTP) module 240, a Session Announcement Protocol (SAP) module 242, a Session Initiation Protocol (SIP) module 244 and a Real Time Streaming Protocol (RTSP) module 246. Protocol stack 224 includes a presentation layer media negotiation module 248, a call control module 250, one or more audio codecs 252 and one or more video codecs 254. Applications 222 may be able to create maintain and/or terminate communication sessions with any of devices 207 by way of AP 206. Typically, applications 222 may activate any of the SAP, SIP, RTSP, media negotiation and call control modules for that purpose. Typically, information may propagate from the SAP, SIP, RTSP, media negotiation and call control modules to PHY module 226 through TCP module 238, IP module 234, LLC module 232 and MAC module 230.

It would be apparent to one skilled in the art that elements of the Electronic Device 204 may also be implemented within the AP 206 including but not limited to one or more elements of the protocol stack 224, including for example an IEEE 802.11-compatible PHY module, an IEEE 802.11-compatible MAC module, and an IEEE 802.2-compatible LLC module 232. The AP 206 may additionally include a network layer IP module, a transport layer User Datagram Protocol (UDP) module and a transport layer Transmission Control Protocol (TCP) module as well as a session layer Real Time Transport Protocol (RTP) module, a Session Announcement Protocol (SAP) module, a Session Initiation Protocol (SIP) module and a Real Time Streaming Protocol (RTSP) module, media negotiation module, and a call control module. Portable and fixed electronic devices represented by Electronic Device 204 may include one or more additional wireless or wired interfaces in addition to the depicted IEEE 802.11 interface which may be selected from the group comprising IEEE 802.15, IEEE 802.16, IEEE 802.20, UMTS, GSM 850, GSM 900, GSM 1800, GSM 1900, GPRS, ITU-R 5.138, ITU-R 5.150, ITU-R 5.280, IMT-1000, DSL, Dial-Up, DOCSIS, Ethernet, G.hn, ISDN, MoCA, PON, and Power line communication (PLC).

Also depicted in FIG. 2 are ACSCs 1000 according to embodiments of the invention such as described and depicted below in respect of FIGS. 3A to 44. As depicted in FIG. 2 an ACSCs 1000 may communicate directly to the Network 100. Other ACSCs 1000 may communicate to the Network Device 207, Access Point 206, and Electronic Device 204. Some ACSCs 1000 may communicate to other ACSCs 1000 directly. Within FIG. 2 the ACSCs 1000 coupled to the Network 100 and Network Device 207 communicate via wired interfaces. The ACSCs 1000 coupled to the Access Point 206 and Electronic Device 204 communicate via wireless interfaces. Each ACSC 1000 may communicate to another electronic device, e.g., Access Point 206, Electronic Device 204 and Network Device 207, or a network, e.g., Network 100. Each ACSC 1000 may support one or more wireless or wired interfaces including those, for example, selected from the group comprising IEEE 802.11, IEEE 802.15, IEEE 802.16, IEEE 802.20, UMTS, GSM 850, GSM 900, GSM 1800, GSM 1900, GPRS, ITU-R 5.138, ITU-R 5.150, ITU-R 5.280, IMT-1000, DSL, Dial-Up, DOCSIS, Ethernet, G.hn, ISDN, MoCA, PON, and Power line communication (PLC).

Accordingly, FIG. 2 depicts an Electronic Device 204, e.g. a PED, wherein one or more parties including, but not limited to, a user, users, an enterprise, enterprises, third party provider, third party providers, wares provider, wares providers, financial registry, financial registries, financial provider, and financial providers may engage in one or more financial transactions relating to an activity including, but not limited to, e-business, P2P, C2B, B2B, C2C, B2G, C2G, P2D, and D2D via the Network 100 using the electronic device or within either the access point 206 or network device 207 wherein details of the transaction are then coupled to the Network 100 and stored within remote servers.

Optionally, rather than wired and./or wireless communication interfaces devices may exploit other communication interfaces such as optical communication interfaces and/or satellite communications interfaces. Optical communications interfaces may support Ethernet, Gigabit Ethernet, SONET, Synchronous Digital Hierarchy (SDH) etc.

### 2: Reconfigurable Module Via Insert

Within embodiments of the invention an Arbitrarily Configurable Sensor and Control device (ACSC) may form part of an overall device wherein the configuration of the device is established in an arbitrary manner as ACSCs may be connected within an overall stack where the sequence of ACSCs is essentially arbitrary in that, for example, a set of 3 ACSCs may be assembled in 6 different permutations. This can be generalized for n ASCSs in that they can be configured in n! ways. Accordingly, n ACSCs can be assembled without consideration of the order in which they are assembled or an n^{th} ACSC can be added to an existing assembly of n−1 ACSCs without consideration of what these previous ACSCs are.

Within embodiments of the invention as described below one ACSC may be a master with the other slaves. The master ACSC may be a pre-requisite initial ACSC in an ACSC assembly or it may be dynamically established in dependence upon the ACSCs assembled. As discussed below some ACSCs may be “cap” devices wherein they are always established at an end of the ACSC assembly. For example, an ACSC base module may employ an ACSC cap module wherein other ACSCs can be inserted into the stack in an arbitrary sequence but the ACSC cap is always the outermost ACSC at one end of the stack and the ACSC base module at the other end of the stack.

Further, an ACSC within an ACSC assembly or an ACSC discretely may be configured or reconfigured without consideration of the overall ACSC assembly it is within. Accordingly, a subset of ACSCs may accept inserts that define their functionality or augment a pre-installed functionality. For example, an ACSC may provide a gas sensing function but may be initially configured by the addition of a nightlight insert before being subsequently reconfigured for the nightlight insert to be replaced with a Bluetooth wireless repeater functionality or a light sensor etc. for example. An ACSC assembly or an ACSC discretely may contain one or more of sensors, communications interfaces, power interfaces, processing modules, and control interface.

Within the following description a set of stacked or assembled ACSC elements are referred to as an ACSC array.

Within embodiments of the invention the array may be one-dimensional (1D) such that the modules are sequentially in a linear array.

Within embodiments of the invention the array may be two-dimensional (2D) such that the modules populate each point in a 2D array or a subset of connected elements within a 2D array. For example, 4 ACSCs may be formed into a 2×2 array or may be formed as a row and column of the 2D array with 2 ACSCs in the row and 3 ACSCs in the column or vice-versa.

Within embodiments of the invention the array may be three-dimensional (3D) such that the modules populate each point in a 3D array or a subset of connected elements within a 3D array.

The orientation of the ACSC array, be it 1D, 2D, 3D may within embodiments of the invention be arbitrary spatially or it may be defined by one ACSC within the ACSC array such as ACSC module being designed to mount to a wall, to a floor, or to a ceiling for example. Within other embodiments the ACSC module defining the spatial orientation of the ACSC array may be fixed at arbitrary angles relative to the environment defining a space it is deployed within where this space may be an internal space or an external space (e.g., outside rather than inside).

Now referring to FIG. 3A there is depicted an ACSC 300 according to an embodiment of the invention. For simplicity interfaces of the ACSC 300 to other ACSCs are not depicted. Within embodiments of the invention an ACSC may have only one set of interfaces to other ACSCs such that it is an ACSC cap module as the inventors define it such that it is always an outermost ACSC in a stack of ACSCs. Within embodiments of the invention an ACSC may be designed to accept one or more inserts whilst within other embodiments of the invention it may be designed to not accept an insert. As depicted in FIG. 3A the ACSC 300 includes a single Insert 400 which is, for example, an ambient light sensor to provide input for a control aspect of the ACSC array it forms part of or it may be an optical emitter to provide visible illumination based upon a decision or control input made by the ACSC it is within or by another ACSC within an ACSC array.

Within the following description inserts such as Insert 400 are depicted with a rectangular design and inserted into an ACSC, such as ACSC 300, in a particular orientation with respect to the ACSC. However, the inserts may have other geometries including, but not limited to, square, hexagonal, a regular polygon, an irregular polygon, circular and elliptical. Further, an ACSC may be designed to accept inserts of only one geometry or two or more geometries within the scope of the invention. Similarly, the orientation of the inserts within the ACSC may vary have orientations including but not limited to those aligned with an axis of the ACSC, aligned with an edge or facet of the ACSC, and aligned at an angle to an axis or facet or edge of the ACSC. The ACSC may have inserts with a single orientation with respect to itself or with two or more orientations with respect to itself. The orientation of the inserts with respect to the ACSC may be defined by an aspect of the environment the ACSC is deployed within.

FIG. 3B provides an exploded view of the ACSC 300 and Insert 400. Insert 400 is inserted into Cavity 310 in ACSC 300. Insert 400 provides a physical and electrical interface for various insert configurations, each of which can provide alternate functionality. In the illustrated embodiment, Insert 400 provides illumination via Light 430, although alternate inserts can provide other functions such as chargers for different connections, additional outlets, smoke detectors, wireless nodes, microphones, loudspeakers, sensors, power outlets, switches, control outputs and other functions that will be apparent to those skilled in the art. Insert 400 includes a printed circuit board (PCB) 410 that houses the control circuitry and elements for the intended functionality. Faceplate 420 provides a cover that may match with surface of the ACSC 300 although within other embodiments of the invention it may be different, textured differently, coloured differently, prominent or recessed. On the Faceplate 420 is provided the Light 430, for example a light emitting diode (LED), and a Test Switch 440 which can be used to determine if the insert is functional.

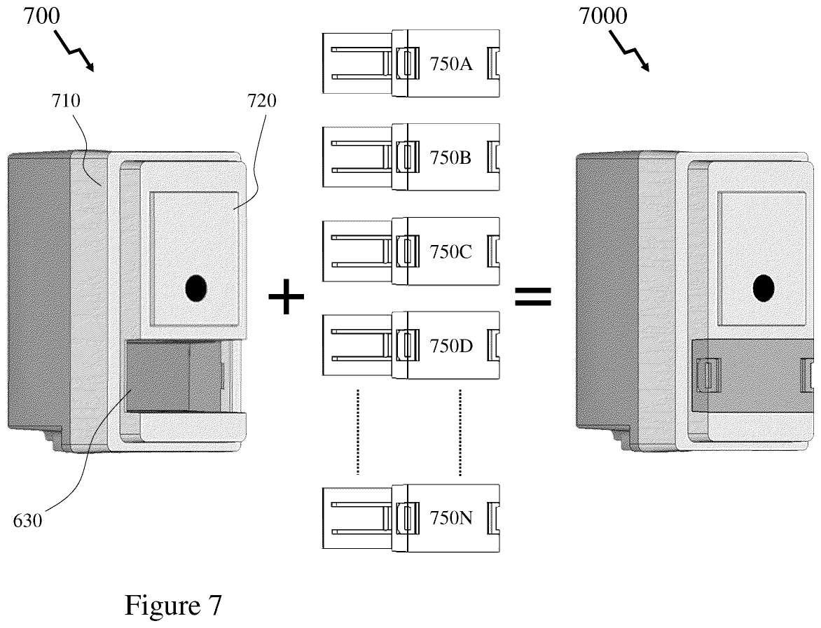

Now referring to FIG. 4 there is depicted an ACSC 300 according to an embodiment of the present invention with the insert removed. As shown, the body of the ACSC 300 provides a Cavity 310 within which the insert can be inserted or removed from. As depicted the ACSC 300 provides two power outlets. These outlets may, within embodiments of the invention, be selectively powered in dependence upon a control signal generated either by the ACSC 300 itself in dependence upon processing data from an insert inserted into Cavity 310 or from another ACSC based upon its processing from one or more inserts or received control signals from external controllers communicating with the ACSC array through a wireless interface for example. For example, the ACSC 300 may allow connection of an external light which is enabled when the detected light level drops, a dehumidifier which is enabled when a humidity sensor determines the humidity has exceeded a threshold, or a radon mitigation system enabled as a radon sensor has established radon exceeding a threshold. The ACSC 300 may provide a standard electrical connection means to main power, e.g., 120V AC, 240V AC, 100V AC etc. through the ACSC Sockets 302 on the face or it may provide non-standard power. Whilst the ACSC 300 is depicted with 3-pin North American ACSC Sockets 302 in FIG. 4 it would be evident that other ACSC Sockets 302 may be provided to meet the electrical standards of one or more jurisdictions within which the ACSC 300 will be employed. Further, whilst the mains power may be described within this specification as being mains power at 120V AC, 240V AC, 100V AC for residential mains within North America, Europe and Japan respectively it would be evident that other voltages/ampere outputs can be provided. It would be evident that power may also be DC voltage provided through an AC-DC or DC-DC transformer within the ACSC. For example, the output may be 12V 2.5A for example through a Universal Serial Bus (USB) connector or 48V DC for supplying a DIN rail or industrial automation equipment etc. Within embodiments of the invention:
the ACSC 300 may receive AC power at a first voltage and provide AC power at a second voltage to the insert through electrical connections within the Cavity 310 such as described below;
the ACSC 300 may receive AC power at a first voltage and provide DC power at a second voltage to the insert through electrical connections within the Cavity 310 such as described below;
the ACSC 300 may receive DC power at a first voltage and provide AC power at a second voltage to the insert through electrical connections within the Cavity 310 such as described below; and
the ACSC 300 may receive DC power at a first voltage and provide DC power at a second voltage to the insert through electrical connections within the Cavity 310 such as described below.

Within other embodiments of the invention the ACSC 300 may receive electrical power at a first frequency and provide electrical power at a second frequency. The first frequency may, for example, be 50 Hz, 60 Hz, 400 Hz etc. The ACSC 300 may receive DC power at predetermined voltages including, but not limited to, 48V and 60V. Whilst in most embodiments of the invention the electrical power received by a ACSC 300 may be according to a standard, e.g. national standard, international standard, application standard (e.g. telecommunications, aircraft etc.), etc. in other embodiments of the invention the electrical power received may be at a standard set by a manufacturer. Whilst in most embodiments of the invention the electrical power provided by a ACSC 300 to an insert may be according to a standard, e.g. national standard, international standard, application standard (e.g. telecommunications, aircraft, etc.), etc. in other embodiments of the invention the electrical power received may be at a standard set by a manufacturer of either the inserts and/or the ACSCs 300.

Within embodiments of the invention the insert may provide a power outlet as described below.

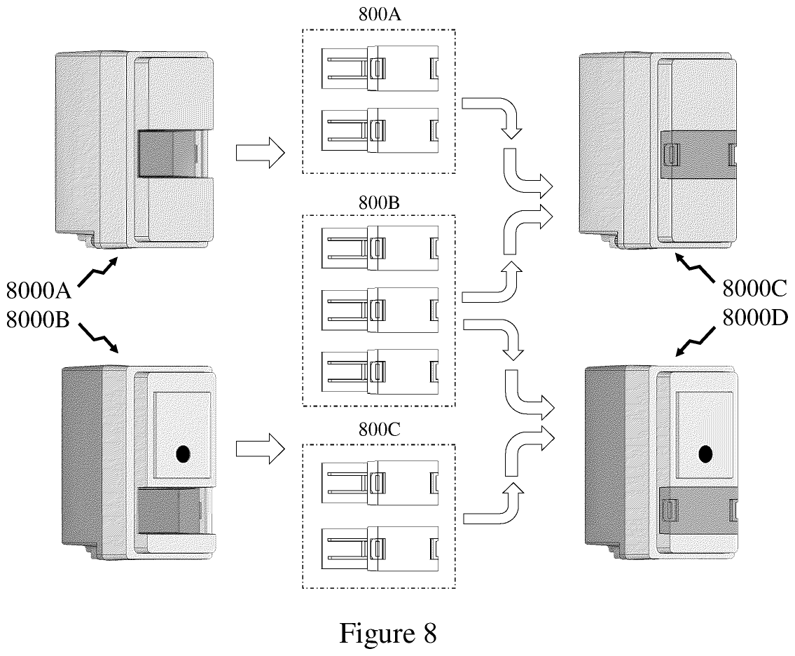

Now referring to FIG. 5 there is depicted a representation of a first Insert 500 providing power through an extension rather through a socket interface of the ACSC or an insert of the ACSC. Accordingly, the first Insert 500 has a Cable 520 which terminates in an External Socket 510. As with the ACSC Sockets 302 the External Socket 510 can provide a socket for a defined standard electrical plug or plugs, a socket for a custom vendor specific plug, etc. Electrical Socket 510 may also provide two or more sockets for interfacing to external devices. Optionally, Electrical Socket 510 may within other embodiments of the invention be a connector providing control signals to an item of external equipment connected to and controlled by the ACSC Module the Insert 500 forms part of or by an ACSC Array that the ACSC Module with the Insert 500 forms part of.

Also depicted in FIG. 5 is a representation of a second Insert 550 providing an external sensor capability to an ACSC Module the Insert 500 forms part of or an ACSC Array that the ACSC Module with the Insert 500 forms part of. Accordingly, the second Insert 500 has a Cable 520 which terminates in an External Sensor 560.

The assembled Insert 400 within some embodiments of the invention is retained within the ACSC 300 by a mounting mechanisms such as latches, e.g., plastic latches, on the insert. These latches can provide protection from accidental removal and child protection as the removal of such embodiments of the invention with latches require a small screwdriver or specialized tool on both the left and right side of the insert to unlock the latches for removal. The latches engage mating latching elements upon the ACSC. Within other embodiments of the invention the mounting mechanism may be a screw in retention means for example, a sliding retainer engagement, etc. In some embodiments of the invention no retention means is provided except, potentially, that of a rear connector on the insert engaging a connector within the cavity of the ACSC

As will become evident from the following a variety of functions can be implemented within the inserts, e.g., Insert 400. It would be evident to one of skill in the art that some inserts, e.g., Insert 400, may provide multiple functionality. It would also be evident to one of skill in the art that the functionality, number of functions, etc. within an insert, e.g. Insert 400, may depend upon a variety of factors including, but not limited to, cost, format of insert, size of insert, technology employed in implementing the function(s) of the insert, available power, legal requirements, jurisdictional constraints, and function specifications.

Within other embodiments of the invention other functionalities may be provided without departing from the scope of the invention. In some embodiments of the invention the insert within the ACSC receives mains power (e.g., 120V AC), reduced AC power, DC power, regulated DC power or a combination thereof. Amongst alternate inserts would be those providing for the powering/charging of other electronic devices without the requirement to consume an electrical output (socket or plug) of the insert or provide an AC-DC adapter. For example, many PEDs, wearable devices etc. are designed to draw power for operation or charging from a Universal Serial Bus (USB) connection, e.g. USB-A, USB-B, USB-C. Accordingly, an insert may receive an AC or DC signal and contain a current converter that transforms the AC or DC current to an appropriate DC current/voltage and provides a USB connector allowing for the charging of devices, e.g. PEDs, wearable devices etc. It would be evident that the current converter can be implemented using any of a number of standard devices including transformers, rectifiers and other devices that will be well known to those skilled in the art.

Within other embodiments of the invention other functionalities may be provided without departing from the scope of the invention. In some embodiments of the invention computer network connections can be provided in inserts. Additional contacts can be provided so that computer networking cabling can be connected to the ACSC and accessed through the insert. Alternatively, power-line networking connections can be provided using industry standard interfaces. Such a design provides network connectivity to any location where a PED, FED, or wearable device is to be plugged in to an outlet of the ACSC for power. In some embodiments of the invention the insert may provide storage for a cable and connector or it may provide a network jack connection.

Within other embodiments of the invention other functionalities may be provided without departing from the scope of the invention. In some embodiments of the invention a wireless transceiver can be employed and powered from the contacts connecting to the electrical main. The wireless transceiver can be, for example, an industry standard such as IEEE802.11, Bluetooth or a wide area networking standard such as WiMAX. Optionally, an insert may support multiple wireless standards concurrently. Alternatively, a proprietary networking standard can be provided.

Within other embodiments of the invention other functionalities may be provided without departing from the scope of the invention. In some embodiments of the invention one or more sensors may be implemented within the insert. Such sensors may include, but not be limited to, motion detectors, security system sensors, smoke detectors, radon detectors, noxious gas detectors such as carbon dioxide detectors, carbon monoxide detectors and natural gas detectors, which can be implemented by those skilled in the art by placing standard designs for these system on an insert and drawing electrical power from the power main. It would be evident to one of skill in the art that such sensors may further include, but not be limited to, environmental sensors, medical sensors, biological sensors, chemical sensors, ambient environment sensors, position sensors, motion sensors, thermal sensors, infrared sensors, visible sensors, RFID sensors, medical testing and diagnosis devices, and neurological sensors. Within other embodiments of the invention the insert may comprise control and timing functionality allowing the insert to control one or more other external devices such as irrigation systems, lighting, drug delivery systems, alarms, etc. As will be described below such control and/or timing functionality may include the provisioning of embedded or remotely accessed artificial intelligence (AI) in the decision making.

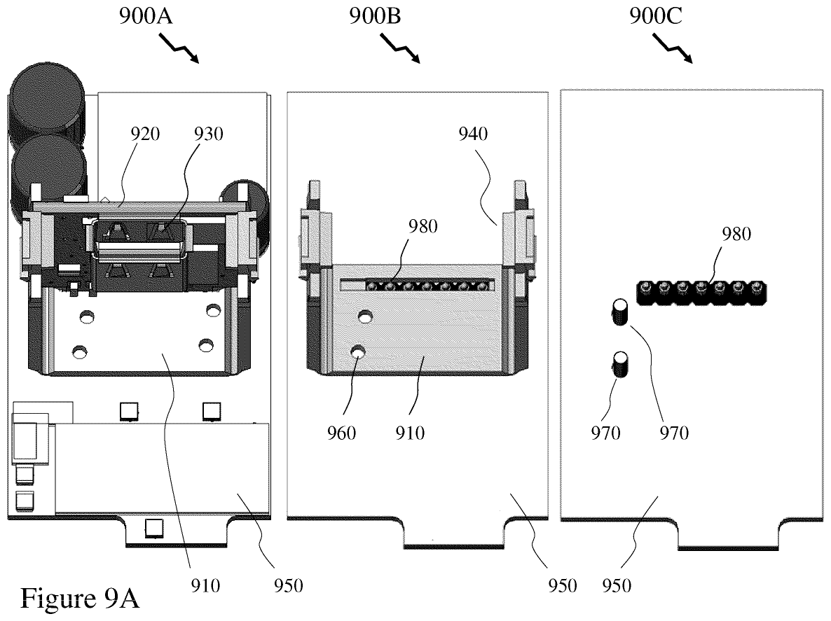

Referring to FIG. 6 there is depicted a configurable ASCS 6000 comprising an ACSC 600 which features a Cavity 630. A replaceable insert may be disposed within the Cavity 630 such as Inserts 650A to 650N respectively which may comprise a blank insert 650A, Wi-Fi node 650B, nightlight 650C, motion detector 650D and smoke detector 650N for example. Accordingly, ASCS 6000 provides a user selectable function with the one of the Inserts 650A to 650N, respectively.

It would be evident that other functionality for the Inserts 650A to 650N may be provided without departing from the scope of the invention. An insert may provide a socket or plug according to a standard communications interface such as a serial interface or a parallel interface. This interface may be electrical or optical. Examples of such interfaces include, but are not limited to, Ethernet, Fiber Channel, HDMI, Ethernet, RS-232, RS-422, SCSI, USB, PCI, ATA, and IEEE 488.

Within FIG. 6 the ACSC 6000 provided a functionality determined by the insert employed without any external interfaces. However, the ACSC 6000 may have provided other functionality such as a wireless repeaters, wireless hub etc. embedded within the ACSC 6000. However, referring to FIG. 7 there is depicted an ACSC 7000 according to an embodiment of the invention which comprises an ACSC Module 700 which features a Body 710 within which is a Functional Element 720 and a Cavity 630. A replaceable insert may be disposed within the Cavity 630 such as Inserts 750A to 750N respectively or other according to other embodiments of the invention. Accordingly, ACSC 7000 as depicted provides multiple functionality with the Functional Element 720 pre-installed and a user selectable function with the one of a plurality of inserts inserted within the Cavity 630. The Functional Element 630 may be an optical source, optical receiver (e.g., light detector or infrared detector control data receipt etc.), an audio signal generator, a visible signal generator (e.g., LED or LCD display etc.), motion detector, electrical power socket, electrical power plug, data communications interface, etc. Accordingly, one or more ACSC 7000 within an ACSC array provide both pre-defined functionality and reconfigurable functionality via the inserts that can be inserted into the Cavity 630.

### 3: Blocked and Enabled Insert Subsets for ACSCs

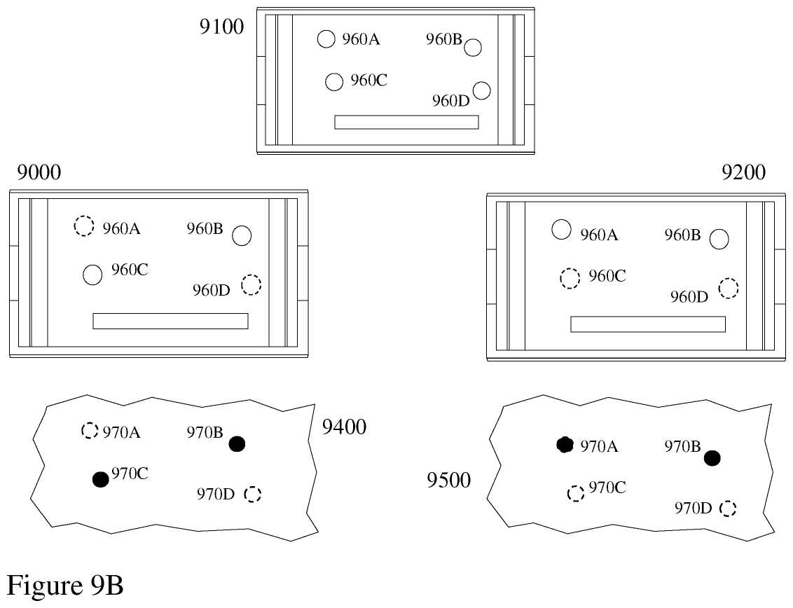

Now referring to FIG. 8 there are depicted applications of insert restrictions to ACSCs based upon the pre-installed functionality of the ACSC according to an embodiment of the invention. Accordingly, a first ACSC 8000A is depicted wherein inserts from first Insert Group 800A and second Insert Group 800B can be inserted into its cavity and make the appropriate electrical, data and mechanical connections to power the insert and form configurable ACSC 8000A. Similarly, second ACSC 8000B may be employed in combination with an insert selected from the second Insert Group 800B and third Insert Group 800C which when inserted into the cavity makes the appropriate electrical and mechanical connections to power the insert and form and provide configurable second ACSC 8000B. Accordingly, three classes of insert are defined:
First class 800A which fit the ACSC 8000A only;
Second class 800B which fit either the ACSC 8000A or second ACSC 8000B; and
Third class 800C which fit the second ACSC 8000B only.

Accordingly, insertion of an insert into the cavity of first ACSC 8000A yields ACSC 8000C whilst insertion of an insert into the cavity of second ACSC 8000B yields ACSC 8000D. Whilst FIG. 8 depicts three classes of inserts and two ACSC it would be evident that alternatively three classes of inserts may be associated with two classes of ACSCs of which first ACSC 8000A and second ACSC 8000B are examples of each class of these two classes. However, it would also be evident that the concept can be extended to N classes of ACSC and M classes of inserts wherein each class of ACSC accepts inserts from a subset of the M classes of inserts comprising R classes of inserts. N, M and R being positive non-zero integers.

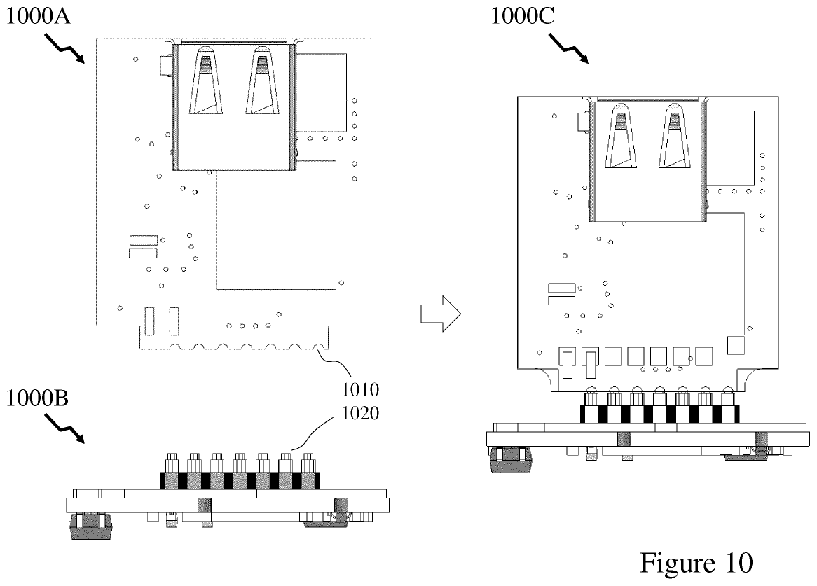

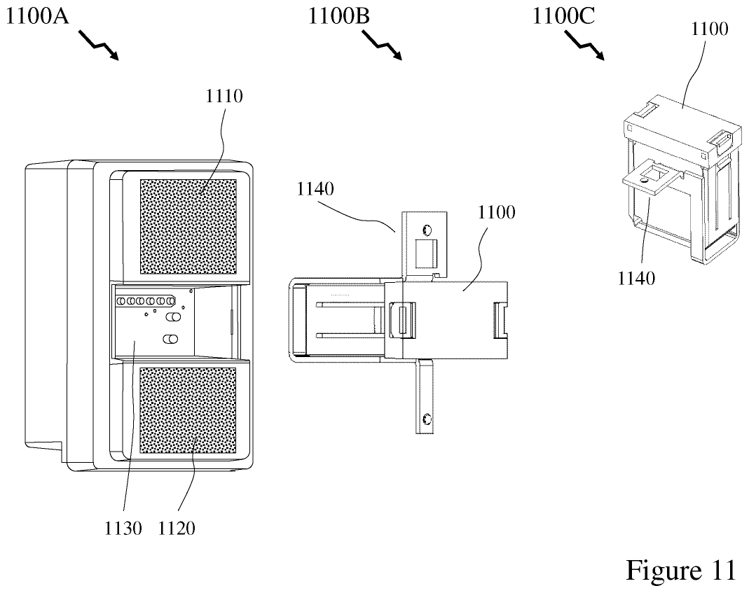

Referring to FIG. 9A there is depicted a configuration of insert and ACSC circuit board supporting restriction of inserts and ACSC combinations such as depicted in FIG. 8 according to an embodiment of the invention. Referring to first image 900A there is depicted a perspective view of parts of the ACSC, e.g., ACSC 8000AACSC 8000A and insert. The electrical ACSC portion depicted being the main PCB 950. As depicted the portion of the insert depicted comprises insert shell 910, insert PCB 920, and USB socket 930 as the insert 650A-650N/750A-750N provides a USB charger wherein the insert PCB 920 provides a stabilized USB interface supporting power and data. Optionally, a USB insert may be solely for charging an electrical device or it may support data communications through the USB to a device connected to it by a user which are then transmitted to/from the USB insert either via a wireless interface (forming part of the USB insert) or through power line communications (PLC) via the electrical supply to/from the insert.

Next in second image 900B the PCB 950 is depicted absent any components for simplicity except electrical connector 980 visible through opening within the back wall of the insert shell 910 whilst the insert now depicts only insert shell 910 and its keyed openings 960. Finally, third image 900C depicts only the PCB 950 with electrical connector 980 and keyed posts 970.

Accordingly, referring to FIG. 9B there is depicted a post 970—opening 960 configuration for achieving the insert restrictions according to FIG. 8 according to an embodiment of the invention wherein a first class 800A which fit the ACSC 8000A only, a second class 800B which fit either the ACSC 8000A or second ACSC 8000B, and a third class 800C which fit the second ACSC 8000B only as described above in respect of FIG. 8. As depicted first to third rear views 9000 to 9200 in FIG. 9B depict the rear wall of the insert shell for the first, second, and third classes, respectively.

First rear view 9000 depicts the openings 960B and 960C which are presented from the four potential opening positions 960A to 960D, respectively. Now referring to first PCB configuration 9400 there are depicted the occupied posts 970B and 970C of the four potential post positions 970A to 970D, respectively. Accordingly, when the openings 960B and 960C correspond to the posts 970B and 970C such that when the insert with first rear view is inserted into a ACSC with first configuration 9400 with posts 970B and 970C the combination allows the insert to be inserted fully engaging the electrical connector 980 on the PCB 950 to the electrical connections within the insert (not shown for clarity) and a latching mechanism within the ACSC to engage with that of the insert. However, if the insert is instead inserted into a ACSC with second configuration 9500 the posts configured as depicted in positions 970A and 970B the insert cannot be inserted fully preventing the electrical connection being made and the engagement of the latching mechanism.

However, an insert with third rear view 9200 with openings 960A and 960B would align and be fully insertable with second configuration 9500. It would be evident that the third rear view 9200 does not align with the posts of first configuration 9400 thereby preventing an insert with third rear view 9200 being inserted into a ACSC with posts in first configuration 9400. However, second rear view 9100 has openings 960A to 960D and will accordingly accept posts in either of the first and second configurations 9400 and 9500, respectively.

It would be evident to one of skill in the art that in each instance the insertion of the insert into a ACSC in an inverted position will not match any post configuration and accordingly an insert cannot be inserted upside down. Hence, in this manner a configuration of openings and posts as depicted in FIG. 9B provides the three classes of inserts. It would be evident that other configurations of “posts” and “openings” may be employed to achieve the same result. It would also be evident that the configuration may be adjusted according to whether two, three, four or more classes of insert are intended for use in different subsets of two, three, four or more ACSCs.

### 4: Grounding First/Last Connectivity on Insert Insertion/Removal

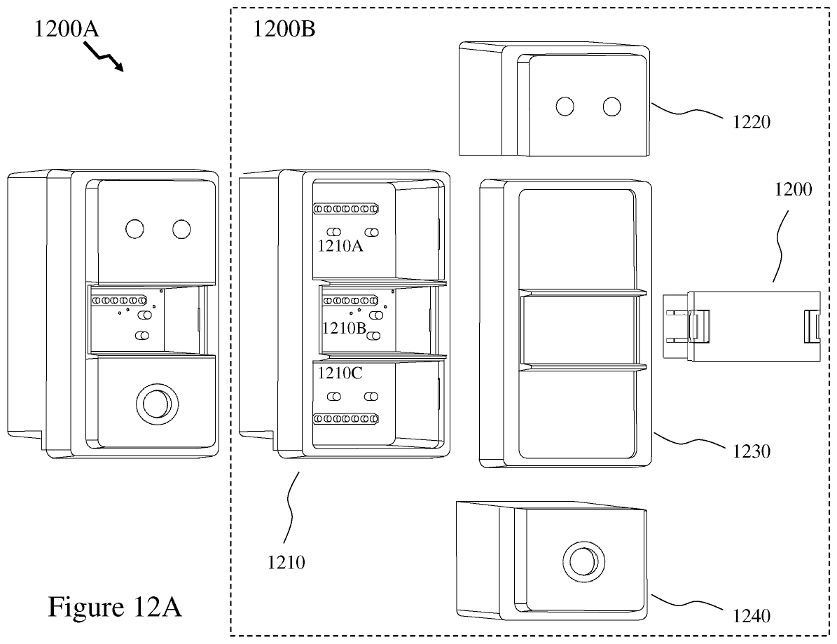

Now referring to FIG. 10 there is depicted an edge connection between the insert and ACSC circuit board according to an embodiment of the invention for low complexity and low cost. Accordingly, there is depicted an insert PCB 1000A together with ACSC PCB 1000B as discrete elements and as assembled when the insert is inserted into a ACSC cavity keyed to access that insert. As depicted with insert PCB 1000A the edge of the PCB where it will abut the electrical connector contacts 1020 is castellated and the inner edge of each recess is metallized to form an electrical contact with its respective electrical connector contact 1020 when the insert is fully inserted as depicted in assembly 1000C. In this manner, the mechanical positioning/retention of the insert relative to the ACSC cavity is managed by the latching/alignment mechanism together with the posts/openings that define an allowable insertion. The electrical connection is a mechanical contact without additional complexity. It would be evident that within other embodiments of the invention the insert PCB 1000A may be configured with an electrical connector or electrical connectors in socket and/or plug whilst the ACSC PCB is configured with the matching plug and/or socket electrical connector or connectors. For example, these may include, but are not limited to single in-line (SIL) headers, dual in-line headers (DIL), card edge connectors, backplane connectors, micro-USB, and mini-USB.

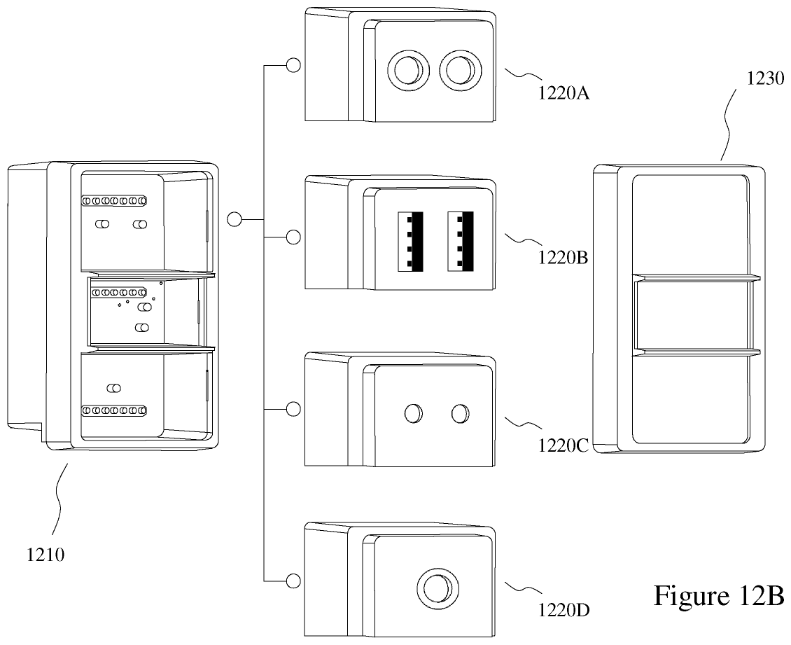

Referring to FIG. 11 there is depicted an internal ground bar configuration according to an embodiment of the invention providing grounding of the insert prior to electrical connectivity with the ACSC circuit board with low complexity and low cost. In first image 1100A a ACSC is depicted with first and second Functional Elements 1110 and 1120 with a Cavity 1130 However, it is not evident whether the insert is grounded prior to full insertion and the electrical connections being made between the Insert 1100, for example an insert according to an appropriate group of first to third classes 800A to 800C respectively in FIG. 8, and the ACSC 1100A. Accordingly first to second assembly images 1100B and 1100C respectively depict the ground strap 1140 absent all other elements of the ACSC 1100A wherein it is evident that the ground strap is formed such that it is around the cavity over at least part of the cavity width such that as the insert is inserted it makes electrical contact to the ground plane. Accordingly, either through a conductive plastic shell for the insert or metal contacts on the upper and/or lower surfaces of the insert a ground contact is made as the insert is partially inserted and maintained through to the electrical connection such that in the event of a fault the insert is always grounded even though the accessible contacts within the cavity may be limited to an acceptable DC or AC voltage, e.g. 12V such that a user contacting them does not suffer harm. Optionally, the electrical construction may be reversed to that shown in FIG. 10 such that the “plug” portion of the electrical connector(s) on the insert-ACSC PCB connection are on the insert and the “socket” portion is on the ACSC PCB so that an errant finger cannot touch the electrical contacts.

5: Reconfigurable Functions of ACSCs accepting Inserts

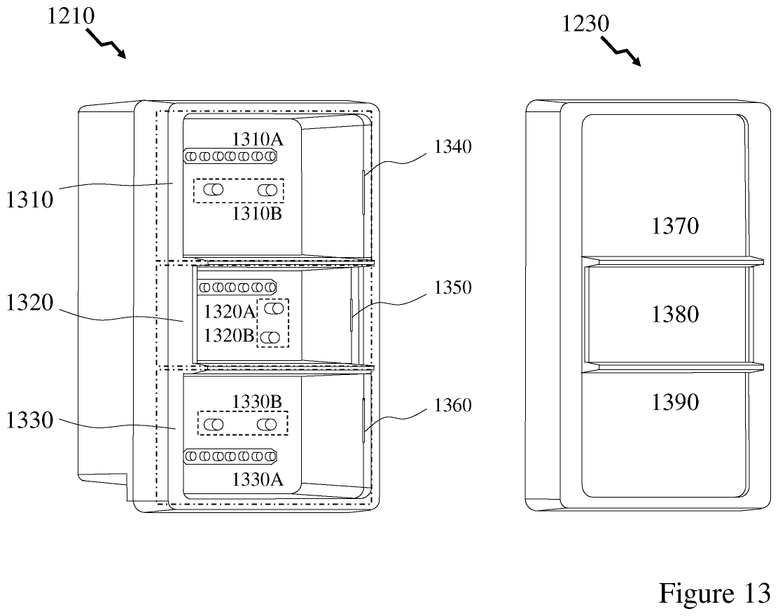

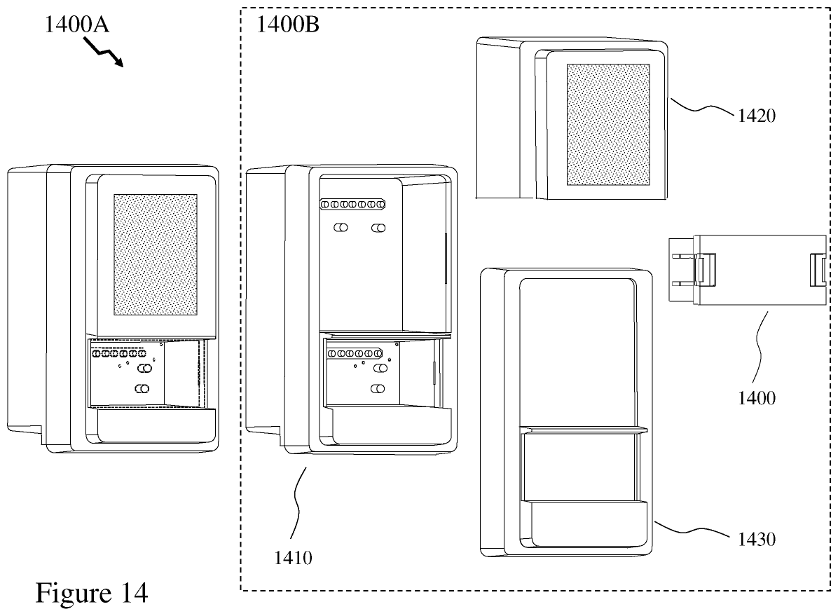

Within FIG. 8 an insert according to an appropriate group of first to third classes 800A to 800C is inserted into a cavity of an ACSC where any other functionality of the ACSC is predetermined by the ACSC selected for inclusion within the ACSC array. However, referring to FIG. 12A there is depicted a configurable ACSC according to an embodiment of the invention wherein the installed functionality is set in two stages:
Stage 1: configuration of ACSC functional elements; and
Stage 2: configuration of insert.

Accordingly, as depicted in second image 1200B a series of elements are depicted which when assembled provide the ACSC depicted in first image 1200A. There is therefore a ACSC 1210, an upper ACSC Functional Element 1220, a lower ACSC Functional Element 1240 and a cover 1230 together with Insert 1200, for example an insert according to an appropriate group of first to third classes 800A to 800C respectively in FIG. 8. At installation, the first and second ACSC Functional Elements 1220 and 1240 are inserted into first and third cavities 1210A and 1210C respectively whilst the Insert 1200 would be inserted into second cavity 1210B. Once the first and second ACSC Functional Elements 1220 and 1240 are inserted into first and third cavities 1210A and 1210C respectively the cover 1230 is attached and retained, for example, via one or more bolts through the rear of the ACSC body to the rear of the cover 1230.

Now referring to FIG. 12B there is depicted a configurable ACSC according to the configuration depicted in FIG. 12A wherein the installed functionality set at installation can be varied by changing the ACSC Functional Element. Alternate ACSC Functional Elements 1220A to 1220D are depicted comprising optical source, dual USB interface, motion sensor, and gas sensor (e.g., radon, 0.1 mm DC socket. As depicted the second element cavity is configured as a 180° rotation of the first element cavity such that, for example, first ACSC Functional Element 1220A can be used in both cavities. Optionally, within other embodiments of the invention such a configuration may be limited such that different upper and lower elements are required. Further, the concept discussed supra in respect of configuring inserts to fit only certain ACSCs can be applied such that only certain ACSC Functional Elements can be inserted into one or other cavity or both cavities etc.

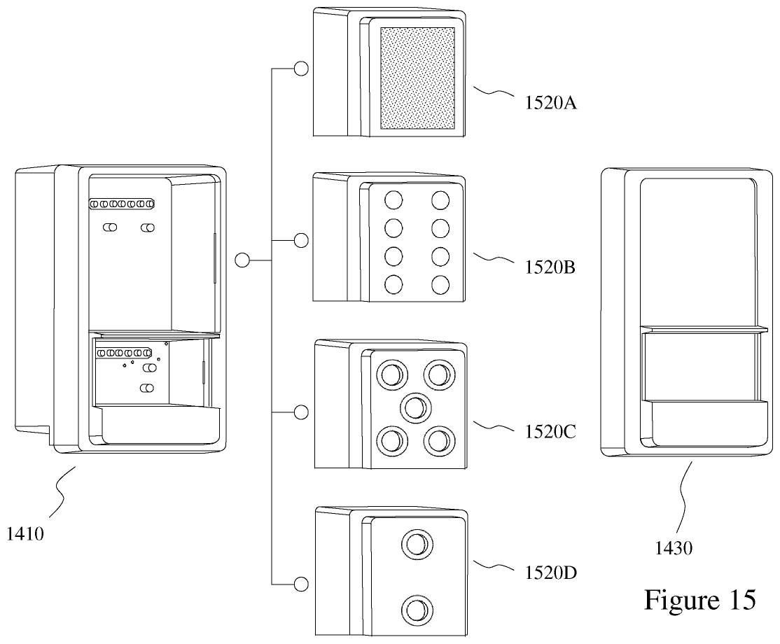

The multiple cavities within a ACSC 1210 and cover 1230 are further depicted in FIG. 13 according to the embodiment of the invention depicted in FIG. 12A. Accordingly, the ACSC 1210 has first to third cavities 1310 to 1330 respectively within each being backplane connectors 1310A to 1330A respectively and keying posts 1310B to 1330B, respectively. As depicted the cover 1230 has three openings 1370 to 1390 that align with the first to third cavities 1310 to 1330, respectively. The design of the cover is such that when attached ACSC Functional Elements cannot be inserted into the first and third cavities 1310 and 1330 through the cover openings 1370 and 1390 but an Insert 1200 (not depicted for clarity) can be inserted through opening 1380 into second cavity 1310B. Within embodiments of the invention the sequence of which cavities permit use of inserts versus may change.

Optionally, within an embodiment of the invention using an example of three cavities all three cavities may be identical but the sequence of which accept elements prior to installation and which accept inserts after installation is defined by the cover applied. Accordingly, the cover may restrict the cavity by projecting within the cavity such that the dimensions of an insert are smaller than that of an ACSC Functional Element. In this manner the insert may be in the first, second, or third cavity based upon the cover applied.

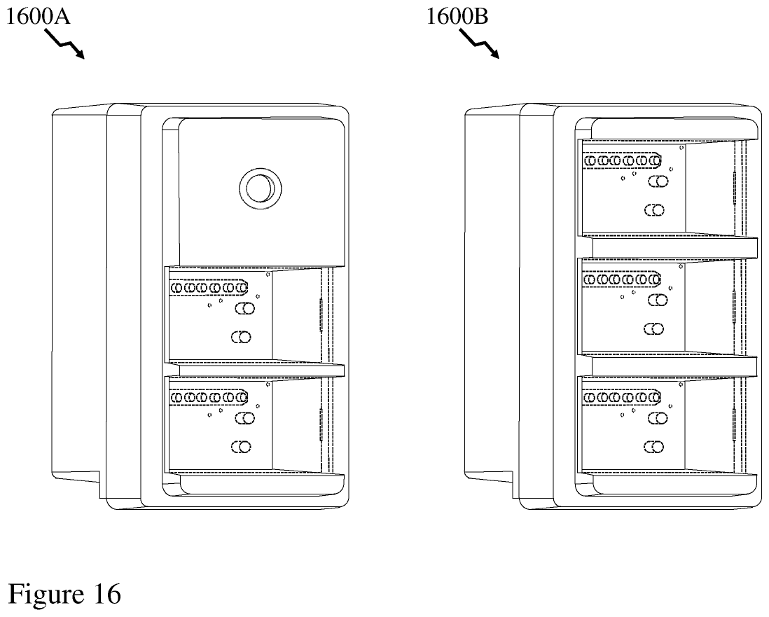

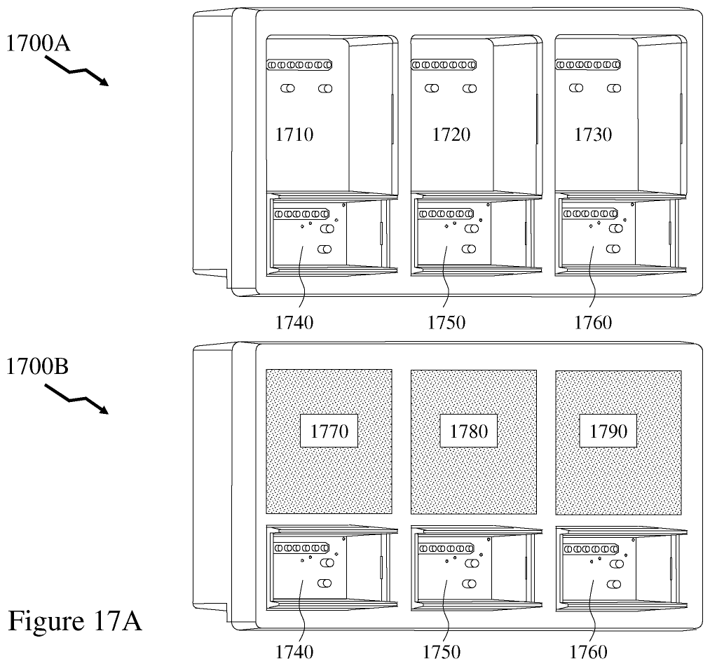

Accordingly, it would be evident to one of skill in the art that this concept may be extended as depicted in FIG. 14 for a configurable ACSC according to an embodiment of the invention wherein the installed functionality can be set at installation leaving the post-installation ACSC configuration via the insert(s). In this manner as depicted in FIG. 15 the ACSC 1510 may be configured with first to fourth Functional Elements 1620A to 1620D which depict loudspeaker 1520A, optical source array 1520B, optical sensor array 1520C and LIDAR modules 1520D respectively

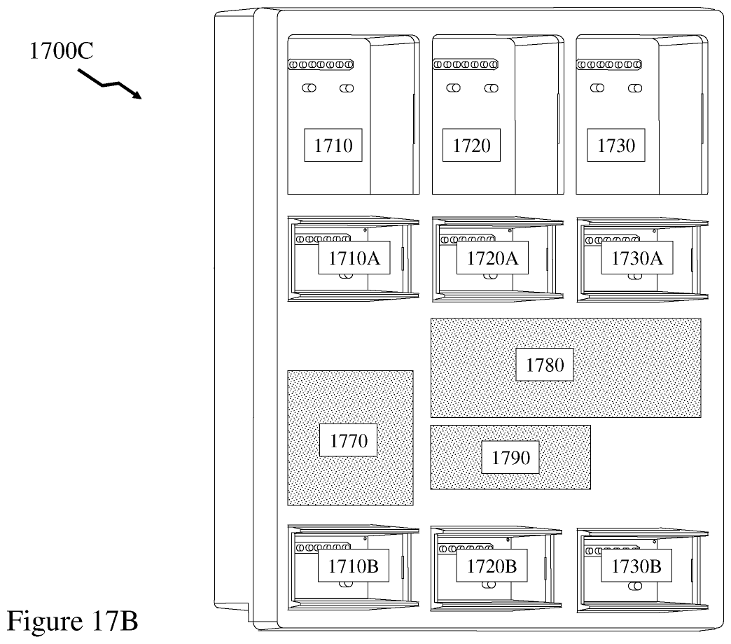

Further, as depicted in FIGS. 16 and 17 configurable ACSCs according to embodiments of the invention may employ two or three (or potentially more) inserts. First image 1600A in FIG. 16 depicts an ACSC accepting 2 Inserts for configurable functionality together with a predefined functionality whilst second image 1600B depicts an ACSC with 3 Inserts which has no baseline or predetermined functionality and accepts 3 Inserts. For example, first image 1700A depicts an ACSC providing three first Cavities 1710-1730 for insertion of one, two, or three Functional Elements (or blanking elements) and three second Cavities 1740-1760 for the insertion of one, two, or three Inserts (or blanking inserts). Second image 1700B depicts a ACSC providing three cavities for the insertion of inserts. Optionally, within embodiments of the invention the cavities within either first and second images 1700A and 1700B may be keyed such as described above such that different cavities may be keyed for different insert classes, such as for example as described above in respect of FIG. 8 with the first to third classes 800A to 800C.

It would be evident that the concepts described and depicted within FIGS. 3A-16 may be exploited in what may be viewed from a conventional electrical receptacle perspective as “2-gang”, “3-gang”, “4-gang” etc. configurations where multiple Functional Elements are disposed adjacent to one another across the ACSC with multiple cavities as well as the “1-gang” design depicted. Accordingly, this would reduce the number of electrical connections to be made by providing a single ACSC which then supports a grid of configurable elements and/inserts. Within embodiments of the invention depicted in respect of FIGS. 3A-16 the presumption has been that the removable inserts are removed manually without special tooling. However, within other embodiments of the invention a tool may be required to insert and/or remove the insert. Similarly, a tool may also be required to insert and/or remove ACSC Functional Elements.

Referring to FIG. 17A there are depicted first and second “3-gang” ACSCs 1700A and 1700B respectively by way of embodiments of the invention. First ACSC 1700A comprising first to third cavities 1710 to 1730 for insertion of Functional Elements with fourth to sixth cavities 1740 to 1760 respectively for insertion of Inserts. Second ACSC 1700A comprising first to third Functional Elements 1770 to 1790 providing pre-installed functionalities with fourth to sixth cavities 1740 to 1760 respectively for insertion of Inserts. As noted above, the number of gangs can range from 1 upwards.

Similarly, an ACSC may support one or more gangs and one or more tiers such as depicted by ACSC 1700C in FIG. 17B. ACSC 1700C in FIG. 17B depicts a first tier comprising first to third Functional Elements 1710 to 1730 respectively, a second tier comprising first to third Cavities 1710A, 1720A and 1730A respectively for insertion of Inserts, a third tier comprising first to third Installed Functional Elements 1770 to 1790 respectively, and a fourth tier comprising fourth to sixth Cavities 1710B, 1720B and 1730B respectively. Within embodiments of the invention the “gangs” and “tiers” (which can be viewed as columns and rows of a matrix) may be disposed upon a regular pattern (e.g., square grid, rectangular grid, hexagonal grid) or disposed irregularly. Further, a cavity, functional element (installed or configurable) may extend over one or more “gangs” and/or “tiers.”

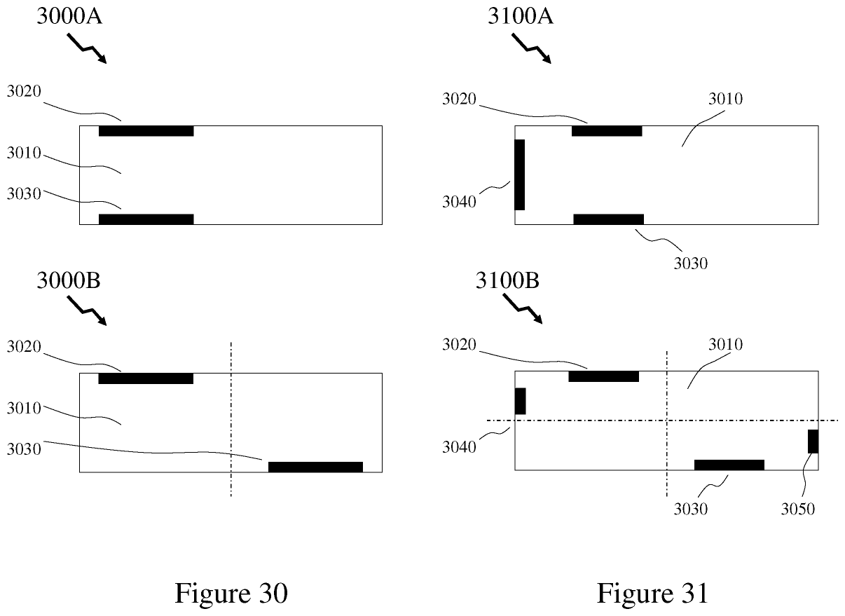

Whilst within the figures and description cavities, inserts, functional elements etc. are described and depicted with respect to a single face or surface of an ACSC it would be evident that the cavities, inserts, functional elements may be disposed within multiple faces or surfaces of the ACSC without departing from the scope of the invention. Whilst it is generally expected that these faces or surfaces will be those exposed to the external environment there is nothing that prevents these being disposed within or with respect to faces or surfaces of ACSC that are designed to abut another ACSC in forming an ACSC Array such as described and depicted below in respect of FIGS. 26 to 29, respectively. In instances where a functional element has no requirements for an external connector, connection, interface, input, output etc. then location of the functional element is not restricted by the external geometry of the ACSC.

Optionally, within embodiments of the invention the ACSC Functional Elements may be inserted and retained without an overlaying cover but are “latched” into position and then covered with the faceplate wherein this then covers the required access to remove the ACSC Functional Elements with a tool, for example. In this manner, removal of the faceplate and use of the appropriate extraction tool allows the ACSC Functional Elements to be reconfigured and then re-covered with the faceplate. Optionally, the ACSC Functional Elements may be retained through screw/bolt fixtures through the rear of the ACSC or the front wherein these are then obscured/hidden via a cover and faceplate or just a faceplate. In each instance the removable inserts are inserted/removed from the ACSC when the cover and faceplate or just faceplate are in position.

Within embodiments of the invention an ACSC Functional Element may extend to other functions that those described and depicted without departing from the scope of the invention. For example, a functional element may relate to a hydraulic system where the Functional Element is hydraulic switch wherein input and output hydraulic connectors and/or piping are provided. Such functional elements may support hydraulic systems and/or hydraulic controls, pneumatic systems and/or pneumatic controls, HVAC systems and/or HVAC controls etc. without departing from the scope of the invention. Further, such ACSC Functional Elements may include AC power interfaces, DC power interfaces, lighting controls, motor controls, pump controls etc.

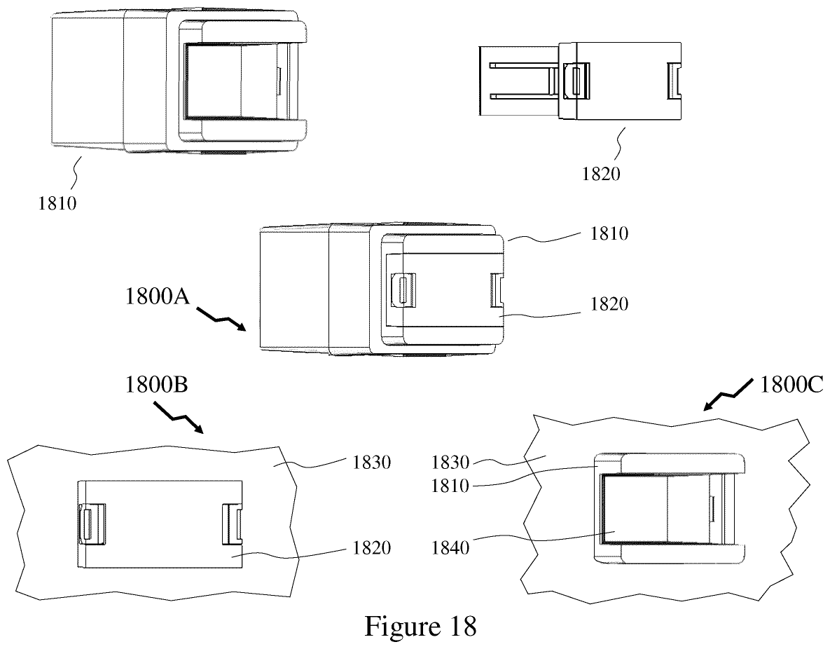

Now referring to FIG. 18 there is depicted an ACSC 1810 according to an embodiment of the invention within which an Insert 1820 such as described and depicted in respect of FIGS. 3A-17 respectively can be inserted. The resulting combination being depicted in first image 1800A as a discrete ACSC assembly and in second image 1800B where the ACSC 1810 is mounted into a Panel 1830 as part of an ACSC. In third image 1800C the ACSC 1810 is depicted assembled with the Panel 1830 but without the insert thereby showing the Cavity 1840 within which the insert, e.g., Insert 1820, fits.

As noted above an ACSC according to embodiments of the invention may contain one or more Inserts in conjunction with an ACSC having zero or one or more Functional Elements. Accordingly, a plurality of inserts within ACSCs, such as those depicted in FIGS. 16 and 17 for example may provide data to one or more central hubs supporting ACSC-SAPs according to embodiments of the invention, hereinafter referred to as ACSC-SAP hubs. An ACSC-SAP hub may be associated with an environment physically, e.g., an ACSC-SAP hub with an office, residence, factory, home, etc. and therein to one or more electronic devices/systems etc. the ACSC-SAP hub controls. Alternatively, an ACSC-SAP hub may be associated with an environment remotely as it is connected via a network, such as Network 100 in FIGS. 1 and 2, to a plurality of ACSCs and therein to one or more electronic devices/systems via the network. Accordingly, an ACSC-SAP hub may acquire a variety of information from a plurality of inserts within an environment, process it with one or more artificial intelligence (AI)/machine learning (ML) algorithms.

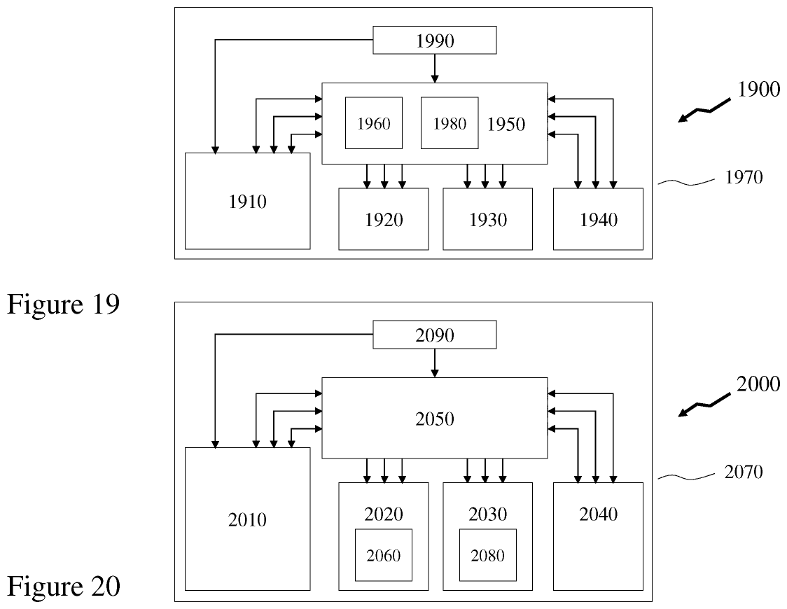

Optionally, an ACSC hub according to an embodiment of the invention may be within an ACSC, distributed across a plurality of ACSCs within an ACSC array, distributed across a subset of a plurality of ACSCs forming an ACSC array, or discrete from the ACSCs/ACSC array connected via communications link and/or communications network. Referring to FIG. 19 there is depicted a schematic 1900 of a ACSC 1970 according to an embodiment of the invention supporting an ACSC hub 1960 within Electronics 1950 associated with the ACSC 1970. Disposed within the ACSC 1970 are a Function 1910, e.g., an electrical power outlet or electrical switch for example, and first to third Inserts 1920, 1930, and 1940, respectively. An Electrical Interface 1990 couples' electrical power to the ACSC 1970 from an external power distribution network. Accordingly, each of the Functional Element 1910 and first to third Inserts 1920, 1930, and 1940 respectively communicate to the ACSC Hub 1960 via the Electronics 1950, although they may communicate directly to the ACSC Hub 1960 within other embodiments of the invention. Accordingly, the ACSC Hub 1960 may determine an action or actions with respect to one or more of the Functional Element 1910 and first to third Inserts 1920, 1930, and 1940 respectively from data received by the ACSC Hub 1960 from all or a subset of the Functional Element 1910 and first to third Inserts 1920, 1930, and 1940 respectively either in isolation or in conjunction with data received from functions and/or inserts of one or more other ACSCs 1970 or other PEDs, FEDs, wearable devices, sensors etc. linked to the ACSC Hub 1960. Optionally, the ACSC Hub 1960 may communicate via an Interface 1980 forming part of the Electronics 1950. Such a communications interface may, for example, be a wired interface and/or a wireless interface such as described above in respect of FIG. 2.

Referring to FIG. 20 there is depicted a schematic 2000 of a ACSC 2070 according to an embodiment of the invention supporting an ACSC hub 2060 within a first insert 2020. Disposed within the ACSC 2070 are a Function 2010, e.g., an electrical power outlet or electrical switch for example, and first to third Inserts 2020, 2030, and 2040, respectively. An Electrical Interface 2090 couples' electrical power to the ACSC 2070 from an external power distribution network. Accordingly, each of the Functional Element 2010 and second to third Inserts 2030 and 2040 respectively communicate to an ACSC Hub 2060 within the first Insert 2020 via the Electronics 2050, although they may communicate directly within other embodiments of the invention. Accordingly, the ACSC Hub 2060 may determine an action or actions with respect to one or more of the Functional Element 2010 and first to third Inserts 2020, 2030, and 2040 from data received by the ACSC Hub 2060 from all or a subset of the Functional Element 2010 and first to third Inserts 2020, 2030, and 2040 either in isolation or in conjunction with data received from functions and/or inserts of one or more other ACSCs 2070 or other PEDs, FEDs, wearable devices, sensors etc. linked to the ACSC Hub 2060. Optionally, the ACSC Hub 2060 may communicate via an Interface 2080 forming part of the second Insert 2030 although within other embodiments of the invention the Interface 2080 may form part of the first Insert 2020, part of the third Insert 2040, part of the Functional Element 2010, part of the Electronics 2050 or be discrete from all of these within the ACSC 2070. Such a communications interface may, for example, be a wired interface and/or a wireless interface such as described above in respect of FIG. 2.

Optionally, the ACSC hub may be implemented within an Insert or within a number of Inserts such that absent an ACSC integrating an ACSC hub within their environment, either through direct access such as via wireless interface, through a network to an ACSC hub within a predetermined geographical region around the ACSC(s), or within a number of hops within an ad-hoc network from the ACSC(s) then the ACSCs may establish communications with a remote ACSC hub either associated with a geographically associated physical infrastructure or remotely. For example, ACSCs within a first environment of the building, e.g., an apartment within an apartment building, may determine that an ACSC hub does not exist within their immediate environment but that there is one associated with the apartment building and accordingly communicate with it. Other ACSCs within a second environment of a building, e.g., another apartment within an apartment building, may determine that an ACSC hub does exist, via an insert or being integrated within a ACSC for example, within their immediate environment and accordingly communicate with it. Other ACSCs within a third environment of the building, e.g., another apartment within an apartment building, may determine that no ACSC hub exists and accordingly communicate with a remote server.

Optionally, a graphical user interface of an application associated with one or more of ACSC(s), insert(s) and/or ACSC hub(s) may allow a user to configure aspects of one of more of an insert, an ACSC, and an ACSC hub. For example, at initial installation an insert may be configured so that it is associated with an ACSC hub through one or more techniques such as ACSC hub identification through network scanning, entry of ACSC hub IP address by user, communication with another insert, ACSC hub associated with a predetermined service provider or third party provider etc. This application may be a software application installed upon a PED associated with the user, a software application installed within a PED associated with an installation technician or engineer (e.g., electrician) or a software application installed within a tester (e.g., an item test equipment) associated with an installation technician or engineer (e.g., a service provider technician etc.).

Accordingly, an ACSC hub according to an embodiment of the invention receives data from a plurality of sensors, e.g., those relating to motion, humidity levels, temperature, sound, vibration, light levels, door position, window position, power consumption, light settings, etc. From these the ACSC hub learns the habits of the user(s) of the environment associated with the ACSC hub, what the inventors refer to as the “normal” habits of the user(s) of the environment. Subsequently, the ACSC hub can determine whether a deviation outside of typical variations in respect of these habits has occurred. A determination of a deviation outside of typical variations can trigger the ACSC hub to issue a notification in this respect. Such a notification may be to an individual, a workstation, etc. For example, an ACSC hub monitoring patients within a hospital or residents within a residential home or elderly care facility may issue the notification to a workstation associated with the hospital, residential home or elderly care facility. If the ACSC hub is monitoring a house then the notification may be sent to a predetermined individual such as the owner, occupant etc. The ACSC hub is monitoring an elderly patient at home then the notification may be sent to a next of kin, relative, friend, etc. or to a doctor, emergency service etc.

Optionally, within embodiments of the invention the ACSC hub may determine an extent of the deviation and different resultant outcomes may be associated with different thresholds of deviations. For example, a low deviation above a first threshold may trigger a notification to a first user or system, a moderate deviation above a second threshold may trigger a notification to a second user or system, and a high deviation above a third threshold may trigger a notification to a third user or system.

Optionally, these thresholds may be established by the AI with respect to a normal deviation or distribution of the habit established over a period of time.

Optionally, different monitored aspects of the environment may have different thresholds.

Optionally, a deviation may be associated with a single monitored aspect of the environment in isolation or relative to other monitored aspects.

Optionally, a deviation may be associated with multiple monitored aspects of the environment in isolation or relative to other monitored aspects.

Optionally, overall environment management may be established in relation to multiple monitored aspects of the environment, but an alarm or trigger may be generated in dependence upon a single monitored aspect.

For example, if the monitored environment is associated with a user and the monitored environment ambient noise is being monitored then detection of a sound associated with glass breaking, a heavy object being dropped, a sound similar to a person falling, a shout for help etc. may be detected and according trigger an alarm. Here, the alarm triggered may be associated with the type of detected event.

Optionally, the notification or notifications associated with the type of detected event may determine to whom and how the notification or notifications are sent. In the example above, a shout for help may trigger an alarm to one or more emergency response teams such as police, ambulance and paramedics whilst the sound associated with breaking glass triggers an alarm to an emergency contact, e.g., a relative, neighbour etc.

Optionally, the notification or notifications associated with the type of detected event may determine to whom and how the notification or notifications are sent where the type of detected event is modified by one or more other monitored environmental parameters. In the example above, the sound associated with breaking glass then if the sound is detected when other monitored parameters indicate no one within the environment or they are asleep, for example, then a burglar alarm and a notification to the police may be indicated. Alternatively, if the sound occurs in conjunction with the sound of running water and movement in a kitchen then no alarm may be immediately triggered unless no subsequent motion is detected for example indicating a potential injury. However, if this scenario was within a bathroom, then an alarm to a relative, other member of the household etc. might be automatically triggered. Accordingly, an alarm may be triggered or not triggered from a common set of monitored conditions based upon a context of the monitored event established by the ACSC hub.

### 6: Artificial Intelligence

Within the preceding description additional intelligence has been described in respect of FIGS. 19 and 20 for providing an ACSC Hub within the ACSC and/or an insert of the ACSC. However, within other embodiments of the invention an ACSC Nano-Hub may be associated with a ACSC and/or an insert. In contrast to the description above in respect of ACSC Hubs which acquire and process data received from functions and/or inserts of other ACSCs, Inserts etc. or other PEDs, FEDs, wearable devices, sensors etc. linked to the ACSC Hub an ACSC Nano-Hub acquires and processes data received from functions and/or inserts of a single ACSCs or several ACSCs and/or Inserts together with, optionally, other PEDs, FEDs, wearable devices, sensors etc. linked to the associated with the ACSC Nano-Hub. Each ACSC Nano-Hub may locally process and make decisions with respect to the ACSC, inserts etc. and communicate these decisions to an ACSC Hub. Accordingly, each ACSC may provide localized decision making/control within a framework of an overall decision making/control provided by an ACSC Hub.

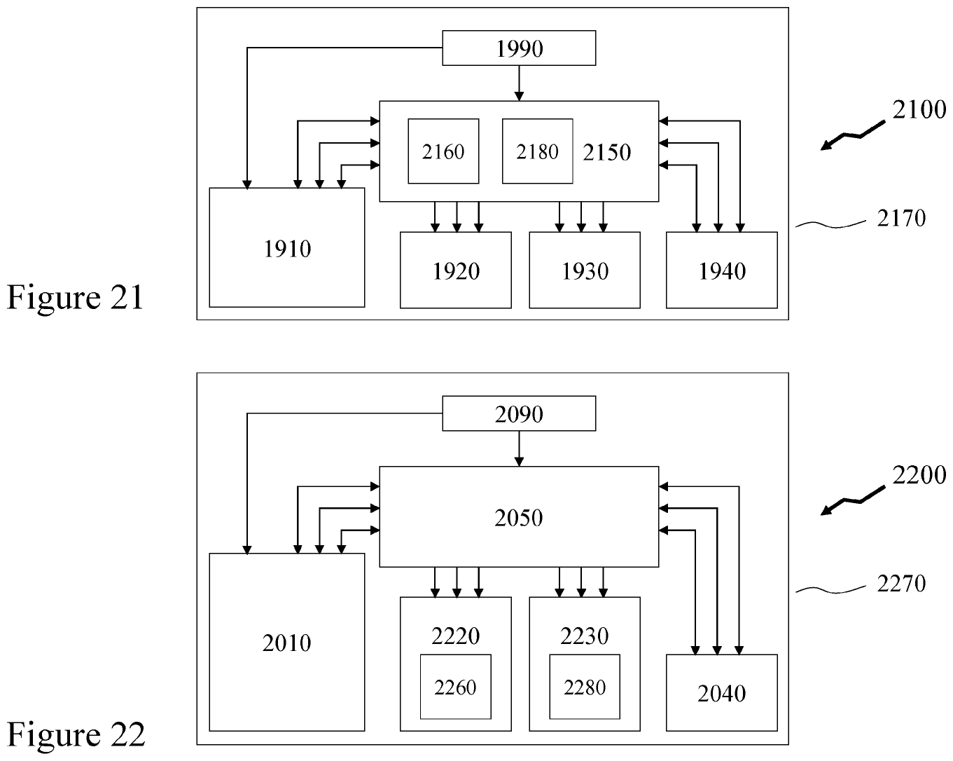

For example, ACSCs 2170 and 2270 as described and depicted with respect to FIGS. 21 and 22 may each, within an embodiment of the invention be installed within a baseboard heater such that the Functions 1910 and 2010 control the baseboard heater. Accordingly, an ACSC Hub may have established that heating for the physical structure to which the baseboard heaters are associated with should be turned on at 5 pm and turned off at 10 pm based upon the date and its AI/ML processing of data relating to the physical structure over time. However, the ACSC Nano-Hub 2160 or 2260 associated with the ACSC 2170 or 2270 determines that at 5 pm rather than the area being occupied it is unoccupied and accordingly does not turn the heaters on but rather waits until an occupancy of the area is determined from an infrared sensor within one of the inserts within the ACSC 2170 or 2270 determining the presence of an individual or individuals. Equally, the ACSC Nano-Hub 2160 or 2260 associated with the ACSC 2170 or 2270 determines that at 10 pm rather than the area being unoccupied it is occupied and accordingly does not turn the heaters off but rather waits until no occupancy of the area is determined from an infrared sensor within one of the inserts within the ACSC 2170 or 2270. Accordingly, it would evident that the ACSC Nano-Hubs may provide localized override of decisions made by the ACSC Hub or adjusts them based upon local information.

An ACSC Hub may push in advance of specific time related actions/decisions with respect to ACSCs such that a temporary failure of wireless communications from the ACSC Hub to the ACSC Nano Hubs does not prevent the action/decision being made at that specific time or trigger. As such each ACSC Nano-Hub may include a clock allowing a time/date function to be implemented within the ACSC. Accordingly, the ACSC Hub(s) and ACSC Nano-Hubs may communicate with a protocol defining an action/trigger, time etc. To avoid continuous data communications between ACSC Hub(s) and ACSC Nano-Hub(s) these communications may be periodically provided with or without the use of data compression techniques to limit the data transmitted.

Referring to FIG. 21 there is depicted a schematic 2100 of a ACSC 2170 according to an embodiment of the invention supporting an ACSC Nano-Hub 2160 within Electronics 2150 associated with the ACSC 2170. Disposed within the ACSC 2170 are a Function 1910 and first to third Inserts 1920, 1930, and 1940 respectively together with an Electrical Interface 1990 such as described above in respect of FIG. 19. Accordingly, each of the Function 1910 and first to third Inserts 1920, 1930, and 1940 respectively communicate to the ACSC Nano-Hub 2160 via the Electronics 2150, although they may communicate directly within other embodiments of the invention. Accordingly, the ACSC Nano-Hub 2160 may determine an action or actions with respect to one or more of the Function 1910 and first to third Inserts 1920, 1930, and 1940 respectively from data received by the ACSC Nano-Hub 2160 from all or a subset of the Function 1910 and first to third Inserts 1920, 1930, and 1940 either in isolation or in conjunction with data received from functions and/or inserts of one or more other ACSCs or other PEDs, FEDs, wearable devices, sensors etc. linked to the ACSC Nano-Hub 2160. The ACSC Nano-Hub 2160 may communicate via an Interface 1980 forming part of the Electronics 1950 to an ACSC Hub such as described above. Such a communications interface may, for example, be a wired interface and/or a wireless interface such as described above in respect of FIG. 2.

Referring to FIG. 22 there is depicted a schematic 2200 of a ACSC 2270 according to an embodiment of the invention supporting an ACSC Nano-Hub 2260. Disposed within the ACSC 2270 are a Function 2010, third Insert 2040, Electronics 2050 and Electrical Interface 2090 such as described in respect of FIG. 20. Also depicted are first and second Inserts 2220 and 2230, respectively. Disposed within the first Insert 2220 is an ACSC Nano-Hub 2260 and within the second Insert 2230 an Interface 2280. Accordingly, each of the Function 2010, third Insert 2040 and first and second Inserts 2220 and 2230 communicate to the ACSC Nano-Hub 2260 via the Electronics 2050, although they may communicate directly within other embodiments of the invention. Accordingly, the ACSC Nano-Hub 2260 may determine an action or actions with respect to one or more of the Function 2010, third Insert 2040 and first and second Inserts 2220 and 2230 from data received by the ACSC Nano-Hub 2260 from all or a subset of the Function 2010, third Insert 2040 and first and second Inserts 2220 and 2230 or in conjunction with data received from functions and/or inserts of one or more other ACSCs 2070 or other PEDs, FEDs, wearable devices, sensors etc. linked to the ACSC Hub 2060. Optionally, the ACSC Hub 2260 may communicate via the Interface 2280 forming part of the second Insert 2230. Such a communications interface may, for example, be a wired interface and/or a wireless interface such as described above in respect of FIG. 2.

Accordingly, a ACSC such as ACSC 2170 in FIG. 21 with ACSC Nano-Hub 2160 or ACSC 2270 in FIG. 22 with first Insert 2220 and ACSC Nano-Hub 2260 may perform machine based learning of one or more aspects of each of its functions. Such functions may include, but not be limited to, those provided by Functions 1910 and 2010 in FIGS. 21 and 22 respectively; provided by first to third inserts 1920 to 1940 respectively in FIG. 21; or third insert 2040 and first to second inserts 2220 to 2230 respectively for example.

Based upon the machine based learning the ACSC Nano-Hub such as ACSC Nano-Hub 2160 in FIG. 21 or ACSC Nano-Hub 2260 in FIG. 22 may determine to perform a modification, enablement or cancellation of an aspect of the function(s) and/or insert(s). For example, an ACSC Nano-Hub enabled ACSC such as ACSCs 2100 and 2200 in FIGS. 21 and 22 respectively may also comprise power monitoring such as described in respect of ACSC 2100 in FIG. 21. Accordingly, the ACSC Nano-Hub may within an embodiment of the invention decide to turn off, turn on or adjust the intensity of a light connected to a light switch, this being the function of the ACSC or a function of an insert of the ACSC. Accordingly, an ACSC Nano-Hub may within an embodiment of the invention decide to turn off or turn on electrical power to a power outlet, communications interface, etc. where this is the function of the ACSC or a function of an insert of the ACSC.

Accordingly, an ACSC Nano-Hub such as described in respect of FIGS. 21 and 22 may establish through communications to/from an insert the function(s) of the insert(s) installed within the ACSC and accordingly adjust the actions managed by the ACSC Nano-Hub in dependence upon the function(s) of the insert(s). Accordingly, considering the example above where the ACSC is associated with a baseboard heater then of the ACSC Nano-Hub determines an insert includes an infrared sensor it accordingly can employ this information to adjust locally the decision with respect to turning on, turning off, adjusting the baseboard heater against the overall control decision from the ACSC Hub. However, if the ACSC Nano-Hub determines that none of the inserts includes an infrared sensor it accordingly defaults to slaving the turning on, turning off, adjusting the baseboard heater to the overall control decision from the ACSC Hub.

Accordingly, an ACSC Nano-Hub such as described in respect of FIGS. 21 and 22 may establish through communications to/from a function the physical functionality of the function(s) installed within the ACSC where the physical functionality of the ACSC can be established through which modules are inserted into the ACSC such as described above in respect of FIGS. 13A to 16, respectively.

Alternatively, the ACSC Nano-Hub may be initially configured through data stored with a memory associated with the ACSC Nano-Hub with this physical functionality of the function(s) installed within the ACSC.

In this manner an ACSC Nano-Hub according to an embodiment of the invention may perform functions under the direction of an ACSC Hub and/or based upon its own decision making. Accordingly, an ACSC Nano-Hub may turn off an electrical device connected to an outlet where the electrical device is drawing power but the ACSC Nano-Hub determines that the electrical device should not be powered. For example, the ACSC Nano-Hub may determine through monitoring wireless signals that a cable television (TV) set-top box has been turned off by a user but that the associated TV is still powered on wherein the ACSC Nano-Hub then turns off the associated TV. Alternatively, the ACSC Nano-Hub may determine that the cable TV set-top box and associated TV are powered off, an alarm for the premises associated with the cable TV set-top box and associated TV has been set to “Away” or turned on wherein the ACSC Nano-Hub turns off power at the wall ACSC, for example, thereby removing these ongoing low level power drains, commonly referred to as vampire power, leeched electrical power, or leeched energy.

Alternatively, the ACSC Nano-Hub may determine that lights within an area have been turned on but that the motion sensors indicate no one within the area and turn the lights off. In this instance, the motion sensors may be associated with ingress/egress points of an area and independent of the actual lights themselves. Accordingly, an ACSC Nano-Hub may provide additional functionality.

As described above additional functionality can be provided to a wide range of PEDs, FEDs, wearable devices, control systems, environmental control systems, etc. by providing one or more ACSCs with or without one or more added modular functional units (inserts). As discussed above in respect of artificial intelligence this functionality can be augmented with decision making undertaken locally, e.g., an ACSC Nano-Hub such as described above in respect of FIGS. 21 and 22 respectively, or an ACSC Hub such as described above.

For example, within embodiments of the invention an item to which the functionality is added may be what the refer to as “dumb” in that whilst it contains a control circuit, e.g., a baseboard heater with a simple thermostat, the item cannot adjust its operation outside that provided by the internal thermostat. Accordingly, through a simple modification a baseboard heater, for example, can be modified using an insert such as described and depicted in respect of 6. This may be at original manufacturing or post-installation.

Accordingly, considering the original manufacturing scenario the ACSC may contain the control electronics for the baseboard heater such that with a “blank” insert the baseboard heater operates as per prior art baseboard heaters. However, if the “blank” insert is replaced the normal functionality is bypassed and the baseboard heater is now controllable through a network connection, either by the user themselves via wireless connectivity, or through another manner including an ACSC Nano-Hub within the insert, an ACSC Nano-Hub within an ACSC, or an ACSC Hub.

Accordingly, considering the post-installation scenario the ACSC may now replace the control electronics for the baseboard heater. Accordingly, the ACSC may contain electrical connections for electrical power from the mains wiring and electrical connections to the heater element(s). Accordingly, once installed the baseboard heater is now controllable through a network connection, either by the user themselves via wireless connectivity, or through another manner including an ACSC Nano-Hub within the insert, an ACSC Nano-Hub within an ACSC, or an ACSC Hub.

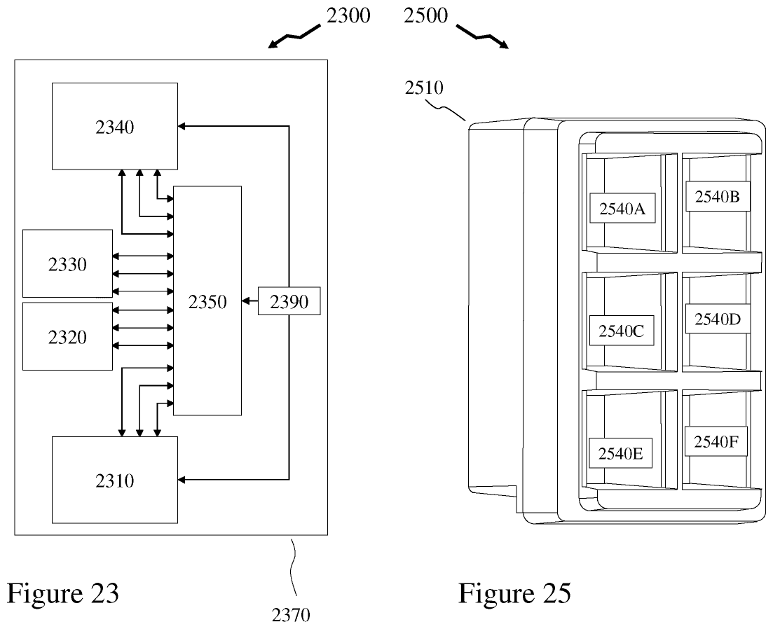

Within the descriptions above in respect to Inserts within ACSCs, artificial intelligence assisted living etc. an Insert providing a wireless interface may be employed. However, within these descriptions the wireless interface has been depicted as a separate function to that of the ACSC itself, either as With Section 9 with respect to FIG. 22 the wireless functionality within an Insert is described as communicating data from the ACSC/Inserts to another device, e.g., another wireless Insert within an ad-hoc wireless network, ACSC Hub, network etc. However, as depicted in FIG. 23 this data flow may also go from an Insert to the ACSC in order to control aspects of the ACSC, function(s) of the ACSC, or functions of another Insert(s).

Referring to FIG. 23 there is depicted a schematic 2300 of a ACSC 2370 according to an embodiment of the invention. Disposed within the ACSC 2370 are a first Function 2310, second Function 2340, first Insert 2320, second Insert 2330, Electrical Circuit 2350 and Electrical Interface 2390. The Electrical Interface 2390 providing functionality such as described in respect of FIG. 20 and Electrical Interface 2090. Accordingly, connections between each of the first Function 2310, second Function 2340, first Insert 2320, second Insert 2330 and the Electrical Circuit 2350 are all depicted as bidirectional. Accordingly, one or more aspects of each of the first Function 2310 and second Function 2340 can be controlled by the Electrical Circuit 2350 as well as the Electrical Circuit 2350 receiving data relating to each of the first Function 2310 and second Function 2340 such as described above. Further, each of the first Insert 2320 and second Insert 2330 receive data from the Electrical Circuit 2350 and provide data to the Electrical Circuit 2350. Accordingly, if one or both of the first Insert 2320 and second Insert 2330 provide a wireless interface functionality then according to the functionality embedded into the Electrical Circuit 2350 aspects of the ACSC 2370, the first Function 2310, second Function 2340, first Insert 2320, the second Insert 2330 may be controlled.

For example, if first Insert 2320 provides a Bluetooth wireless interface, then any electronic device paired with the first Insert 2320 could provide commands which are received by the first Insert 2320 and communicated to the Electrical Circuit 2350 wherein, they are executed. Alternatively, second Insert 2330 may support IEEE 802.14 wireless protocol(s) such that commands can be provided to the Electrical Circuit 2350 via the second Insert 2320 from any device coupled to a network to which the second Insert 2350 is also coupled.

Alternatively, a first wireless circuit within the first Insert 2320 may receive commands which are re-broadcast by a second wireless circuit within the second Insert 2330. Alternatively, a first wireless circuit within the first Insert 2320 may receive data which is communicated to an electronic device via a wired interface, e.g., a USB interface within the second Insert 2330.

Optionally, the first wireless circuit and second wireless circuit may be within a common Insert, such as first Insert 2320 for example.

Optionally, the first wireless circuit and the wired interface may be within a common Insert, such as first Insert 2320 for example.

Accordingly, the ACSC 2370 with the appropriate Inserts can receive commands and employ these either with respect to the function(s) of the ACSC, e.g., to enable output power, disable output power, set an output power level, etc. or with respect to function(s) of the Insert(s).

However, the ACSC 2370 by virtue of being able to receive wireless signals according to a first wireless standard and re-broadcast them upon a second wireless standard is able to provide additional functionality within an ACSC environment. For example, the wireless signals according to the second standard may, for example, be an RF signal for remote control of an electronic devices such as a television, smart television, personal video recorder (PVR) etc. In this manner the ACSC 2370 may receive wireless signals according to the first standard from a user's smartphone, for example, through Bluetooth and re-broadcast these so that an application upon the user's smartphone provides them with the functionality of an RF remote control normally provided with the electronic device(s) such as the television, smart television, personal video recorder (PVR) etc.

Within another embodiment of the invention a ACSC such as ACSC 2370 for example may employ a first Insert, e.g., first Insert 2320 in FIG. 23, which has a wireless receiver and a second Insert, e.g., second Insert 2330 in FIG. 23, which has an optical emitter supporting modulated output, e.g., a visible LED or an infrared LED. In this manner signals received according to a wireless standard supported by the first Insert are re-broadcast optically by the optical emitter within the second Insert. It would be evident that optionally, within other embodiments of the invention, the first and second Inserts may be the same Insert.

Within another embodiment of the invention a ACSC such as ACSC 2370 for example may employ a first Insert, e.g. first Insert 2320 in FIG. 23, which has a wireless receiver and has an additional functionality provided within the Electrical Circuit 2350 such that data received via the first Insert 2320 is communicated to the Electrical Circuit 2350 and employed to generate power line communication (PLC) signals which are applied to the electrical mains via the Electrical Interface 2390. Alternatively, PLC signals received via the Electrical Interface 2390 are processed by the Electrical Circuit 2350 and provided to a transmitter within an Insert, e.g., first Insert 2320 in FIG. 23. This transmitter may be wireless according to a standard or it may be optical according to another standard or within other embodiments of the invention the Insert may support wireless and optical signals and the data provided from the Electrical Circuit 2350 indicates to the Insert which interface is to be employed or whether both are to be employed.

Within another embodiment of the invention a ACSC such as ACSC 2370 for example may employ a first Insert, e.g., first Insert 2320 in FIG. 23, which has a gesture recognition interface component operating either standalone or in combination with the ACSC it is Inserted within, another Insert within the same ACSC, another Insert within another ACSC, another ACSC, etc. Accordingly, gestures generated by a user are established via the first Insert and may, for example, be re-broadcast optically or wirelessly by an appropriate emitter within a second Insert of the ACSC, e.g., second Insert 2330, another Insert within another ACSC, the ACSC etc. In this manner gestures by the user can be employed to control electronic and/or electrical devices within the user's local environment and/or remote environments. For example, a gesture recognition interface may exploit a depth aware camera, stereo cameras, a single camera, and radar. It would be evident that gesture recognition may also be performed using other Inserts where the Insert is receiving data from another electronic device establishing the user's motion for the gesture such as a stylus, handheld controller (e.g., Nintendo Wii controller), a wearable device comprising a MEMS accelerometer based gyroscope, a gyroscope, etc. may also be employed.

Within another embodiment of the invention a ACSC such as ACSC 2370 may enable or disable an Insert or Inserts, e.g. first Insert 2320 and/or second Insert 2330, based upon a current function or state of first Function 2310 and/or second Function 2340 rather than the ACSC 2370 enabling or disabling current function or state of first Function 2310 and/or second Function 2340, based upon data from an Insert or Inserts, e.g. first Insert 2320 and/or second Insert 2330. Optionally, considering ACSC 2370 a single function, e.g., first Function 2310 may enable/disable a predetermined Insert, e.g., first Insert 2320 or second Insert 2330, or it may enable/disable both Inserts. Optionally, considering ACSC 2370 the first Function 2310 may enable/disable a predetermined Insert, e.g., first Insert 2320 or second Insert 2330, whilst the second Function 2340 may enable/disable the other of the first Insert 2320 and second Insert 2330.

Optionally, within another embodiment of the invention an Insert, e.g., first Insert 2320 or second Insert 2330 may enable/disable a predetermined function, e.g., first Function 2310 or second Function 2340. Optionally, considering ACSC 2370 the first Insert 2320 may enable/disable a predetermined function, e.g., first Function 2310 or second Function 2340, whilst the second Insert 2330 may enable/disable the other of the first Function 2310 and second Function 2340.

Optionally, within another embodiment of the invention the first Insert 2320 supports a microphone such that vocal commands provided by a user within the environment around the first Insert 2320 are communicated to the Electrical Circuit 2350 processed and employed to control a function or functions of the ACSC 2370, control another electronic device via an optical and/or wireless interface within the same Insert or another Insert of the ACSC 2370, control another device via PLC communications, provide data to an ACSC Hub, provide data to an ACSC Nano-Hub, or provide data to another ACSC. In this manner a user may employ an Insert with a microphone and associated ACSC as a generic voice activated controller for a large number of functions within their environment or other environments. For example, the user can vocalize “Monday Night Football” and the Electrical Circuit 2350 will communicate via the appropriate interfaces within itself and/or other ACSCs to turn on a TV, turn on a cable set-top box (STB) and tune the STB to a channel showing “Monday Night Football”, start a microwave in another room to cook popcorn, and order a 12″ deep dish pepperoni pizza (via a web interface of the smart TV for example).

Accordingly, it would be evident to one of skill in the art that ACSCs and Inserts according to embodiments of the invention may provide remote control functionality through a variety of interfaces allowing a user to establish a wide range of automation tasks or assisted living tasks discretely or in combination with artificial intelligence assisted living methodologies such as described above. ACSC would allow repeated automation tasks, such as the user requesting “Monday Night Football” every Monday between September and January, to be initially monitored and then associated as an event to automatically trigger for the user. However, as the user only ordered pizza sporadically the learnt ACSC process either does not include ordering the pizza or includes a prompt to the user as to whether they wish to order one or not.

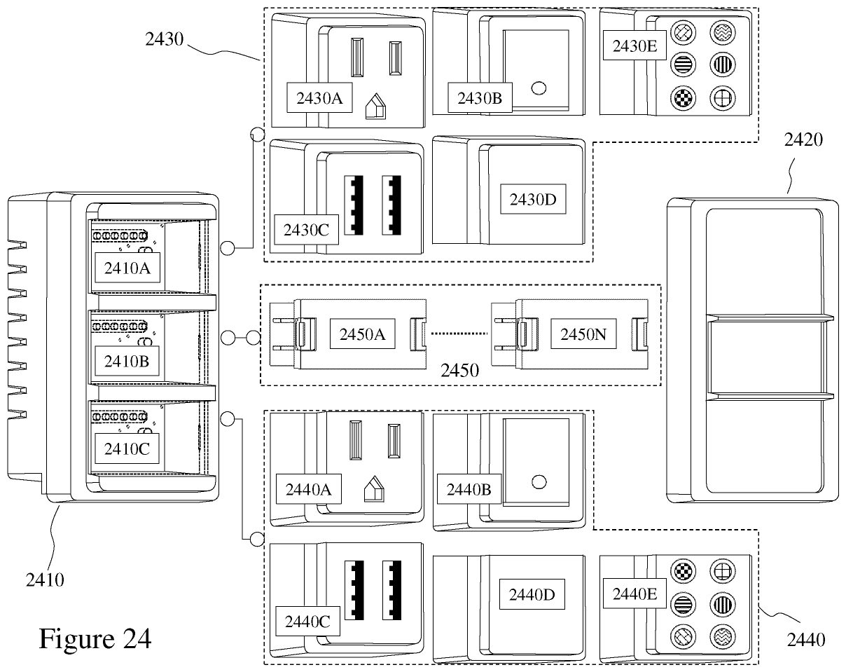

As discussed above Inserts may employ a wide range of sensors. Further, as the functionality of a ACSC itself may also be configured at installation then it is also possible that included amongst the potential functions of a ACSC is environmental sensing. Accordingly, referring to FIG. 24 there is depicted a configurable ACSC, ACSC 2410, according to an embodiment of the invention together with its faceplate 2420. The associated electrical work box, retention means for faceplate 2420 etc. have been omitted for clarity. Accordingly, the ACSC 2410 can accept a first functional Insert within the upper first cavity 2410A, a second functional Insert within the lower third cavity 2410C, and an Insert within the second middle cavity 2410B.

As depicted an Insert selected from Insert Group 2450 comprising Inserts 2450A to 2450N may be employed within the second middle cavity 2410B of ACSC 2410.

For the first upper cavity 2410A a functional Insert from first Functional Group 2430 may be employed. As depicted first Functional Group 2430 comprises North American (NA) Power Outlet 2430A, Toggle Switch 2430B, Dual USB Interface 2430C, Blank 2430D and first Sensor Module 2430E.

For the third lower cavity 2410C a functional Insert from second Functional Group 2440 may be employed. As depicted second Functional Group 2440 comprises North American (NA) Power Outlet 2440A, Toggle Switch 2440B, Dual USB Interface 2440C, Blank 2430D and second Sensor Module 2440E.

Within embodiments of the invention the functionality of second Sensor Module 2440E may be the same as the functionality of first Sensor Module 2430E or within other embodiments of the invention it may be different. Within other embodiments of the invention each of the first and second Sensor Modules 2430E and 2440E may be one of a series of variants of sensor modules providing different functionalities. For example, a first subset of one or more sensor modules may be directed to one application, e.g., security, whilst a second subset of one or more other sensor modules may be directed to another application, e.g., environment monitoring. Further, as depicted in schematic 2500 a ACSC 2510 may be configured to accept multiple smaller footprint Inserts, not depicted for clarity, wherein the ACSC 2510 accepts up to six Inserts within first to sixth cavities 2540A to 2540F, respectively. Accordingly, it would be evident that embodiments of the invention may therefore support dedicated sensor only Inserts as well as sensor based Inserts into ACSCs that provide other functions through design of the ACSC or through a functional Insert used to configure a ACSC for example.

Whilst the ACSC 2410 in FIG. 24 is depicted such that a functional Insert for the upper first cavity 2410A will not fit into lower third cavity 2410C due to geometric and backplane projections/connections etc. it would evident that within other embodiments of the invention a design can be implemented such that a common Insert may be employed within each of the upper first cavity 2410A and lower third cavity 2410C. Alternatively, common Inserts may be applied for some functions within each of the upper first cavity 2410A and lower third cavity 2410C such as USB interfaces, wireless interfaces, etc. whilst some functions may still be designed for use in a single cavity such as electrical power outlets such that a pair of electrical power outlets employed within each of the upper first cavity 2410A and lower third cavity 2410C have the same orientation relative to the ACSC 2410.

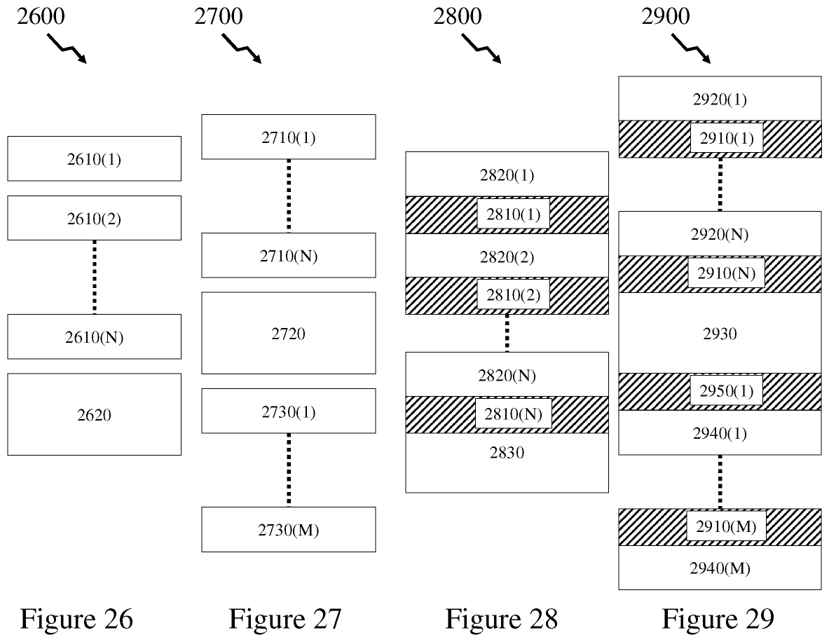

A similar set of constraints or flexibility may be established with ACSC 2510 in FIG. 25 wherein if all cavities, namely first to sixth cavities 2540A to 2540F, are identical in geometry and rear mechanical/electrical configurations any compatible Insert may be Inserted into any of the cavities. Alternatively, some cavities, e.g., first and second cavities 2540A and 2540B respectively, may be of a first design, third and fourth cavities 2540C and 2540D respectively of a second design, and fifth and sixth cavities 2540E and 2540F respectively of a third design. In this scenario some Inserts may be designed solely for use with the first design or the second design or the third design. Optionally, only certain functions and/or sensors may be provided within a specific design, e.g., environmental sensors may only be designed for compatibility with the first design whilst chemical sensors may only be designed for compatibility with the second design.

Accordingly, sensors may be deployed within ACSCs in isolation of other functions or deployed in ACSCs in conjunction with other functions. Such networks of sensors may provide a significant volume of data to local or remote processors of this data including, but not limited to, an ACSC Hub, an ACSC Nano-Hub, a regulatory authority, a service provider, a third party provider, and a Government organization. Accordingly, a service provider such as an electrical utility may be provided with data, based upon explicit acceptance of each user/organization providing the data, allowing it to establish and modify consumption projections as well as using its own artificial intelligence (AI) processes etc. Within another variant a Government organization, e.g., the U.S. National Weather Service, can establish real time environmental at a much finer granularity than national sensor networks and/or weather satellites allowing it to pinpoint and project (potentially) where an event such as a hurricane, tornado, flood etc. may occur.

### 7. ACSC Arrays and Interconnection Methods

Referring to FIG. 26 there is depicted an ACSC Array 2600 comprising a series of ACSC Modules 2610(1) to 2610(N) which are connected to a Base ACSC 2620. The number N being a positive integer or zero as a Base ACSC 2620 can be deployed on its own. Each ACSC Module 2610(1) to 2610(N) and/or Base ACSC 2620 can provide discrete integral functionality as discussed above or may include one or more cavities for insertion of an Insert such as described above to provide additional configuration options and reconfigurability. Further, as discussed above each of the ACSC Modules 2610(1) to 2610(N) within the series of ACSC Modules 2610(1) to 2610(N) can be placed in any position relative to the others unless one of the ACSC Modules 2610(1) to 2610(N) is defined as a cap module wherein the cap module is always positioned at the distal end of the series of ACSC Modules 2610(1) to 2610(N) from the Base ACSC 2620. Whilst the orientation depicted has the Base ACSC 2620 at the bottom of the series of the ACSC Modules 2610(1) to 2610(N) the sequence may be inverted with the Base ACSC 2620 always being the top ACSC module. Alternatively, the ACSC Modules 2610(1) to 2610(N) and Base ACSC 2620 may be designed to form the ACSC array from left to right or vice versa or front to back or vice versa. Other configurations such as staggered stacking may be implemented without departing from the scope of the invention.

Referring to FIG. 27 there is depicted an ACSC Array 2700 comprising an upper series of ACSC Modules 2710(1) to 2710(N) which are connected to one side of a Base ACSC 2720. The number N being a positive integer or there may no upper ACSC Modules 2710(1) to 2710(N) as a Base ACSC 2620 can be deployed on its own. Disposed to the other side of the Base ACSC 2620 are a lower series of ACSC Modules 2730(1) to 2730(M) where the number M is a positive integer or there may no lower ACSC Modules 2720(1) to 2720(M) within other configurations. Within embodiments of the invention the upper series of ACSC Modules 2710(1) to 2710(N) may be configured differently to lower series of ACSC Modules 2730(1) to 2730(M) so that they can only be “stacked” on a predetermined side of the Base ACSC Module 2720 whilst the lower series of ACSC Modules 2730(1) to 2730(M) are configured so that they can only be “stacked” on a different predetermined side of the Base ACSC Module 2720. Alternatively, the ACSC Modules may be configured such that they can be part of either the upper series of ACSC Modules 2710(1) to 2710(N) or the lower series of ACSC Modules 2730(1) to 2730(M) respectively and could in fact be replicated in each. Whilst the upper series of ACSC Modules 2710(1) to 2710(N) and the lower series of ACSC Modules 2730(1) to 2730(M) respectively are depicted as being on opposite sides of the Base ACSC Module 2720 they may be on different non-opposite sides, e.g. a top and a side, a first side and a second side not opposite the first side, or the same side without departing from the scope of the invention.

Each upper series of ACSC Modules 2710(1) to 2710(N) and the lower series of ACSC Modules 2730(1) to 2730(M) respectively and/or Base ACSC 2720 can provide discrete integral functionality as discussed above or may include one or more cavities for insertion of an Insert such as described above to provide additional configuration options and reconfigurability. Further, as discussed above each of the ACSC Modules within each of the upper series of ACSC Modules 2710(1) to 2710(N) and the lower series of ACSC Modules 2730(1) to 2730(M) respectively can be placed in any position relative to the others unless one of the ACSC Modules is defined as a cap module wherein the cap module is always positioned at the distal end of either of the upper series of ACSC Modules 2710(1) to 2710(N) and the lower series of ACSC Modules 2730(1) to 2730(M) respectively from the Base ACSC 2720.

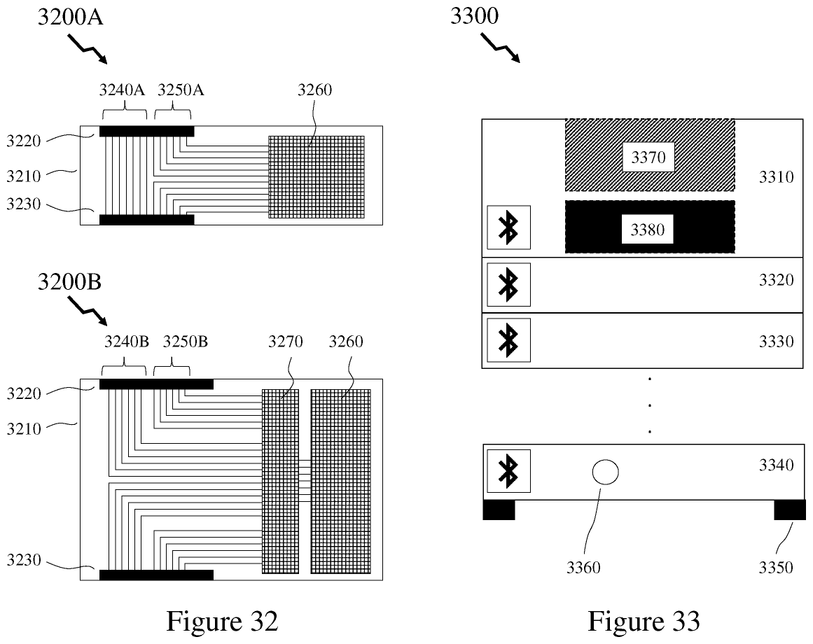

Now referring to FIG. 28 there is depicted an ACSC Array 2800 comprising a series of ACSC Modules 2820(1) to 2820(N) which are connected to a Base ACSC 2830. However, in contrast to FIG. 26 and ACSC Array 2600 disposed between each pair of modules are Interconnection Elements 2810(1) to 2810(N) respectively. The number N being a positive integer or zero as a Base ACSC 2830 can be deployed on its own. Each ACSC Module 2820(1) to 2820(N) and/or Base ACSC 2830 can provide discrete integral functionality as discussed above or may include one or more cavities for insertion of an Insert such as described above to provide additional configuration options and reconfigurability. Further, as discussed above each of the ACSC Modules 2820(1) to 2820(N) within the series of ACSC Modules 2820(1) to 2820(N) can be placed in any position relative to the others unless one of the ACSC Modules 2820(1) to 2820(N) is defined as a cap module wherein the cap module is always positioned at the distal end of the series of ACSC Modules 2820(1) to 2820(N) from the Base ACSC 2830. Whilst the orientation depicted has the Base ACSC 2830 at the bottom of the series of the ACSC Modules 2820(1) to 2820(N) the sequence may be inverted with the Base ACSC 2830 always being the top ACSC module. Alternatively, the ACSC Modules 2820(1) to 2820(N) and Base ACSC 2830 may be designed to form the ACSC array from left to right or vice versa or front to back or vice versa. Other configurations such as staggered stacking may be implemented without departing from the scope of the invention.

The Interconnection Elements 2810(1) to 2810(N) respectively may provide a number of predetermined interconnection locations on each side so that signals from one ACSC Module can be routed to an adjacent ACSC Module even if the connectors are in different locations provided that they are within one of the defined locations on the Interconnection Element. For example, each side of the Interconnection Element may provide 4 connectors at right angles to one another such that the next ACSC Module in the ACSC Array can be oriented such that its connector connects to one of these 4 connectors. It would be evident that the number of connectors may be the same on each side of the Interconnection Element or they may be different. Similarly, the locations of connectors may be the same on each side of the Interconnection Element or they may be different. Optionally, the connectors on each side of the Interconnection Element may both be sockets, may be both plugs, sockets on one side and plugs on the other or different combinations of plugs and sockets on each side of the Interconnection Element.

Optionally, an Interconnection Element according to the design of the ACSC Modules may allow two or more ACSC Modules to be connected to an adjacent ACSC Module either with common connectivity from the two or more ACSC Modules to the adjacent ACSC Module or with different connectivity to the adjacent ACSC Module according to the design of the Interconnection Element. Accordingly, within other embodiments of the invention an Interconnection Element may have two or more designs such that one design supports discrete adjacent ACSC Modules whilst another supports, for example, a pair of ACSC Modules to an adjacent ACSC Module. This may be generalised to an Interconnection Element may provide connectivity between R ACSC Modules on one side and S ACSC Modules on another side where R and S are positive integers.

It would be evident that according to the relative costs/footprints/functionality of the ACSC Modules that similar functionality may be integrated into the ACSC Modules by provisioning multiple connectors on each side.

Within an embodiment of the invention the Interconnection Element and ACSC Modules may exploit an interconnection form that is not socket-plug but a first series of first electrical interface elements which are electrically coupled to a second series of second electrical interface elements. For example, the ACSC Modules may employ a leadless packaging format whilst the Interconnection Element is a flexible, semi-rigid or rigid circuit board with solder bumps wherein electrical connections between the ACSC Module, the Interconnection Element and adjacent ACSC Module are maintained by mechanical connections between the ACSC Modules and the Interconnection Element or by only mechanical connections between the ACSC Modules such that the Interconnection Element is “sandwiched” mechanically. Alternatively, the ACSC Modules and Interconnection Elements may exploit one or more connector formats including those known in the art that retain the Interconnection Element and ACSC Module together. Within embodiments of the invention these connections may be made and unmade by direct physical movement, closure/opening of latches, doing up or undoing screw connection etc. Connections may be discrete and separate for power and data or they may be integrated within a single connector. Similarly, a connector may support parallel data communications, serial data communications or both serial and parallel data connections. The connections may follow one or more national or international standards or they may be custom defined for ACSC Modules generally or a brand of ACSC Modules.

Optionally, ACSC Modules may be provided by two different vendors wherein each vendors ACSC Modules connect as depicted in FIGS. 26 and 27 but an Interconnection Element is required to enable an ACSC Module from one vendor to be inserted into a stack of ACSC Modules from another vendor. Optionally, the supplier of the Interconnection Elements may be one of the vendors of one design of the ACSC Modules or it may be independent of both vendors. This may be extended to ACSC Modules from three or more vendors.

Referring to FIG. 29 this concept of Interconnection Elements is extended as depicted in ACSC Array 2900 comprising an upper series of ACSC Modules 2920(1) to 2920(N) which are connected to one side of a Base ACSC 2930. The number N being a positive integer or there may no upper ACSC Modules 2920(1) to 2920(N) as a Base ACSC 2930 can be deployed on its own. Disposed to the other side of the Base ACSC 2930 are a lower series of ACSC Modules 2940(1) to 2940(M) where the number M is a positive integer or there may no lower ACSC Modules 2940(1) to 2940(M) within other configurations. Disposed between each pair of upper ACSC Modules 2920(1) to 2920(N) and Base ACSC 2930 are first Interconnection Elements 2910(1) to 2910(N) whilst disposed between each pair of lower ACSC Modules 2940(1) to 2940(M) and Base ACSC 2930 are second Interconnection Elements 2950(1) to 2950(M). Within embodiments of the invention the design of the first Interconnection Elements 2910(1) to 2910(N) may be the same as that of the lower ACSC Modules 2940(1) to 2940(M) or it may be different.

Optionally, the Base ACSC Module may be defined by it having an electrical power interface to an electrical mains supply or having an electrical battery storage capability exceeding a threshold such that other ACSC Modules which may or may not have electrical batteries draw power from the Base ACSC Module.

Optionally, within other embodiments of the invention of ACSC Arrays electrical connections may or may not be provided for data and/or power wherein data and/or power is transferred from one ACSC Module to another or from a Base ACSC Module to a ACSC Module via optical means as known in the art. Within other embodiments of the invention exploiting optical means for power and/or data the Interconnection Elements may be passive optical routing layers to provide comparable functionality of multiple connection locations between ACSC Modules.

Optionally, within other embodiments of the invention of ACSC Arrays direct electrical connections may or may not be provided for data and/or power wherein data and/or power is transferred from one ACSC Module to another or from a Base ACSC Module to a ACSC Module via near field electrical coupling means as known in the art.

Optionally, within other embodiments of the invention electrical connections may be provided for power only whereby data communications between ACSC Modules or from a Base ACSC Module to a ACSC Module are performed via a short range wireless communications interface such as Bluetooth, Zigbee, Ultra-Wideband (UWB) etc. Within embodiments of the invention ACSC Modules may communicate solely with adjacent ACSC Modules based upon a configuration protocol via the Base ACSC Module that detects the addition of each ACSC Module since these must be added when the Base ACSC Module is powered. Within embodiments of the invention ACSC Modules may communicate solely with a Base ACSC Module where this is implemented.

Within the following description an Interface is referred to as providing power and/or data communications between an ACSC Module to another ACSC Module or from a Base ACSC Module to a ACSC Module. As such this Interface may be a direct electrical connection, direct optical connection, an indirect electrical connection via an Interconnection Element, and indirect optical connection via an Interconnection Element etc. Accordingly, the term Interface may define one or more power and/or data interfaces between ACSC Modules and/or a Base ACSC Module and an ACSC Module. Optionally, within other embodiments of the invention an Interconnection Element may be active rather than passive wherein it contains active elements which provide discrete functionality within the Interconnection Element such as data protocol conversion, serial-to-parallel conversion, parallel-to-serial conversion, etc. according to the requirements of the different ACSC Modules being connected together.

Within embodiments of the invention ACSC Modules may have a common physical geometry and physical dimensions. For example, each ACSC Module may have a cross-sectional geometry in the plane that the ACSC Module stacks which may be circular, elliptical, square rectangular, hexagonal, octagonal, regular polygon, an irregular polygon etc. However, each ACSC has the same geometry and lateral dimensions with a constant height of each ACSC or varying height of each ACSC. As such an ACSC Array formed from such ACSC Modules has a regular exterior profile.

However, within other embodiments of the invention the ACSC Modules may have different cross-sectional geometries and/or different dimensions such that the ACSC Array formed from such ACSC Modules has an irregular exterior profile. In such instances Interconnection Elements may be required to provide the requisite physical mapping of connections between one ACSC Module and another ACSC Module as their connectors are disposed at different locations relative to an axis of the ACSC Array.

Within the following description a Connection is referred to as providing power and/or data communications for one or more DC, AC, optical or RF connections between an ACSC Module to another ACSC Module or from a Base ACSC Module to a ACSC Module. A Connection may be direct or indirect.

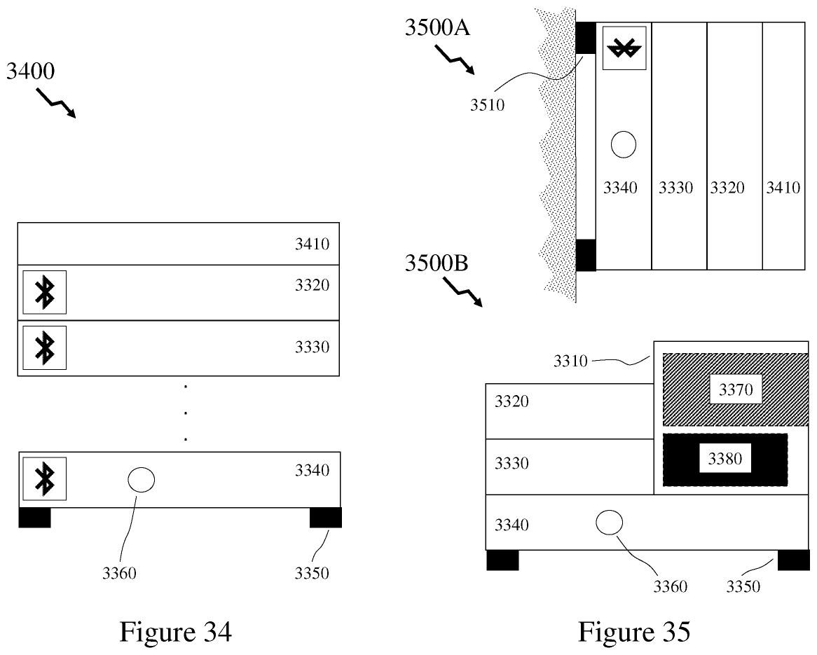

Referring to FIG. 30 there are depicted first and second Schematics 3000A and 3000B of ACSC Modules according to embodiments of the invention. First Schematic 3000A depicts an ACSC Module 3010 with first and second Interfaces 3020 and 3030, respectively. In first Schematic 3000A the first and second Interfaces 3020 and 3030 are disposed in the same relative positions on distal faces of the ACSC Module 3010 such that the orientation of the ACSC Module 3010 is orientated in this manner (conceptually) to stack with other ACSC Modules. In contrast, in second Schematic 3000B the first and second Interfaces 3020 and 3030 are again disposed on opposite faces of the ACSC Module 3010 but at different physical locations with equal offset from an axis of the ACSC Module 3010 so that the ACSC Module 3010 can be placed either “one way up” or inverted without impacting the interconnections between the ACSC Modules.

Now referring to FIG. 31 there are depicted first and second Schematics 3100A and 3100B of ACSC Modules according to embodiments of the invention. First Schematic 3100A depicts an ACSC Module 3010 with first and second Interfaces 3020 and 3030 respectively and third Interface 3040. In first Schematic 3000A the first and second Interfaces 3020 and 3030 are disposed in the same relative positions on distal faces of the ACSC Module 3010 such that the orientation of the ACSC Module 3010 is orientated in this manner (conceptually) to stack with other ACSC Modules. Equally a further ACSC Module can be connected via third Interface 3040. In contrast, in second Schematic 3000B the first and second Interfaces 3020 and 3030 are again disposed on opposite faces of the ACSC Module 3010 but at different physical locations with equal offset from an axis of the ACSC Module 3010 so that the ACSC Module 3010 can be placed either “right way up” or inverted without impacting the interconnections between the ACSC Modules. To accommodate this the ACSC Module 3010 now has third and fourth Interfaces 3040 and 3050 respectively which are equally offset from another axis of the ACSC Module such that another ACSC Module can still be connected to the left of the ACSC Module 3010 independent of whether the ACSC Module 3010 is disposed “right way up” or inverted.

It would be evident that these concepts can be extended with respect to other axes of the ACSC Module 3010 such that the, for example, the ACSC Module 3010 is orientated in the same manner in two arrays but is rotated 180° with respect to its adjacent ACSC Modules in one array relative to the other array. As noted above multiple connection points may also be provided to further provided flexibility in configuration. This may be beneficial in embodiments of the invention where multiple sensors are deployed in different ACSC Modules within an ACSC Array but the requirement is that they are directed in different directions relative to the location of the ACSC Array.

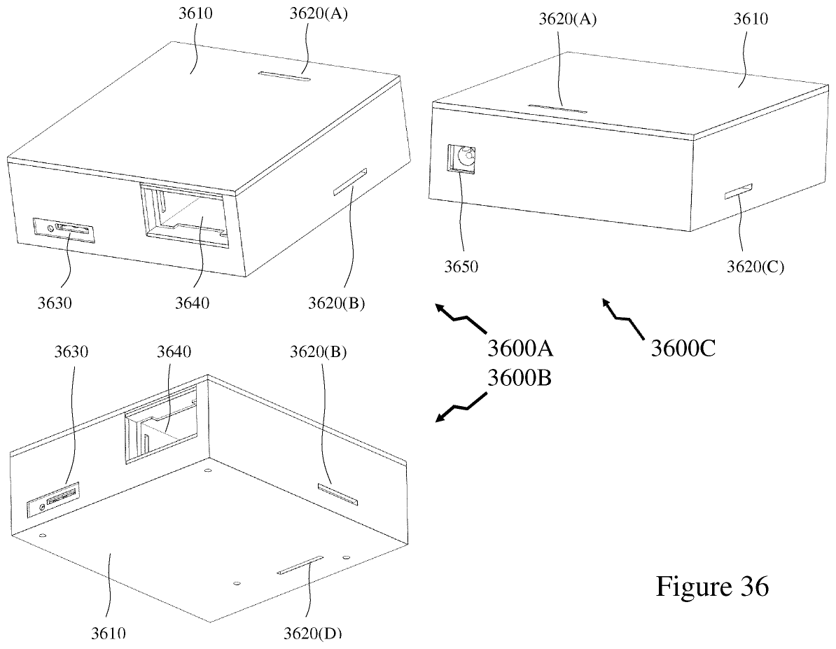

Referring to FIG. 32 there are depicted first and second Schematics 3200A and 3200B for connectivity between first and second Interfaces 3220 and 3230 of an ACSC Module 3210 with integral Circuit 3260. As depicted a first subset of Connections 3240A route directly from first Interface 3220 to second Interface 3230 whilst a second subset of Connections 3250A for each of the first and second Interfaces 3220 and 3230 route to the Circuit 3260. Within embodiments of the invention the first and second subsets of Connections 3240A and 3250A may be fixed for all ACSC Modules.

Within embodiments of the invention as depicted in first Schematic 3200A the first and second subsets of Connections 3240A and 3250A may be fixed for an ACSC Module but may vary between ACSC Modules. For example, first subset 3240A may be DC power connections wherein a Base ACSC Module provides DC power on N Connections but each ACSC Module connected to it takes DC power from a different Connection of these N Connections where the ACSC Array is limited to N ACSC Modules together with the Base ACSC Modules. Within other embodiments multiple ACSC Modules may take power from a common power rail such that the number of ACSC Modules connected to the Base ACSC Module is not limited to N. Whilst only two Interfaces are depicted it would be evident to one of skill in the art that additional Interfaces may be similarly configured and implemented without departing from the scope of the invention.

Alternatively, as depicted within second Schematic 3200B each of a first subset of Connections 3240B and a second subset of Connections 3250B route to an Interface Circuit 3270 which is not only connected to the first and second Interfaces 3220 and 3230 but the Circuit 3260. The Interface Circuit 3270 may programmatically in a static or dynamic manner configure which signals from the first subset of Connections 3240B and the second subset of Connections 3250B route directly between the first and second Interfaces 3220 and 3230 and which route to the Circuit 3260. Accordingly, the Interface Circuit 3270 may adjust this based upon the configuration of the ACSC Array when it is assembled with the ACSC Array or when another ACSC Module is added or removed from the ACSC Array. It would be evident that Interface Circuit 3270 may be partitioned within other embodiments of the invention such that part is associated with first Interface 3220 and another part with second Interface 3230. Whilst only two Interfaces are depicted it would be evident to one of skill in the art that additional Interfaces may be similarly configured and implemented without departing from the scope of the invention.

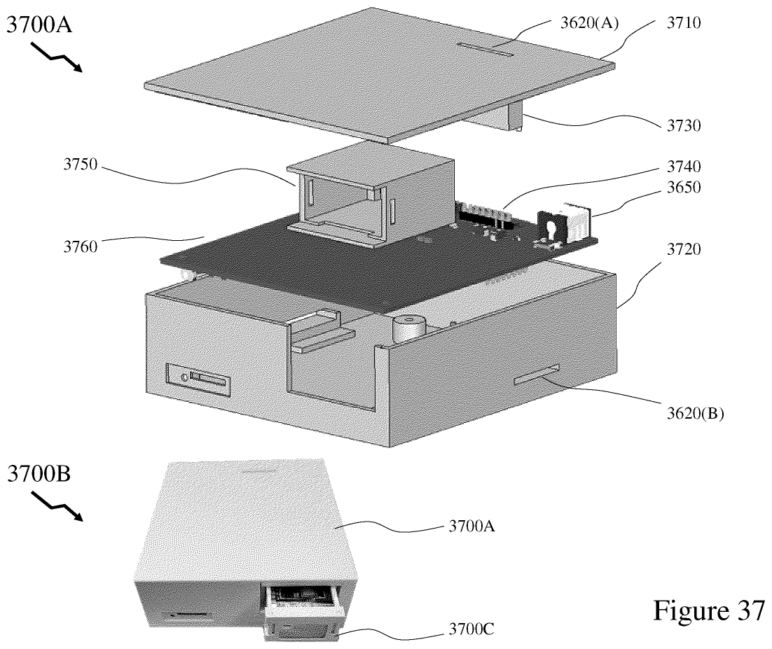

Now referring to FIGS. 33 and 34 depict ACSC Array configurations exploiting ACSC Modules and Vase ACSC Modules according to embodiments of the invention. Referring to FIG. 33 there is depicted an ACSC Array 3300 comprising:
Upper ACSC Module 3310 which provides for insertion of an Insert 3370, e.g., a 5G wireless interface, a battery 3380 and a short-range wireless interface SRWI (e.g., Bluetooth);
First intermediate ACSC Module 3320 which provides for radon detection and includes a SRWI;
Second intermediate ACSC Module 3330 which provides for air particulate sensor for particulate detection and counting together with a SRWI;
Base ACSC Module 3340 which provides for water detection, includes a SWRI, a power interface (e.g., 5V DC power) 3360 and feet 3350.

Accordingly, ACSC Array 3300 provides a stacked ACSC Array which can be located on a floor. Accordingly, the ACSC Array 3300 provides a stand-alone configuration providing a wireless interface from the ACSC Array 3300 to external device(s) through the 5G interface of the Insert 3370, a radon detector, an air particulate sensor, and water detection. A user is able to add additional ACSC Modules to the ACSC Array 3300 to provide additional functionality and subsequently remove them. The SWRI within each of the upper ACSC Module 3310, first and second intermediate ACSC Modules 3320 and 3330 and Base ACSC Module 3340 allow for over-the-air interfacing to a user's PED for example for configuration and/or data acquisition. In the event of power failure from the external power suppl coupled to the power interface 3360 the battery 3380 provides power backup. Optionally, Base ACSC 3340 may not provide water detection but is a “blank” power base to couple the external power supply to the ACSC Modules. Accordingly, ACSC Array 3300A provides a stacked ACSC Array which can be discretely located on a floor as can other embodiments of the invention. Alternatively, other embodiments may be designed to be wall mounted (see first ACSC Array 3500A in FIG. 35), ceiling mounted, pole mounted, disposed upon furniture etc., or integrated into an element of infrastructure and/or other equipment without departing from the scope of the invention.

Referring to FIG. 34 there is depicted an ACSC Array 3400 comprising:
Cap 3410;
First intermediate ACSC Module 3320 which provides for radon detection and includes a SRWI;
Second intermediate ACSC Module 3330 which provides for air particulate sensor for particulate detection and counting together with a SRWI;
Base ACSC Module 3340 which provides for water detection, includes a SWRI, a power interface (e.g., 5V DC power) 3360 and feet 3350.

Accordingly, ACSC Array 3400 whilst providing the same functionality with respect radon, air particulate, and water detection it does not provide stand-alone operation in the event of a failure of its external power supply. Further, ACSC Array 3400 connects via one or more of SWRI within the ACSC Modules within the ACSC Array 3400 to a SWRI interface within another device locally to the ACSC Module. For example, this device may be a PED, FED, electrical receptacle with SWRI interface (either integrated or provisioned via an Insert), electrical receptacle with SWRI interface (either integrated or provisioned via an Insert), etc. The SWRI of the ACSC Array 3400 and other device locally can form part of a SWRI mesh allowing an infrastructure to be provisioned with sensors without requiring the infrastructure to be rewired etc.

Now referring to FIG. 35 there are depicted first and second ACSC Arrays 3500A and 3500B, respectively. First ACSC Array 3500A provides the same functionality as ACSC Array 3400 but now integrates a single SWRI within the Base ACSC Module 3340 which is depicted mounted to a vertical support via brackets 3510. Similarly, second ACSC Array 3500B depicts an ACSC Array with the same functionality as ACSC Array 3300 in FIG. 33 but the Base ACSC Module 3340 now supports a pair of ACSC Module Stacks, the left hand one comprising ACSC Modules 3320 and 3330 whilst the right hand one comprises ACSC Module 3310 with Battery 3380 and Insert 3370. Accordingly, it would be evident to one of skill in the art that the ACSC Arrays can have multiple configurations, multiple orientations, be mounted in different configurations and/or orientations, etc.

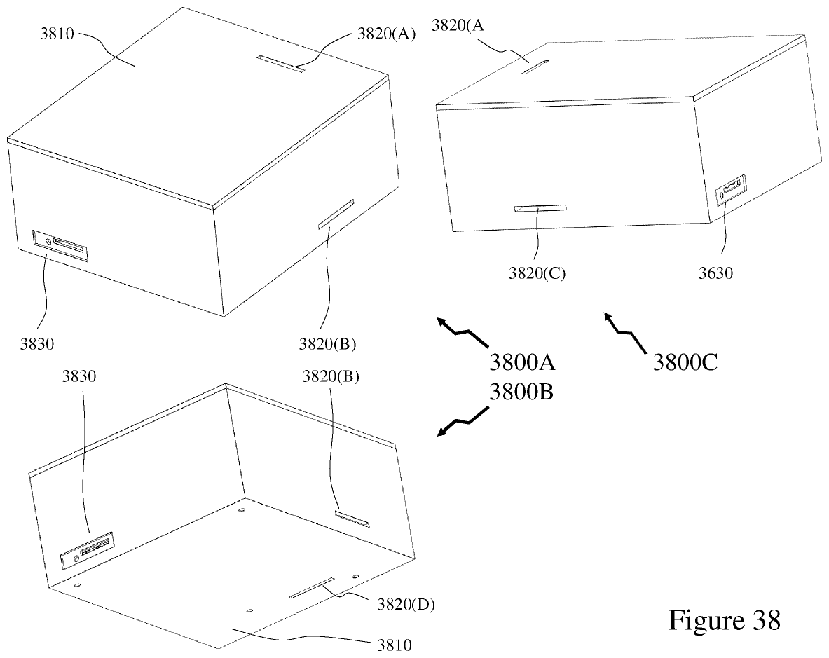

Referring to FIGS. 36 and 37 there are depicted first to third Images 3600A to 3600C and first and second Images 3700A and 3700B respectively of an ACSC module according to an embodiment of the invention supporting inserts to configure and reconfigure additional functionality to the ACSC module. Within first to third Images 3600A to 3600C an ACSC Module 3610 is depicted comprising a Power Interface 3650 for connecting to a power supply, e.g., an AC or DC power supply, a Card Interface 3630, e.g., a Secure Digital (SD) card such as SD, SDHC, SDXC. SDUC, or other interface for connecting a digital memory to the ACSC Module 3610 such as a USB interface, Lightning interface etc. The Card Interface 3630 allowing data and/or software to be loaded to or transferred from the ACSC Module 3610.

The ACSC Module 3610 further comprises a Cavity 3640 allowing the insertion and removal of inserts such as described and depicted above to provide additional functionality to be added to the ACSC Module 3610 and adjusted according to evolving requirements. Whilst the ACSC Module 3610 is depicted with a single Cavity 3640 it would be evident that other ACSC Modules may comprises N cavities, where N≥0.

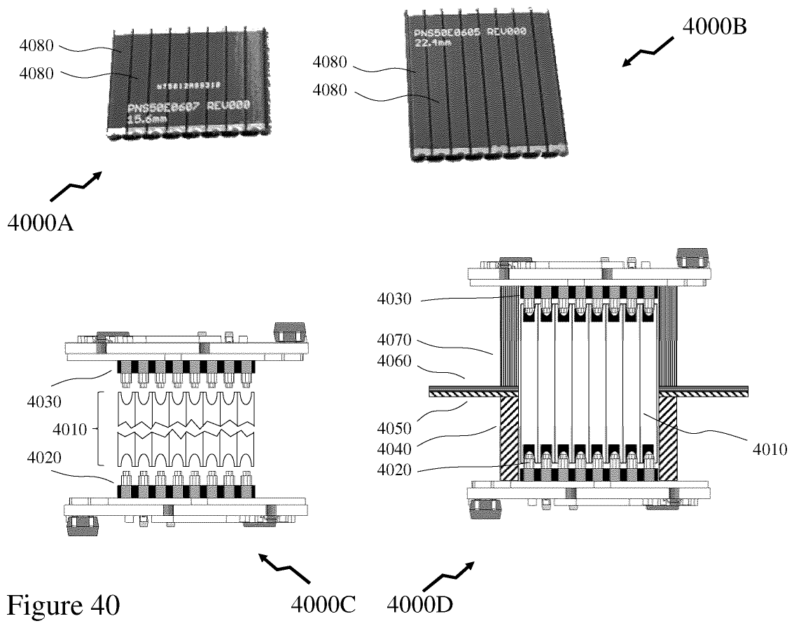

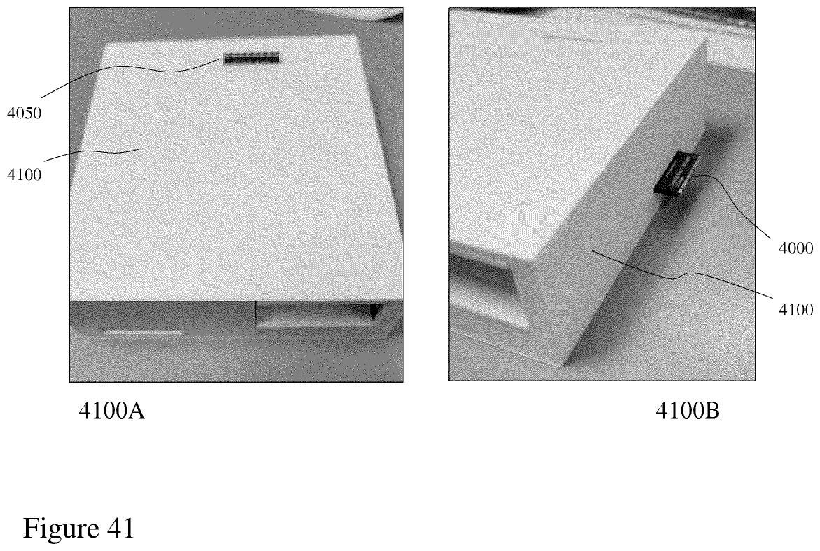

The ACSC Module 3610 further comprises first to fourth Slots 3620(A) to 3620(D) within the top, right, left and bottom surfaces of the ACSC Module 3610. Each of the first to fourth Slots 3620(A) to 3620(D) respectively supports the insertion of a bus interconnection element (BIE) as described and depicted below in respect of FIGS. 40 and 41. The BIE(s) and Slot(s) provide for electrical interconnection between adjacent ACSC Modules, either laterally or vertically, in a manner where additional mechanical interfaces to secure the electrical connections are not required and/or difficult to make between adjacent ACSC Modules.

lock Rather, the ACSC Modules are connected together by mechanical means that each BIE into the two slots of the adjacent ACSC Modules the BIE is interconnecting. These mechanical means of connecting one ACSC Module to another ACSC Module are not depicted within the figures nor described within this specification in extended detail as many such means are known in the art. For example, the mechanical connection may be via connecting straps screwed or bolted to the ACSC Modules or the ACSC Modules may have fittings such as dovetails or other mechanically joining means such as panel connectors or panel mounts, “knock down” fasteners etc. Alternatively, the ACSC Modules may be fitted to one or more “trays” that lock ACSC Modules mechanically in place but provide no other functionality.

Whilst the ACSC Module 3610 further comprises first to fourth Slots 3620(A) to 3620(D) it would be evident that within other embodiments of the invention the number of slots upon each surface of an ACSC Module may vary and may vary surface to surface. The number of slots per surface may be 0, 1, 2, 3 or more. Whilst no slots are depicted within the front and rear surfaces of the ACSC Module 3610 slots may be provided within these to support other mechanical configurations and assembly configurations. However, the locations of these slots upon each surface are predetermined with respect to a defined aspect of the mechanical shell of the ACSC Module such that slots within each pair of adjacent ACSC Modules align based upon mechanical alignment of the ACSC Modules themselves. For example, the slots are defined heights and lengths away from the bottom rear left corner such that even if the width, height and length of ACSC Modules varies the slots are aligned when the ACSC Modules are aligned at their rear.

Referring to FIG. 37 there are depicted first and second Images 3700A and 3700B, respectively. First Image 3700A depicts the ACSC Module 3610 in exploded form. Accordingly, in the view shown there are depicted the first and second Slots 3620(A) and 3620(B), first Slot 3620(A) being in Cover 3710 and second Slot 3620(B) in the Base 3720. Mounted within the Base 3720 is Circuit Board 3760 upon which is mounted Cavity Body 3750 which provides electrical connections between an insert inserted into the Cavity to the Circuit Board 3760 and/or mechanical keying to specific classes of inserts, such as described and depicted above in respect of FIGS. 9A, 9B and 10 for example.

Also mounted to the Circuit Board 3760 is Power Interface 3650 and Header 3740. Mounted to the underside of the Cover 3710 is Guide 3730 which is aligned to the first Slot 3620A. A BIE when inserted into the first Slot 3620A is guided by the inner bore of the Guide 3730 into contact with the Header 3740 as described and depicted in respect of FIGS. 9A-9B, 10 and 40. Similar guides are mounted internally on other surfaces of the Body 3720 for other slots within the Body 3720. Similarly, other guides would also be positioned on the surfaces of the Cover 3710 and Base 3720 to align with other slots in the Cover 3710 and Base 3720, respectively. Exemplary interconnections for instigating the electrical connection between a pair of ACSCs according to embodiments of the invention as depicted in FIGS. 36 and 37 respectively are described and depicted with respect to FIGS. 40 and 41 respectively although it would be evident that other electrical interconnections may be employed as described within this specification in respect of other embodiments of the invention that are compatible with the embodiment of the invention depicted in FIGS. 36 and 37 respectively.

Within an embodiment of the invention each slot aligns with a header, such as Header 3740, at the associated location on the Circuit Board 3760 such that the Circuit Board 3760 may have headers to connect to electrical interconnections inserted in a slot one or more of above the Circuit Board 3760, below the Circuit Board 3760, to a first side the Circuit Board 3760, to a second side the Circuit Board 3760, to a third side the Circuit Board 3760 etc. Whilst the Circuit Board 3760 depicted is square it would be evident that the Circuit Board 3760 may be rectangular, polygonal or have a predetermined non-geometric geometry.

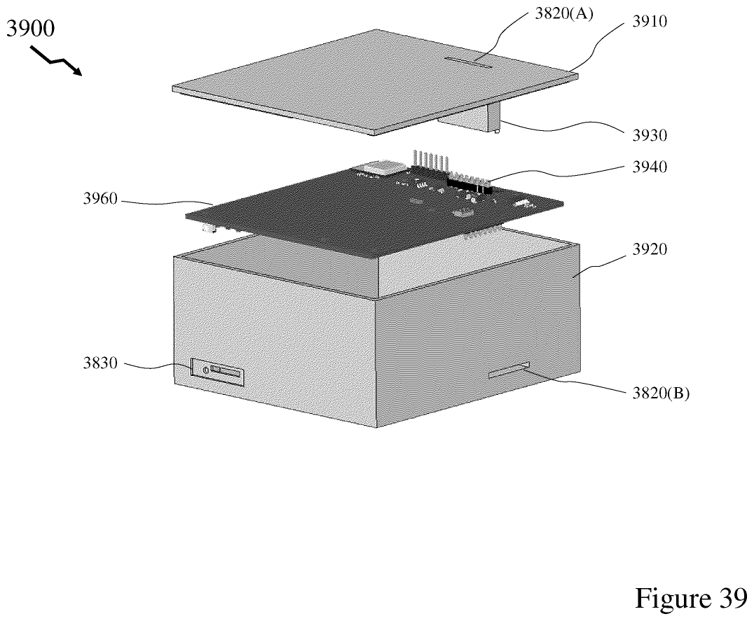

Now referring to FIGS. 38 and 39 there are depicted first to third Images 3800A to 3800C and Image 3900 respectively of an ACSC module according to an embodiment of the invention supporting inserts to configure and reconfigure additional functionality to the ACSC module. Within first to third Images 3800A to 3800C an ACSC Module 3810 is depicted comprising a Card Interface 3830, e.g., a Secure Digital (SD) card such as SD, SDHC, SDXC. SDUC, or other interface for connecting a digital memory to the ACSC Module 3810 such as a USB interface, Lightning interface etc. The Card Interface 3830 allowing data and/or software to be loaded to or transferred from the ACSC Module 3810.

In contrast to ACSC Module 3610 in FIG. 36 the ACSC Module 3810 does not have a Power Interface, such as Power Interface 3650 in FIG. 36, for connecting to a power supply, e.g. an AC or DC power supply, as the ACSC Module 3810 connects to a base module, such as ACSC Module 3610 in FIG. 36 for example wherein the electrical connections between ACSC Module 3810 and the base module provide power to the ACSC Module 3810. However, it would be evident that within other embodiments of the invention multiple modules within a combination of ACSCs may have electrical power supplies and that one or more of these may be employed, including the base module discretely or another module discretely.

The ACSC Module 3810 further comprises first to fourth Slots 3820(A) to 3820(D) within the top, right, left and bottom surfaces of the ACSC Module 3810. Each of the first to fourth Slots 3820(A) to 3820(D) respectively supports the insertion of a bus interconnection element (BIE) as described and depicted below in respect of FIGS. 40 and 41. The BIE(s) and Slot(s) provide for electrical interconnection between adjacent ACSC Modules, either laterally or vertically, in a manner where additional mechanical interfaces to secure the electrical connections are not required and/or difficult to make between adjacent ACSC Modules.

Rather, the ACSC Modules are connected together by mechanical means that lock each BIE into the two slots of the adjacent ACSC Modules the BIE is interconnecting. These mechanical means of connecting one ACSC Module to another ACSC Module are not depicted within the figures nor described within this specification in extended detail as many such means are known in the art. For example, the mechanical connection may be via connecting straps screwed or bolted to the ACSC Modules or the ACSC Modules may have fittings such as dovetails or other mechanically joining means such as panel connectors or panel mounts, “knock down” fasteners etc. Alternatively, the ACSC Modules may be fitted to one or more “trays” that lock ACSC Modules mechanically in place but provide no other functionality.

Whilst the ACSC Module 3810 further comprises first to fourth Slots 3820(A) to 3820(D) it would be evident that within other embodiments of the invention the number of slots upon each surface of an ACSC Module may vary and may vary surface to surface. The number of slots per surface may be 0, 1, 2, 3 or more. Whilst no slots are depicted within the front and rear surfaces of the ACSC Module 3810 slots may be provided within these to support other mechanical configurations and assembly configurations. However, the locations of these slots upon each surface are predetermined with respect to a defined aspect of the mechanical shell of the ACSC Module such that slots within each pair of adjacent ACSC Modules align based upon mechanical alignment of the ACSC Modules themselves. For example, the slots are defined heights and lengths away from the bottom rear left corner such that even if the width, height and length of ACSC Modules varies the slots are aligned when the ACSC Modules are aligned at their rear.

Referring to FIG. 39 there is depicted Image 3900 comprising an exploded view of the ACSC Module 3810. Accordingly, in the view shown there are depicted the first and second Slots 3820(A) and 3820(B), first Slot 3820(A) being in Cover 3910 and second Slot 3820(B) in the Base 3920. Mounted within the Base 3920 is Circuit Board 3960 upon which is mounted Header 3940. Mounted to the underside of the Cover 3910 is Guide 3930 which is aligned to the first Slot 3820A. A BIE when inserted into the first Slot 3820A is guided by the inner bore of the Guide 3930 into contact with the Header 3940 as described and depicted in respect of FIGS. 9A-9B, 10 and 40. Similar guides are mounted internally on other surfaces of the Body 3920 for other slots within the Body 3920. Similarly, other guides would also be positioned on the surfaces of the Cover 3910 and Base 3920 to align with other slots in the Cover 3910 and Base 3920, respectively. Exemplary interconnections for instigating the electrical connection between a pair of ACSCs according to embodiments of the invention as depicted in FIGS. 38 and 39 respectively are described and depicted with respect to FIGS. 40 and 41 respectively although it would be evident that other electrical interconnections may be employed as described within this specification in respect of other embodiments of the invention that are compatible with the embodiment of the invention depicted in FIGS. 38 and 39 respectively.

Within an embodiment of the invention each slot aligns with a header, such as Header 3940, at the associated location on the Circuit Board 3960 such that the Circuit Board 3960 may have headers to connect to electrical interconnections inserted in a slot one or more of above the Circuit Board 3960, below the Circuit Board 3960, to a first side the Circuit Board 3960, to a second side the Circuit Board 3960, to a third side the Circuit Board 3960 etc. Whilst the Circuit Board 3960 depicted is square it would be evident that the Circuit Board 3960 may be rectangular, polygonal or have a predetermined non-geometric geometry.

Referring to FIG. 40 there depicted first to fourth Images 4000A to 4000D respectively of bus interconnection elements (BIEs) to connect ACSC modules according to embodiments of the invention and interfacing of the bus interconnection element to circuits within ACSC modules according to embodiments of the invention. Referring initially to first Image 4000A there is depicted a BIE comprising a linear array of N=8 BIE Elements 4080 which provide an electrical connection from one end of a BIE Element 4080 to a distal end of the BIE Element 4080. The BIE in first Image 4000A having a length of 15.6 mm (0.61″). Second Image 4000B depicts another BIE comprising a linear array of N=8 BIE Elements 4080 which provide an electrical connection from one end of a BIE Element 4080 to a distal end of the BIE Element 4080. The BIE in second Image 4000B having a length of 22.4 mm (0.88″). Accordingly, each of the BIEs in first and second Images 4000A and 4000B therefore interconnects with N=8 contacts of a header within an ACSC Module, such as Headers 3740 and 3940 in FIGS. 37 and 39, respectively.

It would be evident that N may vary within other embodiments of the invention and that N may vary between connections in defined locations on ACSCs that connect to one another. Whilst a common N for all slots may be employed allowing modules to be connected in any orientation relative to another the embodiments of the invention support different N for different electrical connections at defined points on ACSC Modules when connected together with defined orientations between ACSCs. Within embodiments of the invention N≥1 and an integer.

Further, the BIEs depicted in first and second Images 4000A and 4000B are simple linear arrays although it would be evident that BIEs may support M layers to interconnect with a header having M rows, M≥1 and an integer. Further, the BIEs depicted in first and second Images 4000A and 4000B are simple linear arrays wherein the electrical connections on one end are mapped directly to the other end. However, it would be evident that BIEs may support routing of connections between one end and another end such that the BIE has an orientation with respect to the slots rather than being insertable with either end into a slot such that considerations with respect to orientation are removed for the user assembling the ACSCs together.

Referring to third Image 4000C in FIG. 40 there is depicted a schematic of interconnection methodology of a BIE 4010 for connecting between a first Header 4020 forming part of a first ACSC, such as depicted in FIG. 36 or 38 for example, and a second Header 4030 forming part of a second ACSC, such as depicted in FIGS. 36 and 38 for example. The configuration depicted in third Image 4000C being on using a BIE such as depicted in first and second Images 4000A and 4000B respectively with direct linear BIE elements. However, it would be evident that the interconnections may be non-linear and that the interconnection depicted in third Image 4000C may be one plane of interconnection of M planes of interconnection. Within third Image 4000C the BIE 4010 and first and second Headers 4020 and 4030 are depicted spaced apart for clarity.

Now referring to fourth Image 4000D in FIG. 40 there is depicted a schematic of interconnection methodology of a BIE 4010 for connecting between a first Header 4020 forming part of a first ACSC, such as depicted in FIG. 36 or 38 for example, and a second Header 4030 forming part of a second ACSC, such as depicted in FIGS. 36 and 38 for example. The configuration depicted in third Image 4000C being on using a BIE such as depicted in first and second Images 4000A and 4000B respectively with direct linear BIE elements. However, it would be evident that the interconnections may be non-linear and that the interconnection depicted in third Image 4000C may be one plane of interconnection of M planes of interconnection.

Also depicted in fourth Image 4000D are first Guide 4040 and first Wall 4050 forming part of a first ACSC within which is disposed first Header 4020 together with second Guide 4070 and second Wall 4060 forming part of a second ACSC. The first Guide being aligned with first Header 4020 and the second Guide 4030 being aligned with the second Header 4030 such that the BIE 4010 is retained within position. Accordingly, within an assembly process the BIE 4010 is inserted into the opening (slot) within first Wall 4050 and into the first Guide 4040. Subsequently, alignment of the other ACSC and movement into contact results in the BIE being inserted into the opening within the second Wall 4060 and into the second Guide 4070. In this manner the BIE 4010 is retained and aligned to the first and second Headers 4020 and 4030, respectively.

A BIE such as BIE 4010 in FIG. 40 comprises therefore an end dimensioned for insertion into the guide of the module and a plurality of electrical contacts, another end for insertion into the guide of the another module and a plurality of other electrical contacts, and a central portion disposed between the end and the other end dimensioned to fit into the guide of the module and the guide of the another module with a plurality of electrical tracks, each electrical track of the plurality of electrical tracks interconnecting a defined electrical contact of the plurality of electrical contacts to a defined other electrical contact of the plurality of other electrical contacts.

Optionally, the BIE 4010 when inserted into the first Guide 4040 experiences friction such that absent sufficient force being applied the BIE 4010 does not engage the first Header 4020. Rather, it is only upon assembly with the second ACSC with the first ACSC that sufficient force is applied to make contact. This limiting accidental contact being made to prevent either damage to the ACSC or electrical shock to a user.

Optionally, the first Header 4020 may be designed such that until a low voltage circuit connection is made via the BIE 4010 between the first Header 4020 and second Header 4030 any high voltage connections to be made between the first Header 4020 and second Header 4030 are disabled and only enabled upon the low voltage circuit being connected. Within embodiments of the invention the threshold between low and high voltage may be defined as, for example, 5V, 12V, 15V or another defined threshold. Further, current within the low voltage circuit may be limited.

Alternatively, within other embodiments of the invention electrical power supply and/or data connections between the first Header 4020 and second Header 4030 via the BIE 4010 are only enabled based upon another trigger being established, such as for example, an appropriate signal being provided to a controller within the ACSC(s). This signal may, for example, be transmitted to one or both ACSC through a wireless interface, upon connection of a memory device to a memory interface, e.g., insertion of a memory card into Card Interfaces 3630 and 3830 as depicted in FIGS. 36 and 38, respectively. Optionally, an interface may be provided such as Card Interfaces 3630 and 3830 as depicted in FIGS. 36 and 38 respectively where the card inserted is not a memory card but a card with a circuit that provides closure of an appropriate signal path within the ACSC or provisioning of the appropriate signal to the controller within the ACSC.

The headers within third and fourth Images 4000C and 4000D respectively may form part of one or more circuits within each ACSC or they may electrically connect to one or more circuits within each ACSC.

Now referring to FIG. 41 there are depicted first and second Images 4100A and 4100B respectively of bus interconnection elements (BIEs) to connect ACSC modules according to embodiments of the invention disposed within a top and side of an ACSC module according to an embodiment of the invention. Accordingly, in first Image 4100A a BIE 4050 such as described and depicted in second Image 4000B of FIG. 40 is depicted inserted into a slot within an upper surface of ACSC 4100 such as ACSC Module 3610 in FIG. 36 for example. In second Image 4100B a BIE 4000 such as described and depicted in first Image 4000A of FIG. 40 is depicted inserted into another slot within a sidewall of ACSC 4100 such as ACSC Module 3610 in FIG. 36 for example.

Within this embodiment of the invention a shorter BIE, e.g., BIE 4000 of length 15.6 mm (0.61″) is employed for connections between ACSCs laterally whilst a longer BIE, e.g., 4050 of length 22.4 mm (0.88″) is employed for connections between ACSCs vertically. It would be evident that within other embodiments of the invention that a common BIE length may be employed for all connections between ASCSs. Within other embodiments of the invention multiple lengths of BIE may be employed wherein the length of the BIE is defined by the two ACSCs being connected. Further, the specific lengths of BIEs described within this specification are examples only and the specific lengths of BIEs may be defined by one or more factors, including but not limited to, a specification for the ACSCs, the type of ACSC, a manufacturer of the ACSCs, a jurisdiction of deployment of the ACSCs, and location of the connection upon the ACSCs.

Whilst the BIEs have been described as having a single length it would be evident that within other embodiments of the invention the BIE may have a geometry which is profiled such that the BIE engages with two or more headers disposed at different distances from the wall of the ACSC. This profile may be within a single row of a BIE or between different rows of the BIE.

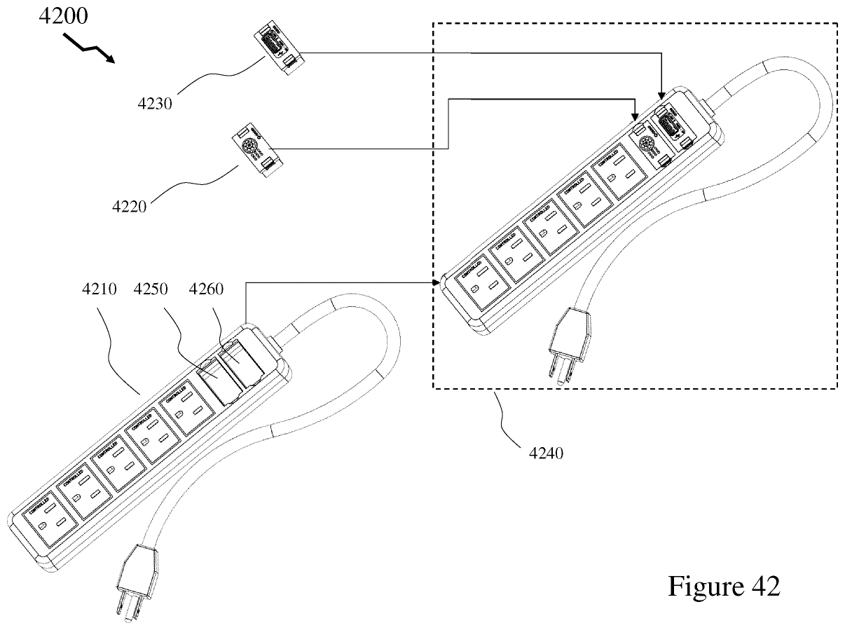

Referring to FIG. 42 there is depicted a power distribution module according to an embodiment of the invention supporting inserts to configure and reconfigure additional functionality to the power distribution module. As depicted a Power Bar 4210 provides a series of electrical outlets and has a cabled interface for connection to a power interface, as depicted there being North American electrical mains interfaces. Disposed within the Power Bar 4210 are first and second Cavities 4250 and 4260 with which fit inserts, such as first and second Inserts 4220 and 4230 respectively, as described above in respect of embodiments of the invention. Accordingly, when first and second Inserts 4220 and 4230 respectively are inserted into the first and second Cavities 4250 and 4260 respectively of the Power Bar 4210 the result is Augmented Power Bar 4240 which provides additional functionality other than basic power distribution. Accordingly, as described above the Power Bar 4210 may be augmented on a dynamic basis with additional functionality including, but not limited to, a sensor, a wireless interface, an optical emitter, a motion detector, a loudspeaker and a microphone.

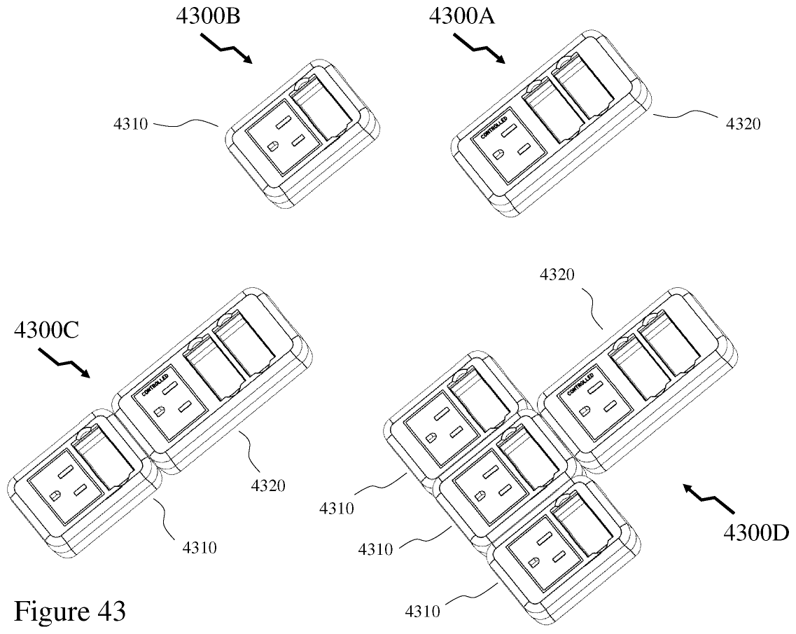

Now referring to FIG. 43 there are depicted first to fourth Images 4300A to 4300D respectively depicting a base power distribution module with electrical mains interface together with ACSC module for extending the base power distribution module and configurations for these elements. First Image 4300A depicts Power Module 4320 which provides an electrical mains interface and a pair of cavities in a manner similar to that depicted in FIG. 42 with Power Bar 4210. However, in contrast to Power Bar 4210 the Power Module 4320 does not include a cable interface to a power source but may include, for example, a power interface such as Power Interface 3650 in FIGS. 36 and 37, respectively. As such Power Module 4320 may be coupled to a DC and/or AC power source. Second Image 4300B depicts an ACSC Module 4310 which comprises another power interface and another cavity.

Third Image 4300C depicts an assembly comprising a Power Module 4320 coupled to an ACSC Module 4310. The mechanical coupling and electrical coupling are not depicted for clarity by may be according to embodiments of the invention. Accordingly, the Power Module 4320 is coupled to the ACSC Module 4310 via a BIE, such as the BIEs depicted in first and second Images 4000A and 4000B in FIG. 40 for example.

Fourth Image 4300D depicts another assembly comprising a Power Module 4320 coupled to an ACSC Module 4310 wherein the ACSC Module 4310 is then coupled to another pair of ACSC Modules 4310. The mechanical coupling and electrical coupling are not depicted for clarity by may be according to embodiments of the invention. Accordingly, the Power Module 4320 is coupled to the ACSC Module 4310 and the ACSC Modules are coupled to one another via BIEs, such as the BIEs depicted in first and second Images 4000A and 4000B in FIG. 40 for example.

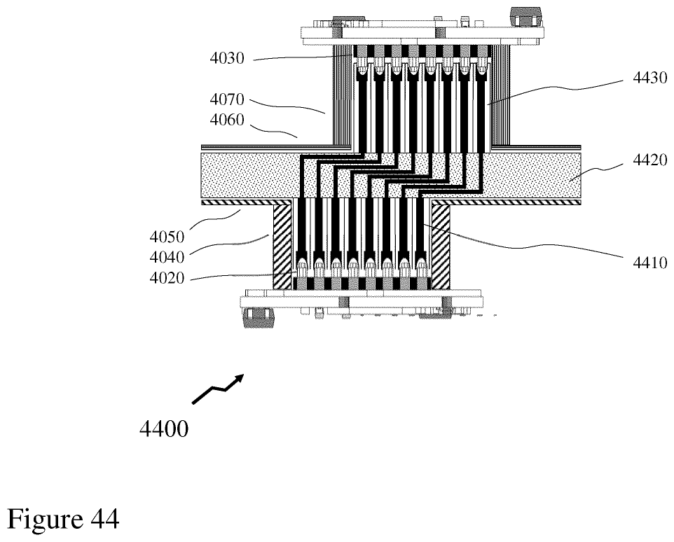

Now referring to FIG. 44 there is depicted an Assembly 4400 employing an interface element to provide an interconnection element to connect ACSC modules according to embodiments of the invention. Accordingly, as depicted there is an interconnection element such as described and depicted with respect to Interconnection Elements 2810(1) to 2810(N) in FIG. 28, first Interconnection Elements 2910(1) to 2910(N) in FIG. 29 or second Interconnection Elements 2950(1) to 2950(M). in FIG. 29. Accordingly, the interconnection element provides electrical connections between a first Header 4020 forming part of a first ACSC, such as depicted in FIG. 36 or 38 for example, and a second Header 4030 forming part of a second ACSC, such as depicted in FIGS. 36 and 38 for example. Also depicted are first Guide 4040 and first Wall 4050 forming part of the first ACSC within which is disposed first Header 4020 together with second Guide 4070 and second Wall 4060 forming part of the second ACSC within which is disposed the second Header 4030. The interconnection element comprises a first BIE 4410, an Intermediate Circuit 4420 and a second BIE 4430. First and second BIEs 4410 and 4430 being as described and depicted according to embodiments of the invention. However, rather than directly connecting two modules together these provide interfaces to the ACSCs and are interconnected via the Intermediate Circuit 4420. Within this configuration the interconnection element allows interconnection between ACSCs with different positions for the interfaces when the ACSCs are mechanically coupled to each other.

Within the embodiments of the invention described and depicted two modules have been described as being mechanically connected to each other and therein the electrical interconnections formed via the BIEs are retained in the interfaces formed by the openings and/or guides. The gap between the two module may be zero or a defined distance as established by the depth of the headers within the ACSCs and the length of the BIE employed.

### 8. Configuration Options and Variations

Within embodiments of the invention as described above with respect to FIGS. 3A to 32 a physical configuration of ACSC Modules is presented to permit flexible configuration of an ACSC Array. The self-stacking design can be viewed as being implemented with an internal backplane so that the backplane extends as each ACSC Modules is added to another. Further, this internal backplane connecting elements can be dynamically configured based upon the ACSC Modules within the ACSC Array and/or the ACSC Module's position within the ACSC Array.

Within embodiments of the invention a Base ACSC Module may be viewed as a “master” module such that the master module controls the flow of information to and from an external communications interface and to and from other modules in the stack. However, within another embodiment of the invention this “master” controller only controls the flow of information to and from an external communications interface whilst the ACSC Modules can exchange information directly or directly and indirectly via the master module. Within other embodiments of the invention the master module may be dynamically established based upon ACSC Modules within the ACSC Array. Similarly, multiple ACSC Modules may have external communication interfaces and only one ACSC Module or a subset of these ACSC Modules may be enabled to provide external communications to a network and other PEDs, FEDS, servers, controls etc. locally or remotely. Similarly, an ACSC Module may exploit a communications interface within another ACSC Module to provide communications to other electronic and/or electrical equipment locally or remotely. This communications interface may be pre-configured within the ACSC Module or established via an Insert within an ACSC Module.

ACSC Modules within embodiments of the invention be statically or dynamically assigned as control modules which are capable of controlling the flow of information within the ACSC Modules within an ACSC Array.

ACSC Modules within embodiments of the invention be statically or dynamically assigned as memory modules which are assigned the role(s) of storing and/or delivering information to other ACSC Modules within an ACSC Array.

ACSC Modules within embodiments of the invention may be statically or dynamically assigned as user interface modules which are assigned the role(s) of displaying information to a user or receiving commands from a user. Whilst an ACSC Array may include a wireless interface allowing the user to interact with and/or control one or more aspects of the ACSC Array via a software application executing upon a PED, FED, wearable device etc. the commands may within other instances be provided by the user via verbal and/or visual means. Accordingly, an ACSC Module may be assigned to listen as it includes a microphone and perform speech recognition either generally or of specific keywords. Another ACSC Module may be assigned to determine user hand signals as it includes a camera and accordingly perform gesture and/or hand signal recognition. For example, the camera and hand signal recognition may perform recognition of sign language or it may perform facial recognition to determine who the user is and adjust aspects of the ACSC Array operation and/or control aspects of the external environment to the ACSC Array in dependence upon the identified user. Other ACSC Modules may provide a user with status information through a display, e.g., an LED or LCD display or via colour coded LEDs etc. Optionally, the LED or LCD Display may be configurable to an ACSC Array via an Insert.

ACSC Modules within embodiments of the invention be statically or dynamically assigned as external control modules which are capable of controlling the flow of information to and/or from one or more external devices such as motors, pumps, fans, humidifiers, dehumidifiers, fire extinguishers, doors, heating systems, cooling systems, risk mitigation systems, and alarms for example.

Within embodiments of the invention a Base ACSC Module may provide an electrical input power interface to distribute power to other ACSC Module within an ACSC Array as well as a liquid level sensor, e.g., for water detection.

Within embodiments of the invention ACSC Modules implement fully automatic or semi-automatic in conjunction with a Base ACSC Module configuration and connectivity of data and/or power interfaces to and from themselves.

Within embodiments of the invention each ACSC Module may be assigned a unique serial number wherein a Base ACSC Module establishes the ACSC Module functionality either through direct communications with the ACSC Module or via a lookup of the unique serial number within an external database. In the latter the ACSC Module may be automatically updated by the Base ACSC Module registering the installation of the ACSC Module within an ACSC Array. Optionally, a predetermined ACSC Module, e.g., a Base ACSC Module, queries periodically what ACSC Modules are connected and generates a table of connected ACSC Modules with their unique identities.

The querying module may then direct specific queries to each individual ACSC Module to establish one or more aspects of the ACSC Module including, but not limited to, data communications configuration, data bus configuration, data bus configuration options, data communication options, hardwired elements, programmable aspects, etc. The querying ACSC Module may then configure one or more aspects of the queried ACSC Module and/or other ACSC Modules interfaced to the ACSC Module. A master ACSC Module may regularly query connected devices or responds to an interrupt request.

Optionally, ACSC Modules within an ACSC Array may be serially connected to a master module, parallel connected to a master module, form a mesh network, implement a star network with the master module, or establish an ad-hoc network where communications are routed as required.

Optionally, a message from one ACSC Module to another ACSC Module is passed through the ACSC Array until it reaches the target ACSC Module or it may be specifically targeted via programmable interfaces and/or discrete connections.

Optionally, each ACSC Module within an ACSC Array may contain one or more short range and/or long range wireless interfaces where each ACSC Module may route via a master module or may be independently connected to external data devices/network.

In addition to wireless external connectivity connections to networks for ACSC Modules may be via optical and/or hardwired interfaces for one or more of external processing, external control, external data acquisition, etc.

It would be evident that ACSC Modules and/or ACSC Arrays may provide solutions to a wide range of applications including, but not limited, basement hazards, radon detection/mitigation, water detection (e.g., pipe leaks, rain, sewer backup, sump-pump failure etc.). Optionally, the ACSC Module(s) and/or ACSC Array employ integrated sensors and/or external sensors connected to Inserts as depicted in FIG. 5 or via a wireless or optical interface. An external sensor may for example be a sensor clamped-on to a sump-pump or be a tethered slim sensor for under a fridge, freezer etc. Optionally, an ACSC Module or ACSC Array may establish dynamic real-time occupancy based upon measurements such as rate of cardon dioxide generate (proportional to number of individuals), thermal imaging and processing, radar and processing, motion detectors with imaging or wireless means.

The inventors expect that ACSC Modules and ACSC Arrays according to embodiments of the invention can provide either through one or more of integrated AI, external AI, integrated ML and external ML can provide a wide range of configurable and dynamically reconfigurable hardware to a variety of enterprises, organizations, third party service providers, service providers, users etc. Within embodiments of the invention an ACSC Array may be configured by a user or it may be purchased pre-assembled targeted to a particular end-pint use such as senior living, aging in place, health and wellness, workplace safety, security, indoor air quality management, hotel room management, office building management, power management, environmental control and agriculture. ACSC Arrays and ACSC Modules according to embodiments of the invention provide static or dynamically reconfigurable elements of “smart” environments. With respect to senior living an ACSC Module with vibration detection may determine through one or more AI/ML processes a user falling or collapsing versus their normal motion or dropping an object.

Optionally, through speech recognition and/or facial recognition discretely or in conjunction with wireless device identity acquisition an ACSC Module or ACSC Array can determine a number of people in an area, identify known individuals, identity new individuals etc.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Implementation of the techniques, blocks, steps and means described above may be done in various ways. For example, these techniques, blocks, steps and means may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above and/or a combination thereof.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be rearranged. A process is terminated when its operations are completed but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages and/or any combination thereof. When implemented in software, firmware, middleware, scripting language and/or microcode, the program code or code segments to perform the necessary tasks may be stored in a machine readable medium, such as a storage medium. A code segment or machine-executable instruction may represent a procedure, a function, a subprogram, a program, a routine, a subroutine, a module, a software package, a script, a class, or any combination of instructions, data structures and/or program statements. A code segment may be coupled to another code segment or a hardware circuit by passing and/or receiving information, data, arguments, parameters and/or memory content. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor and may vary in implementation where the memory is employed in storing software codes for subsequent execution to that when the memory is employed in executing the software codes. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes but is not limited to portable or fixed storage devices, optical storage devices, wireless channels and/or various other mediums capable of storing, containing or carrying instruction(s) and/or data.

The methodologies described herein are, in one or more embodiments, performable by a machine which includes one or more processors that accept code segments containing instructions. For any of the methods described herein, when the instructions are executed by the machine, the machine performs the method. Any machine capable of executing a set of instructions (sequential or otherwise) that specify actions to be taken by that machine are included. Thus, a typical machine may be exemplified by a typical processing system that includes one or more processors. Each processor may include one or more of a CPU, a graphics-processing unit, and a programmable DSP unit. The processing system further may include a memory subsystem including main RAM and/or a static RAM, and/or ROM. A bus subsystem may be included for communicating between the components. If the processing system requires a display, such a display may be included, e.g., a liquid crystal display (LCD). If manual data entry is required, the processing system also includes an input device such as one or more of an alphanumeric input unit such as a keyboard, a pointing control device such as a mouse, and so forth.

The memory includes machine-readable code segments (e.g., software or software code) including instructions for performing, when executed by the processing system, one of more of the methods described herein. The software may reside entirely in the memory, or may also reside, completely or at least partially, within the RAM and/or within the processor during execution thereof by the computer system. Thus, the memory and the processor also constitute a system comprising machine-readable code.

In alternative embodiments, the machine operates as a standalone device or may be connected, e.g., networked to other machines, in a networked deployment, the machine may operate in the capacity of a server or a client machine in server-client network environment, or as a peer machine in a peer-to-peer or distributed network environment. The machine may be, for example, a computer, a server, a cluster of servers, a cluster of computers, a web appliance, a distributed computing environment, a cloud computing environment, or any machine capable of executing a set of instructions (sequential or otherwise) that specify actions to be taken by that machine. The term “machine” may also be taken to include any collection of machines that individually or jointly execute a set (or multiple sets) of instructions to perform any one or more of the methodologies discussed herein.

The foregoing disclosure of the embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

1. A module comprising:
a casing;
one or more interfaces, each interface disposed at a predetermined position within a surface of the casing and supporting at least one of data communications and power; and
one or more circuits coupled to the one or more interfaces.

2. The module according to claim 1, wherein
the module when-added to an existing stack of modules-forms a new stack of modules;
each module within the existing stack of modules is mechanically coupled to at least one other module within the existing stack of modules;
each module within the new stack of modules is mechanically coupled to at least one other module within the new stack of modules; and
the module is added to the existing stack of modules by either inserting it into the existing stack of modules such that the module is between a pair of modules or by adding the module to another module within the existing stack of modules such that the module is an outer module of the new stack of modules.

3. The module according to claim 1, wherein
the module is assembled with one or more other modules to form stack of modules;
each module within the stack of modules is mechanically coupled to at least one other module within the stack of modules; and
the module is assembled as part of stack of modules by either inserting it between a pair of modules or by adding the module to another module such that the module is an outer module of the stack of modules.

4. The module according to claim 1, wherein
the predetermined position of each interface of the one or more interfaces within a surface of the casing is defined relative to a rear corner of the casing such that when the module is disposed adjacent to one another module with their rear surfaces aligned a defined interface of the one or more interfaces of the module is aligned with another defined interface of the one or more interfaces of the another module.

5. The module according to claim 1, wherein
each interface of the one or more interfaces comprises:
an opening within the surface of the casing;
a guide projecting from surface of the casing into the casing; and
a header comprising a plurality of electrical connector contacts; and
the header is either part of a circuit of the one or more circuits or electrically connected to the circuit of the one or more circuits.

6. The module according to claim 1, wherein
each interface of the one or more interfaces of the module comprises:
an opening within the surface of the casing;
a guide projecting from surface of the casing into the casing; and
a header comprising a plurality of electrical connector contacts;
the header is part of a circuit of the one or more circuits; and
the module is electrically connected to another module via a bus interconnection element which is inserted into the interface of the one or more interfaces of the module and into another interface of the one or more interfaces of the another module.

7. The module according to claim 6, wherein
the bus interconnection element comprises:
an end dimensioned for insertion into the guide of the module and a plurality of electrical contacts;
another end for insertion into the guide of the another module and a plurality of other electrical contacts; and
a central portion disposed between the end and the other end dimensioned to fit into the guide of the module and the guide of the another module with a plurality of electrical tracks, each electrical track of the plurality of electrical tracks interconnecting a defined electrical contact of the plurality of electrical contacts to a defined other electrical contact of the plurality of other electrical contacts.

8. The module according to claim 1, wherein
upon coupling the module to another module, the module dynamically configures the at least one of the data communications and the power of an interface of the one or more interfaces in dependence upon the another module.

9. The module according to claim 1, wherein
upon coupling the module to another module forming part of a stack of modules to form a new stack of modules the module dynamically configures the at least one of the data communications and the power of an interface of the one or more interfaces in dependence upon the another module; and
the dynamic configuration of the at least one of the data communications and the power of the interface of the one or more interfaces is independent of at least one of the order of the modules within the new stack of modules and the functionality of the other modules within the new stack of modules.

10. The module according to claim 1, wherein
upon coupling the module to another module to form a portion of a stack of modules the module dynamically configures the at least one of the data communications and the power of an interface of the one or more interfaces in dependence upon the another module; and
the dynamic configuration of the at least one of the data communications and the power of the interface of the one or more interfaces is independent of at least one of the order of the other modules within the stack of modules apart from the module and the another module and the functionality of the other modules within the stack of modules apart from the module and the another module.

11. The module according to claim 1, wherein
the one or more interfaces comprises a pair of interfaces;
an interface of the pair of interfaces is disposed within a surface of the casing;
the other interface of the pair of interfaces is disposed within another surface of the casing opposite the surface of the casing;
the module can be assembled with another module in a pair of configuration where in one configuration the surface of the casing is disposed towards the another module and in the other configuration the another surface of the casing is disposed towards the another module; and
the predetermined position of each interface of the pair of interfaces is defined relative to a rear corner of the casing such that when the module is disposed adjacent to the another module in either configuration of the pair of configurations with their rear surfaces aligned a defined interface of the pair of interfaces of the module is aligned with another defined interface of the one or more interfaces of the another module.

12. The module according to claim 1, wherein
the one or more interfaces comprises N interfaces where N≥3 and N is an integer;
each interface of the N interfaces is disposed within a different surface of the casing;
the module can be assembled with another module in N configurations where in each configuration of the N configurations the surface of the casing associated with an interface of the N interface is disposed towards the another module; and
the predetermined position of each interface of the N interfaces is defined relative to a rear corner of the casing such that when the module is disposed adjacent to the another module in each configuration of the N configurations the associated interface of the N interface is aligned with another defined interface of the one or more interfaces of the another module.

13. The module according to claim 1, wherein
each interface of the one or more interfaces of the module comprises:
an opening within the surface of the casing;
a guide projecting from surface of the casing into the casing; and
a header comprising a plurality of electrical connector contacts;
the header is part of a circuit of the one or more circuits; and
the module is electrically connected to another module via a bus interconnection element which is inserted into the interface of the one or more interfaces of the module and into another interface of the one or more interfaces of the another module.

14. The module according to claim 13, wherein
the bus interconnection element comprises:
an end dimensioned for insertion into the guide of the module and a plurality of electrical contacts;
another end for insertion into the guide of the another module and a plurality of other electrical contacts; and
a central portion disposed between the end and the other end comprising a planar circuit having a plurality of electrical tracks, each electrical track of the plurality of electrical tracks interconnecting a defined electrical contact of the plurality of electrical contacts to a defined other electrical contact of the plurality of other electrical contacts; and
the central portion is disposed between the module and the another module and in contact with each of the module and the another module.

15. A module comprising:
one or more interfaces supporting at least one of data communications and power; and
at least one of a control signal generator and a sensor; wherein
the module can be added to a stack of modules to form a new stack of modules where each module of the new stack of modules interconnected to at least one adjacent module of the stack of modules; and
the module dynamically configures at least one of data communications and power according to its adjacent module or modules within the new stack of modules independent of the order of the modules within the new stack of modules but in dependence of the functionality of the other modules within the new stack of modules.
